(19) United States
(12) Patent Application Publication
(10) Pub. No.: US 2011/0130099 A1
(43) Pub. Date: Jun. 2, 2011

(54) SYSTEMS, APPARATUS AND METHODS FOR DISTRIBUTED SCHEDULING TO FACILITATE INTERFERENCE MANAGEMENT

(75) Inventors: Ritesh K. Madan, Jersey City, NJ (US); Ashwin Sampath, Skillman, NJ (US); Aamod Dinkar Khandekar, San Diego, CA (US); Jaber M. Borran, San Diego, CA (US)

(73) Assignee: QUALCOMM INCORPORATED, San Diego, CA (US)

(21) Appl. No.: 12/784,398

(22) Filed: May 20, 2010

Related U.S. Application Data
(60) Provisional application No. 61/180,726, filed on May 22, 2009.
(60) Provisional application No. 61/288,813, filed on Dec. 21, 2009.
(60) Provisional application No. 61/288,816, filed on Dec. 21, 2009.

(51) Int. Cl. H04W 24/02; H04W 72/04

(52) U.S. Cl. 455/63.1

(57) ABSTRACT

Systems, methods, apparatus and computer program products for scheduling in a wireless communication system are provided. In some embodiments, the method can include: receiving a buffer status report from user equipment having one or more logical channel groups; configuring a first priority metric and a first prioritized bit rate for at least one of the one or more logical channel groups, wherein the configuring a first priority metric and a first prioritized bit rate for at least one of the one or more logical channel groups is in response to information included in the buffer status report; determining interference at the user equipment; and re-configuring, by the serving base station, the first priority metric and the first prioritized bit rate for the at least one of the one or more logical channel groups in response to determining interference at the user equipment.

### CROSS-REFERENCE TO RELATED APPLICATIONS

This application claims the benefit of U.S. Provisional Patent Application Ser. No. 61/180,726 titled “SCHEDULING AND INTERFERENCE MANAGEMENT FOR MULTIPLE MOBILE DEVICES PER CELL IN DOWNLINK AND UPLINK,” which was filed May 22, 2009, and U.S. Provisional Patent Application Ser. Nos. 61/288,813 and 61/288,816, each of which is titled “SYSTEMS, APPARATUS AND METHODS FOR DISTRIBUTED SCHEDULING TO FACILITATE INTERFERENCE MANAGEMENT,” and each of which was filed on Dec. 21, 2009, and the entire contents of which are incorporated herein by reference.

### BACKGROUND

I. Field

The following description relates to wireless communications, in general, and to distributed scheduling to facilitate interference management in wireless communication systems, in particular.

II. Background

Wireless communication systems are widely deployed to provide various types of communication. For instance, voice and/or data can be provided via such wireless communication systems. A typical wireless communication system, or network, can provide multiple users access to one or more shared resources (e.g., bandwidth, transmit power). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple access communication systems can simultaneously support communication for multiple user equipment (UEs). Each UE can communicate with one or more base stations (BSs) via transmissions on forward and reverse links. The forward link (or downlink (DL)) refers to the communication link from BSs to UEs, and the reverse link (or uplink (UL)) refers to the communication link from UEs to BSs.

In macro-cellular networks, the BS, in particular, and the infrastructure, in general, is typically provided by very few vendors. Moreover, BSs manufactured by different vendors are usually not deployed in neighboring cells. Hence, the task of ensuring meaningful scheduling for coordination of resources, for example, for inter-cell interference management is a straightforward task because typically, the prioritization of traffic would be the same in neighboring cells because the same scheduling policy is used.

However, in Femto environments, Femto BSs may be manufactured by multiple vendors but deployed on a single frequency for a given operator. Femto deployments can therefore create high interference conditions, and interference mitigation across and within Femto cells is desired. However, interference mitigation can be challenging in Femto environments due to the distributed nature of control.

Poor interference mitigation can also lead to inefficient bandwidth usage, lack of fairness in transmission and difficulty in meeting Quality of Service (QoS) constraints for the traffic transmitted and received in and across the Femto cells. Further, scheduling may need to take into account relative priorities of traffic flows across Femto cells as priorities may be differently assigned by the Femto BSs manufactured by different vendors. Accordingly, distributed scheduling employing consistent prioritization mechanisms and across Femto cells to facilitate interference management is desirable.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with distributed scheduling to facilitate interference management in wireless communication systems.

According to related aspects, a method is provided. The method can include: determining, by a base station within a cell, a benefit to out-of-cell user equipment when a base station transmits with certain transmission attributes, wherein the transmission attributes are at least one of a transmit power, beamforming vector or multiple input multiple output transmission; determining, by the base station, a benefit to a user equipment within the cell when the base station transmits with certain transmission attributes; and determining, by the base station, the total benefit to the out-of-cell user equipment and to the user equipment within the cell.

In aspects, a computer program product is provided. The computer program product includes a computer-readable medium, comprising: a first set of codes for causing a computer to determine a benefit to out-of-cell user equipment when a base station transmits with certain transmission attributes, wherein the transmission attributes are at least one of a transmit power, beamforming vector or multiple input multiple output transmission; a second set of codes for causing the computer to determine a benefit to a user equipment within the cell when the base station transmits with certain transmission attributes; and a third set of codes for causing the computer to determine the total benefit to the out-of-cell user equipment and to the user equipment within the cell.

In other aspects, an apparatus is provided. The apparatus can include: means for determining a benefit to out-of-cell user equipment when a base station transmits with certain transmission attributes, wherein the transmission attributes are at least one of a transmit power, beamforming vector or multiple input multiple output transmission; means for determining a benefit to a user equipment within the cell when the base station transmits with certain transmission attributes; and means for determine the total benefit to the out-of-cell user equipment and to the user equipment within the cell.

In other aspects, another apparatus is provided. The apparatus can include: an interference management module configured to: determine a benefit to out-of-cell user equipment when a base station transmits with certain transmission attributes, wherein the transmission attributes are at least one of a transmit power, beamforming vector or multiple input multiple output transmission; determine a benefit to a user equipment within the cell when the base station transmits with certain transmission attributes; and determine the total benefit to the out-of-cell user equipment and to the user equipment within the cell.

In other aspects, another method is provided. The method can include: determining, by a serving base station, a first set of user equipment to contend for a resource; scheduling, by the serving base station, transmission of one or more coordination messages by the first set of user equipment; receiving, by the serving base station, interference information from the first set of user equipment; determining, by the serving base station, a second set of user equipment to transmit information; and scheduling, by the serving base station, transmission of the information to the second set of user equipment.

In another aspect, another computer program product is provided. The computer program product can include a computer-readable medium. The computer-readable medium can include: a first set of codes for causing a computer to determine a first set of user equipment to contend for a resource; a second set of codes for causing the computer to schedule transmission of one or more coordination messages by the first set of user equipment; a third set of codes for causing the computer to receive interference information from the first set of user equipment; a fourth set of codes for causing the computer to determine a second set of user equipment to transmit information; and a fifth set of codes for causing the computer to schedule transmission of the information to the second set of user equipment.

In some aspects, an apparatus is provided. The apparatus can include a means for determining a first set of user equipment to contend for a resource; a means for scheduling transmission of one or more coordination messages by the first set of user equipment; a means for receiving interference information from the first set of user equipment; a means for determining a second set of user equipment to transmit information; and a means for scheduling transmission of the information to the second set of user equipment.

In some aspects, another apparatus is provided. The apparatus can include: an interference management module configured to: determine a first set of user equipment to contend for a resource; schedule transmission of one or more coordination messages by the first set of user equipment; receive interference information from the first set of user equipment; determine a second set of user equipment to transmit information; and schedule transmission of the information to the second set of user equipment.

In other aspects, another method is provided. The method can include: receiving, by a base station in a cell that serves user equipment in the cell, information indicative of a buffer status for one or more logical channel groups at a user equipment; transmitting, by the base station, an interference management request to one or more out-of-cell user equipment; receiving, by the base station, information indicative of intended transmit power from the one or more out-of-cell user equipment and a power commitment by the user equipment in the cell in response to the one or more out-of-cell user equipment receiving the interference management request; and scheduling, by the base station, transmission of data from the user equipment in a cell, wherein the scheduling is based on the information indicative of intended transmit power.

In other aspects, another computer program product including a computer-readable medium is provided. The computer program product can include: a first set of codes for causing a computer to receive information indicative of a buffer status for one or more logical channel groups at a user equipment; a second set of codes for causing the computer to transmit an interference management request to one or more out-of-cell user equipment; and a third set of codes for causing the computer to receive information indicative of intended transmit power from the one or more out-of-cell user equipment and a power commitment by the user equipment in the cell in response to the one or more out-of-cell user equipment receiving the interference management request; and a fourth set of codes for causing the computer to schedule transmission of data from the user equipment in a cell, wherein the scheduling is based on the information indicative of intended transmit power, wherein a base station comprises the computer.

In other aspects, another apparatus is provided. The apparatus can include: means for receiving information indicative of a buffer status for one or more logical channel groups at a user equipment; means for transmitting an interference management request to one or more out-of-cell user equipment; means for receiving information indicative of intended transmit power from the one or more out-of-cell user equipment and a power commitment by the user equipment in the cell in response to the one or more out-of-cell user equipment receiving the interference management request; and means for scheduling transmission of data from the user equipment in a cell, wherein the scheduling is based on the information indicative of intended transmit power, wherein receiving information indicative of a buffer status, transmitting, receiving and scheduling is performed by a base station in the cell that serves the user equipment in the cell.

In other aspects, another apparatus is provided. The apparatus can include: an interference management module configured to: receive information indicative of a buffer status for one or more logical channel groups at a user equipment; transmit an interference management request to one or more out-of-cell user equipment; receive information indicative of intended transmit power from the one or more out-of-cell user equipment and a power commitment by the user equipment in the cell in response to the one or more out-of-cell user equipment receiving the interference management request; and schedule transmission of data from the user equipment in a cell, wherein the scheduling is based on the information indicative of intended transmit power, wherein receiving information indicative of a buffer status, transmitting, receiving and scheduling is performed by a base station in the cell that serves the user equipment in the cell.

In other aspects, another method is provided. The method can include: receiving, by a serving base station, a buffer status report from user equipment having one or more logical channel groups; configuring, by the serving base station, a first priority metric and a first prioritized bit rate for at least one of the one or more logical channel groups, wherein the configuring a first priority metric and a first prioritized bit rate for at least one of the one or more logical channel groups is in response to information included in the buffer status report; determining, by the serving base station, interference at the user equipment; and re-configuring, by the serving base station, the first priority metric and the first prioritized bit rate for the at least one of the one or more logical channel groups in response to the determining interference at the user equipment.

In other aspects, another computer program product including a computer-readable medium is provided. The computer program product can include: a first set of codes for causing a computer to receive a buffer status report from user equipment having one or more logical channel groups; a second set of codes for causing the computer to configure a first priority metric and a first prioritized bit rate for at least one of the one or more logical channel groups, wherein configuring a first priority metric and a first prioritized bit rate for at least one of the one or more logical channel groups is in response to information included in the buffer status report; a third set of codes for causing the computer to determine interference at the user equipment; and a fourth set of codes for causing the computer to re-configure the first priority metric and the first prioritized bit rate for the at least one of the one or more logical channel groups in response to determining interference at the user equipment, wherein a serving base station comprises the computer.

In another aspect, another apparatus is provided. The apparatus can include: means for receiving a buffer status report from user equipment having one or more logical channel groups; means for configuring a first priority metric and a first prioritized bit rate for at least one of the one or more logical channel groups, wherein the configuring a first priority metric and a first prioritized bit rate for at least one of the one or more logical channel groups is in response to information included in the buffer status report; means for determining interference at the user equipment; and means for re-configuring the first priority metric and the first prioritized bit rate for the at least one of the one or more logical channel groups in response to determining interference at the user equipment.

In another aspect, another apparatus is provided. The apparatus can include: a transceiver configured to receive a buffer status report from user equipment having one or more logical channel groups; and a scheduler configured to: configure a first priority metric and a first prioritized bit rate for at least one of the one or more logical channel groups, wherein the configuring a first priority metric and a first prioritized bit rate for at least one of the one or more logical channel groups is in response to information included in the buffer status report; determine interference at the user equipment; and re-configure the first priority metric and the first prioritized bit rate for the at least one of the one or more logical channel groups in response to determining interference at the user equipment.

In another aspect, another method is provided. The method can include: determining, by a base station, head of line delay for one or more logical channel groups at user equipment, wherein the determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

In another aspect, a computer program product, a computer-readable medium, comprising: a first set of codes for causing a computer to determine head of line delay for one or more logical channel groups at user equipment, wherein a base station comprises the computer, and wherein determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

In another aspect, means for determining head of line delay for the one or more logical channel groups at the user equipment, wherein determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

In another aspect, an apparatus is provided. The apparatus can include a scheduler configured to: determine head of line delay for the one or more logical channel groups at the user equipment, wherein determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

In another aspect, another method is provided. The method can include: transmitting, by user equipment, a buffer status report from user equipment having one or more logical channel groups; receiving, by the user equipment, information for configuring a priority metric and a prioritized bit rate for at least one of the one or more logical channel groups, wherein the configuring a priority metric and a prioritized bit rate for at least one of the one or more logical channel groups is in response to information included in the buffer status report; and receiving, the user equipment, information for re-configuring the priority metric and the prioritized bit rate for the at least one of the one or more logical channel groups in response to a serving base station for the user equipment having one or more logical channel groups determining interference at the user equipment having one or more logical channel groups.

In another aspect, another computer program product including a computer-readable medium is provided. The computer program product can include a first set of codes for causing a computer to transmit a buffer status report from user equipment having one or more logical channel groups; a second set of codes for causing the computer to receive information for configuring a priority metric and a prioritized bit rate for at least one of the one or more logical channel groups, wherein the configuring a priority metric and a prioritized bit rate for at least one of the one or more logical channel groups is in response to information included in the buffer status report; and a third set of codes for causing the computer to receive information for re-configuring the priority metric and the prioritized bit rate for the at least one of the one or more logical channel groups in response to a serving base station for the user equipment having one or more logical channel groups determining interference at the user equipment having one or more logical channel groups, wherein the user equipment comprises the computer.

In another aspect, another apparatus is provided. The apparatus can include: means for transmitting a buffer status report from user equipment having one or more logical channel groups; means for receiving information for configuring a priority metric and a prioritized bit rate for at least one of the one or more logical channel groups, wherein the configuring a priority metric and a prioritized bit rate for at least one of the one or more logical channel groups is in response to information included in the buffer status report; and means for receiving information for re-configuring the priority metric and the prioritized bit rate for the at least one of the one or more logical channel groups in response to a serving base station for the user equipment having one or more logical channel groups determining interference at the user equipment having one or more logical channel groups.

In another aspect, another apparatus is provided. The apparatus can include a transceiver configured to: transmit a buffer status report from user equipment having one or more logical channel groups; receive information for configuring a priority metric and a prioritized bit rate for at least one of the one or more logical channel groups, wherein the configuring a priority metric and a prioritized bit rate for at least one of the one or more logical channel groups is in response to information included in the buffer status report; and receive information for re-configuring the priority metric and the prioritized bit rate for the at least one of the one or more logical channel groups in response to a serving base station for the user equipment having one or more logical channel groups determining interference at the user equipment having one or more logical channel groups.

In another aspect, a method can include. The method can include: selecting, by a base station in a first cell, one or more user equipment of the first cell to schedule on the uplink, wherein the selecting is based on one or more of: interference caused by the one or more user equipment of the first cell to one or more base stations of a second cell, interference received if interference management requests for the one or more user equipment of the first cell are transmitted, a priority of traffic for the one or more user equipment of the first cell, a serving link gain from the one or more user equipment of the first cell to the base station, instantaneous buffer state for the one or more user equipment of the first cell, channel quality indicator for the one or more user equipment of the first cell, the head of line delay for the one or more user equipment of the first cell.

In another aspect, another computer program product including a computer-readable medium is provided. The computer program product can include a first set of codes for causing a computer to select one or more user equipment of a first cell to schedule on an uplink, wherein selecting is based on one or more of: interference caused by the one or more user equipment of the first cell to one or more base stations of a second cell, interference estimated if interference management requests for the one or more user equipment of the first cell are transmitted, a priority of traffic for the one or more user equipment of the first cell, a serving link gain from the one or more user equipment of the first cell to the base station, instantaneous buffer state for the one or more user equipment of the first cell, channel quality indicator for the one or more user equipment of the first cell, the head of line delay for the one or more user equipment of the first cell.

In another aspect, an apparatus is provided. The apparatus can include: means for selecting one or more user equipment of a first cell to schedule on an uplink, wherein selecting is based on one or more of: interference caused by the one or more user equipment of the first cell to one or more base stations of a second cell, interference estimated if interference management requests for the one or more user equipment of the first cell are transmitted, a priority of traffic for the one or more user equipment of the first cell, a serving link gain from the one or more user equipment of the first cell to the base station, instantaneous buffer state for the one or more user equipment of the first cell, channel quality indicator for the one or more user equipment of the first cell, the head of line delay for the one or more user equipment of the first cell.

In another aspect, an apparatus is provided. The apparatus can include: an interference management module configured to: select one or more user equipment of a first cell to schedule on an uplink, wherein selecting is based on one or more of: interference caused by the one or more user equipment of the first cell to one or more base stations of a second cell, interference estimated if interference management requests for the one or more user equipment of the first cell are transmitted, a priority of traffic for the one or more user equipment of the first cell, a serving link gain from the one or more user equipment of the first cell to the base station, instantaneous buffer state for the one or more user equipment of the first cell or the head of line delay for the one or more user equipment of the first cell.

In another aspect, another method is provided. The method can include: determining, by a serving base station, a first set of user equipment to contend for a resource; scheduling, by the serving base station, transmission of one or more coordination messages to out-of-cell user equipment; receiving, by the serving base station, interference information; determining, by the serving base station, a second set of user equipment to transmit information, wherein the determining a second set of user equipment to transmit information is in response to determining one or more of the interference information or an interference commitment made for a first set of user equipment; and scheduling, by the serving base station, transmission of the information by a second set of user equipment.

In another aspect, another computer program product including a computer-readable medium is provided. The computer program product can include a first set of codes for causing a computer to determine a first set of user equipment to contend for a resource; a second set of codes for causing the computer to schedule transmission of one or more coordination messages to out-of-cell user equipment; a third set of codes for causing the computer to receive interference information; a fourth set of codes for causing the computer to determine a second set of user equipment to transmit information; and a fifth set of codes for causing the computer to schedule transmission of the information by the second set of user equipment, wherein a serving base station comprises the computer.

In another aspect, another apparatus is provided. The apparatus can include: means for determining a first set of user equipment to contend for a resource; means for scheduling transmission of one or more coordination messages to out-of-cell user equipment; means for receiving interference information; means for determining a second set of user equipment to transmit information, wherein the determining a second set of user equipment to transmit information is in response to determining one or more of the interference information or an interference commitment made for a first set of user equipment; and means for scheduling transmission of the information by a second set of user equipment.

In another aspect, another apparatus is provided. The apparatus can include an interference management module configured to: determine a first set of user equipment to contend for a resource; schedule transmission of one or more coordination messages to out-of-cell user equipment; receive interference information; determine a second set of user equipment to transmit information, wherein determining a second set of user equipment to transmit information is in response to determining one or more of the interference information or an interference commitment made for a first set of user equipment; and schedule transmission of the information by a second set of user equipment.

In another aspect, another method is provided. The method can include receiving, by a base station in a first cell, a buffer status request; and transmitting, by the base station, an interference management request, wherein the interference management request is based on the buffer status request, wherein the transmitting the interference management request comprises transmitting the interference management request over a backhaul to a base station in a second cell.

In another aspect, another computer program product including a computer-readable medium is provided. The computer program product can include: a first set of codes for causing a computer to receive a buffer status request; and a second set of codes for causing the computer to transmit an interference management request, wherein the interference management request is based on the buffer status request, and wherein the receiving and the transmitting is performed by a base station in a first cell, wherein the transmitting the interference management request comprises transmitting the interference management request over a backhaul to a base station in a second cell.

In another aspect, another apparatus is provided. The apparatus can include: means for receiving a buffer status request; and means for transmitting an interference management request, wherein the interference management request is based on the buffer status request, and wherein the receiving and the transmitting is performed by a base station in a first cell, wherein the transmitting the interference management request comprises transmitting the interference management request over a backhaul to a base station in a second cell.

In other aspects, another apparatus is provided. The apparatus can include an interference management module configured to: receive a buffer status request; and transmit an interference management request, wherein the interference management request is based on the buffer status request, and wherein the receiving and the transmitting is performed by a base station in a first cell, wherein the transmitting the interference management request comprises transmitting the interference management request over a backhaul to a base station in a second cell.

Toward the accomplishment of the foregoing and related ends, the one or more embodiments comprise the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of an example wireless communication system for facilitating interference management in accordance with various aspects set forth herein.

FIG. 2 is an illustration of another example wireless communication system for facilitating interference management for a number of users in accordance with various aspects set forth herein.

FIG. 3 is an illustration of an example wireless communication system where one or more Femto nodes are deployed for facilitating interference management in accordance with various aspects set forth herein.

FIG. 4 is an illustration of an example coverage map in a wireless communication system for facilitating interference management in accordance with various aspects set forth herein.

FIG. 5A illustrates an example block diagram of a wireless communication system for facilitating interference management on the downlink in accordance with various aspects set forth herein.

FIG. 5B illustrates an example block diagram of a wireless communication system for facilitating interference management on the uplink in accordance with various aspects set forth herein.

FIG. 6 is an illustration of a flowchart of an example method for distributed scheduling to facilitate interference management in accordance with various aspects set forth herein.

FIG. 7A is an illustration of a flowchart of an example method of determining the priority of traffic for a UE on the downlink in accordance with various aspects set forth herein.

FIG. 7B is an illustration of an example graph showing user experience for average transmission rate with best effort traffic in accordance with various aspects set forth herein.

FIG. 8 is an illustration of a flowchart of an example method of scheduling in accordance with various aspects set forth herein.

FIG. 9 is an illustration of an example of a flowchart of a method for selecting a first set of UE for transmission of coordination messages in accordance with various aspects set forth herein.

FIG. 10 is a block diagram of an example BS for computing a head of line delay at a UE for use in distributed scheduling to facilitate interference management in accordance with various aspects set forth herein.

FIG. 11 is an illustration of an example of a flowchart of a method for computing a head of line delay at a UE for use in distributed scheduling to facilitate interference management in accordance with various aspects set forth herein.

FIGS. 12A, 12B, 12C, 12D, 12E, 12F, 12G, 12H, 12I, 12J, 12K, 12L, 12M, 12N and 12O are illustrations of examples of flowcharts of methods of scheduling in accordance with various aspects set forth herein.

FIG. 13 is an illustration of a block diagram of a system employing feedback for configuring parameters to facilitate interference management on the uplink in wireless communication systems in accordance with various aspects set forth herein.

FIG. 14 is an illustration of an example of a flowchart of a method of configuring parameters at a UE to facilitate interference management on the uplink in a wireless communication system in accordance with various aspects set forth herein.

FIGS. 15A, 15B, 15C, 15D and 15E are illustrations of examples of flowcharts of methods of resource allocation on an uplink in a wireless communication system in accordance with various aspects set forth herein.

FIGS. 16, 17, 18, 19, 20, 21, 22, 23, 24, 25, 26, 27, 28, 29, 30, 31, 32, 33, 34, 35, 36, 37, 38, 39 and 40 are illustrations of block diagrams of example systems for facilitating interference management in accordance with various aspects set forth herein.

FIG. 41 shows an example wireless communication system in which the embodiments described herein can be employed in accordance with various aspects set forth herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and/or other systems. The terms “system” and “network” are often used interchangeably. A CDMA system can implement a radio technology such as Universal Terrestrial Radio Access (UTRA), CDMA8020, etc. UTRA includes Wideband-CDMA (W-CDMA) and other variants of CDMA. CDMA8020 covers IS-8020, IS-95 and IS-856 standards. An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA8020 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA) utilizes single carrier modulation and frequency domain equalization. SC-FDMA can have similar performance and essentially the same overall complexity as those of an OFDMA system. A SC-FDMA signal can have lower peak-to-average power ratio (PAPR) because of its inherent single carrier structure. SC-FDMA can be used, for instance, in uplink communications where lower PAPR greatly benefits UEs in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with UEs. A UE can also be called a system, subscriber unit, subscriber station, mobile station, mobile, remote station, remote terminal, mobile device, access terminal, wireless communication device, user agent or user device. A UE can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a BS or access node (AN). A BS can be utilized for communicating with UEs and can also be referred to as an access point, BS, Femto node, Pico Node, Node B, Evolved Node B (eNodeB, eNB) or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include, but are not limited to, magnetic storage devices (e.g., hard disk, floppy disk, magnetic strips), optical disks (e.g., compact disk (CD), digital versatile disk (DVD)), smart cards, and flash memory devices (e.g., EPROM, card, stick, key drive). Additionally, various storage media described herein can represent one or more devices and/or other machine-readable media for storing information. The term “machine-readable medium” can include, without being limited to, wireless channels and various other media (and/or storage media) capable of storing, containing, and/or carrying codes and/or instruction(s) and/or data.

In some aspects the teachings herein may be employed in a network that includes macro scale coverage (e.g., a large area cellular network such as a 3G networks, typically referred to as a macro cell network) and smaller scale coverage (e.g., a residence-based or building-based network environment). A UE moves through such a network. The UE may be served in certain locations by BSs that provide macro coverage while the UE may be served at other locations by BSs that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a Macro node. A node that provides coverage over a relatively small area (e.g., a residence) may be referred to as a Femto node. A node that provides coverage over an area that is smaller than a macro area and larger than a Femto area may be referred to as a Pico node (e.g., providing coverage within a commercial building).

A cell associated with a Macro node, a Femto node, or a Pico node may be referred to as a macro cell, a Femto cell, or a Pico cell, respectively. In some implementations, each cell may be further associated with (e.g., divided into) one or more sectors.

In various applications, other terminology may be used to reference a Macro node, a Femto node, or a Pico node. For example, a Macro node may be configured or referred to as a BS, access point, eNodeB, macro cell, and so on. Also, a Femto node may be configured or referred to as a Home NodeB, Home eNodeB, access point access node, a BS, a Femto cell, and so on.

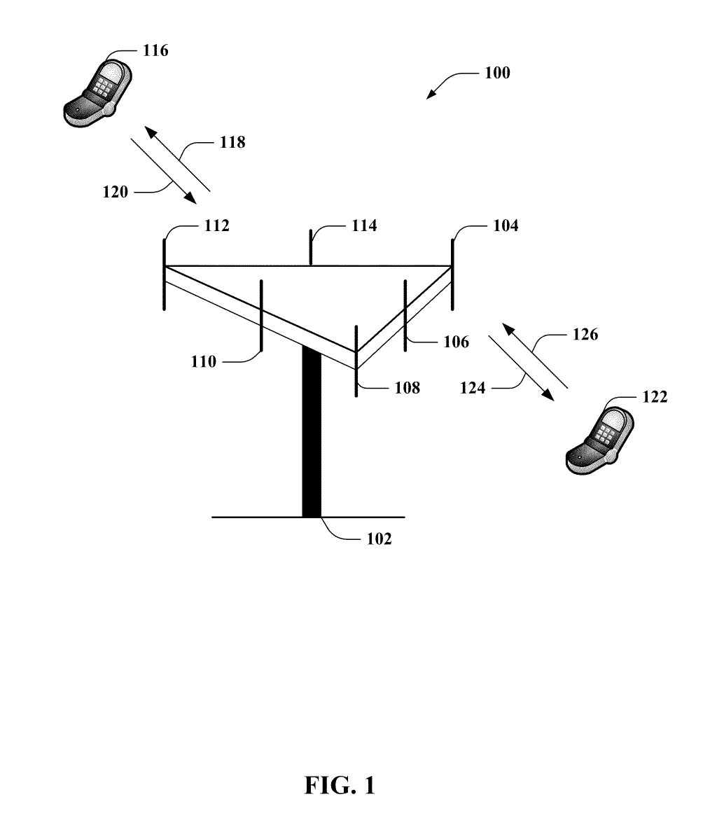

FIG. 1 is an illustration of an example wireless communication system for facilitating interference management in accordance with various aspects set forth herein. In wireless communication system 100, interference caused by transmissions on the UL can be managed by the BS 102 while interference caused by transmissions on the DL can be managed by the UEs 116, 122.

Referring now to FIG. 1, a wireless communication system 100 is illustrated in accordance with various embodiments presented herein. System 100 includes a BS 102 that can include multiple antenna groups. For example, one antenna group can include antennas 104, 106, another group can comprise antennas 108, 110, and an additional group can include antennas 112, 114. Two antennas are illustrated for each antenna group; however, more or fewer antennas can be utilized for each group. BS 102 can additionally include a transmitting node chain and a receiving node chain, each of which can in turn comprise a plurality of components associated with signal transmission and reception (e.g., processors, modulators, multiplexers, demodulators, demultiplexers, antennas), as will be appreciated by one skilled in the art.

BS 102 can communicate with one or more UEs such as UE 116, 122. However, it is to be appreciated that BS 102 can communicate with substantially any number of UEs similar to UEs 116, 122. UEs 116, 122 can be, for example, cellular phones, smart phones, laptops, handheld communication devices, handheld computing devices, satellite radios, global positioning systems, PDAs, and/or any other suitable device for communicating over wireless communication system 100. As depicted, UE 116 is in communication with antennas 112, 114, where antennas 112, 114 transmit information to UE 116 over DL 118 and receive information from UE 116 over a UL 120. Moreover, UE 122 is in communication with antennas 104, 106, where antennas 104, 106 transmit information to UE 122 over a DL 124 and receive information from UE 122 over a UL 126. In a frequency division duplex (FDD) system, DL 118 can utilize a different frequency band than that used by UL 120, and DL 124 can employ a different frequency band than that employed by UL 126, for example. Further, in a time division duplex (TDD) system, DL 118 and UL 120 can utilize a common frequency band and DL 124 and UL 126 can utilize a common frequency band.

Each group of antennas and/or the area in which they are designated to communicate can be referred to as a sector of BS 102. For example, antenna groups can be designed to communicate to UEs in a sector of the areas covered by BS 102. In communication over DLs 118, 124, the transmitting antennas of BS 102 can utilize beamforming to improve signal-to-noise ratio of DLs 118, 124 for UEs 116, 122. Also, while BS 102 utilizes beamforming to transmit to UEs 116, 122 scattered randomly through an associated coverage, UEs 116, 122 in neighboring cells can be subject to less interference as compared to a BS transmitting through a single antenna to all its UEs. Further, the BS 102 and UEs 116, 122 can be configured for facilitating interference management as described herein.

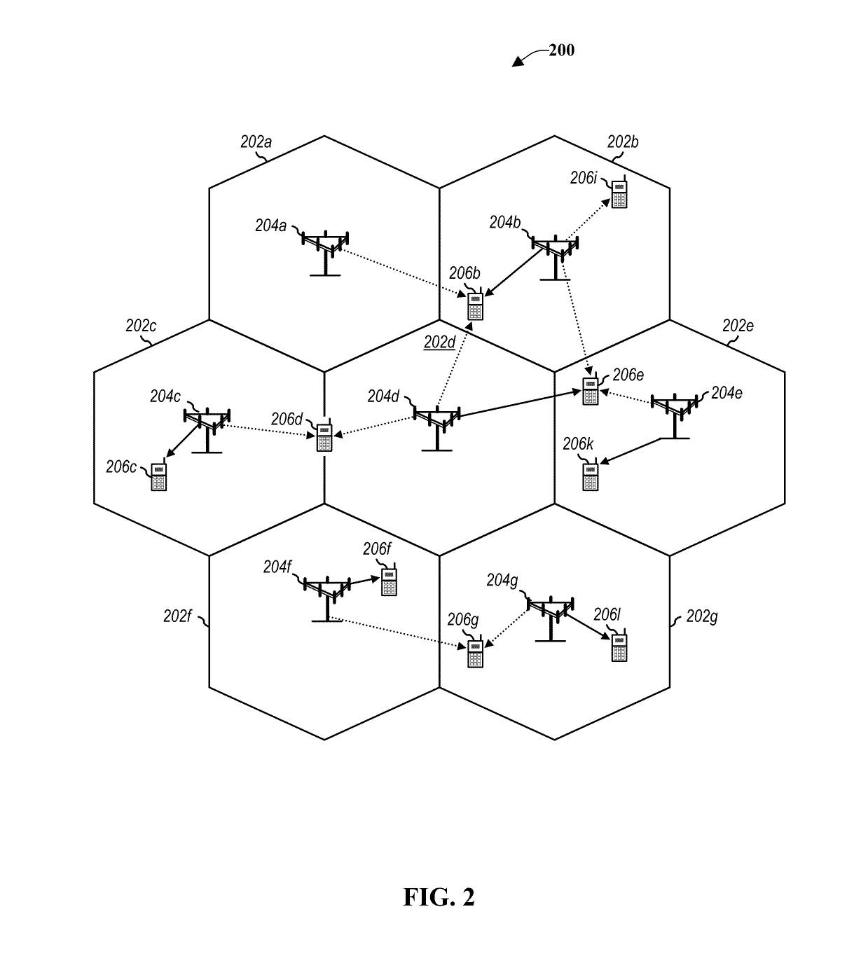

FIG. 2 is an illustration of another example wireless communication system for facilitating interference management for a number of users in accordance with various aspects set forth herein. The system 200 provides communication for multiple cells 202, such as, for example, macro cells 202A-202G, with each cell being serviced by a corresponding BS 204 (e.g., BS 204A-204G). As shown in FIG. 2, UE 206 (e.g., UEs 206A-206L) can be dispersed at various locations throughout the system over time. Each UE 206 can communicate with one or more BS 204 on a DL or a UL at a given moment, depending upon whether the UE 206 is active and whether it is in soft handoff, for example. The wireless communication system 200 may provide service over a large geographic region. For example, macro cells 202A-202G may cover a few blocks in a neighborhood.

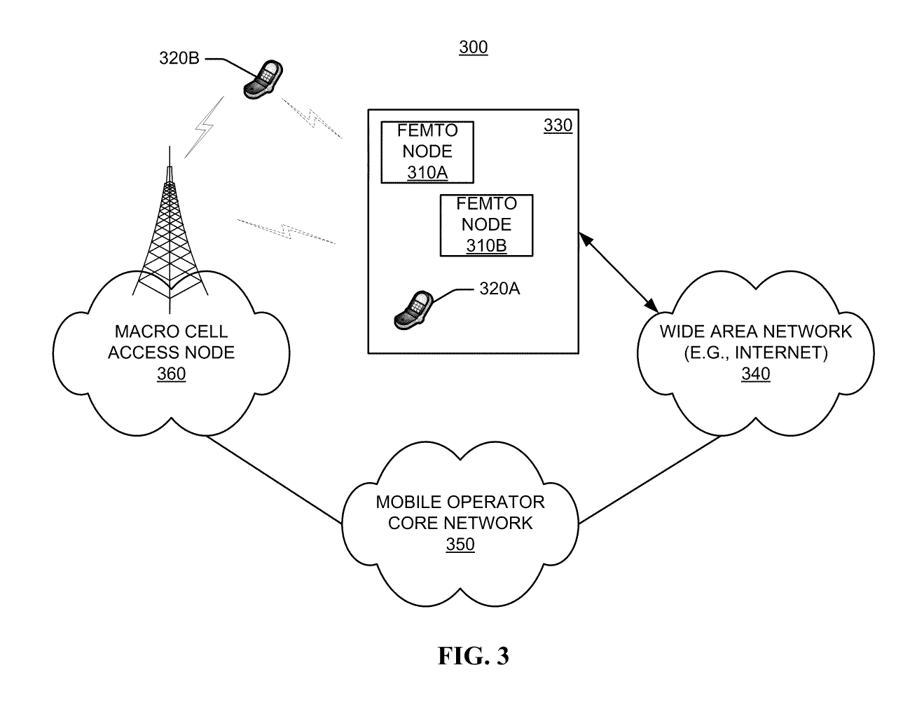

FIG. 3 is an illustration of an example wireless communication system where one or more Femto nodes are deployed for facilitating interference management in accordance with various aspects set forth herein. Specifically, the system 300 includes multiple Femto nodes 310 (e.g., Femto nodes 310A and 310B) installed in a relatively small scale network environment (e.g., in one or more user residences 330). Each Femto node 310 can be coupled to a wide area network 340 (e.g., the Internet) and a mobile operator core network 350 via a DSL router, a cable modem, a wireless link, or other connectivity means (not shown). As will be discussed below, each Femto node 310 can be configured to serve associated UEs (e.g., associated UE 320A) and, optionally, alien UEs (e.g., alien UE 320B). In other words, access to Femto nodes 310 may be restricted whereby a given UE 320 can be served by a set of designated (e.g., home) Femto node(s) 310 but may not be served by any non-designated Femto nodes 310 (e.g., a neighbor's Femto node 310).

However, in various embodiments, an associated UE 320A can experience interference on the DL from a Femto node 310 serving an alien UE 320B. Similarly, a Femto node 310 associated with associated UE 320A can experience interference on the UL from the alien UE 320B. In embodiments, interference management can be facilitated in the system 300 as described herein.

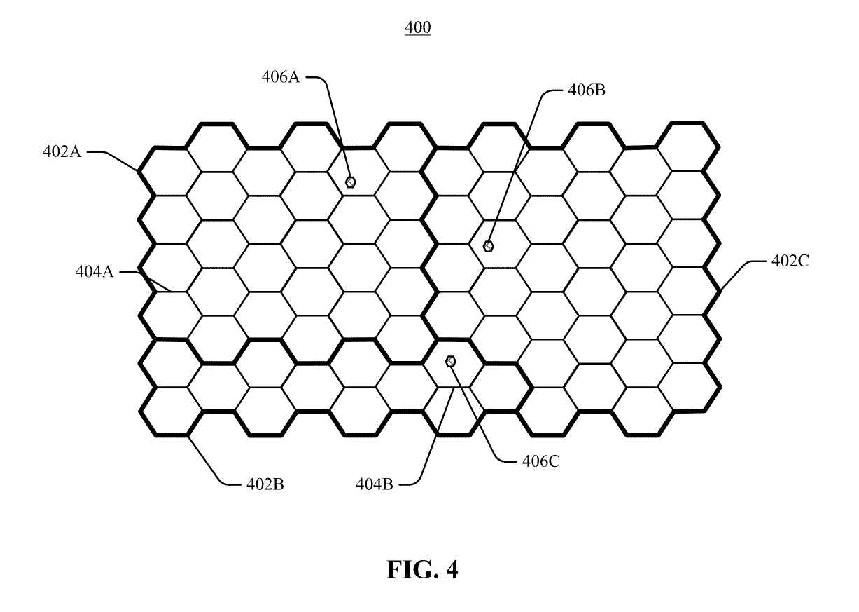

FIG. 4 is an illustration of an example coverage map in a wireless communication system for facilitating interference management in accordance with various aspects set forth herein. The coverage map 400 can include several tracking areas 402 (or routing areas or location areas), each of which can include several macro coverage areas. In the embodiment shown, areas of coverage associated with tracking areas 402A, 402B, and 402C are delineated by the wide lines and the macro coverage areas 404 are represented by the hexagons. The tracking areas 402A, 402B, and 402C can include Femto coverage areas 406. In this example, each of the Femto coverage areas 406 (e.g., Femto coverage area 406C) is depicted within a macro coverage area 404 (e.g., macro coverage area 404B). It should be appreciated, however, that a Femto coverage area 406 may not lie entirely within a macro coverage area 404. In practice, a large number of Femto coverage areas 406 can be defined with a given tracking area 402 or macro coverage area 404. Also, one or more Pico coverage areas (not shown) can be defined within a given tracking area 402 or macro coverage area 404.

Referring again to FIG. 3, the owner of a Femto node 310 can subscribe to mobile service, such as, for example, 3G mobile service, offered through the mobile operator core network 350. In addition, a UE 320 may be capable of operating both in macro environments and in smaller scale (e.g., residential) network environments. In other words, depending on the current location of the UE 320, the UE 320 may be served by an access node 360 of the macro cell mobile network 350 or by any one of a set of Femto nodes 310 (e.g., the Femto nodes 310A and 310B that reside within a corresponding user residence 330). For example, when a subscriber is outside his home, he is served by a standard macro access node (e.g., node 360) and when the subscriber is at home, he is served by a Femto node (e.g., node 310A). Here, it should be appreciated that a Femto node 310 may be backward compatible with existing UEs 320.

A Femto node 310 may be deployed on a single frequency or, in the alternative, on multiple frequencies. Depending on the particular configuration, the single frequency or one or more of the multiple frequencies can overlap with one or more frequencies used by a Macro node (e.g., node 360).

In some aspects, a UE 320 can be configured to connect to a preferred Femto node (e.g., the home Femto node of the UE 320) whenever such connectivity is possible. For example, whenever the UE 320 is within the user's residence 330, it may be desired that the UE 320 communicate only with the home Femto node 310.

In some aspects, if the UE 320 operates within the macro cellular network 350 but is not residing on its most preferred network (e.g., as defined in a preferred roaming list), the UE 320 may continue to search for the most preferred network (e.g., the preferred Femto node 310) using a Better System Reselection (BSR), which can involve a periodic scanning of available systems to determine whether better systems are currently available, and subsequent efforts to associate with such preferred systems. With the acquisition entry, the UE 320 may limit the search for specific band and channel. For example, the search for the most preferred system may be repeated periodically. Upon discovery of a preferred Femto node 310, the UE 320 selects the Femto node 310 for camping within its coverage area.

A Femto node may be restricted in some aspects. For example, a given Femto node may only provide certain services to certain UEs. In deployments with so-called restricted (or closed) association, a given UE may only be served by the macro cell mobile network and a defined set of Femto nodes (e.g., the Femto nodes 310 that reside within the corresponding user residence 330). In some implementations, a node may be restricted to not provide, for at least one node, at least one of: signaling, data access, registration, paging, or service.

In some aspects, a restricted Femto node (which may also be referred to as a Closed Subscriber Group Home NodeB) is one that provides service to a restricted provisioned set of UEs. This set may be temporarily or permanently extended as necessary. In some aspects, a Closed Subscriber Group (CSG) may be defined as the set of BSs (e.g., Femto nodes) that share a common access control list of UEs. A channel on which all Femto nodes (or all restricted Femto nodes) in a region operate may be referred to as a Femto channel.

Various relationships may thus exist between a given Femto node and a given UE. For example, from the perspective of a UE, an open Femto node may refer to a Femto node with no restricted association. A restricted Femto node may refer to a Femto node that is restricted in some manner (e.g., restricted for association and/or registration). A home Femto node may refer to a Femto node on which the UE is authorized to access and operate on. A guest Femto node may refer to a Femto node on which a UE is temporarily authorized to access or operate on. An alien Femto node may refer to a Femto node on which the UE is not authorized to access or operate on, except for perhaps emergency situations (e.g., 911 calls).

From a restricted Femto node perspective, a home UE may refer to a UE that authorized to access the restricted Femto node. A guest UE may refer to a UE with temporary access to the restricted Femto node. An alien UE may refer to a UE that does not have permission to access the restricted Femto node, except for perhaps emergency situations, for example, such as 911 calls (e.g., a UE that does not have the credentials or permission to register with the restricted Femto node).

While the description of FIG. 4 has been provided with reference to a Femto node, it should be appreciated, that a Pico node may provide the same or similar functionality for a larger coverage area. For example, a Pico node may be restricted, a home Pico node may be defined for a given UE, and so on.

A wireless multiple-access communication system can simultaneously support communication for multiple wireless UEs. As mentioned above, each UE can communicate with one or more BSs via transmissions on the DL or the UL. These communication links (i.e., DL and UL) may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system can support TDD and FDD. In a TDD system, the DL and UL transmissions can be on the same frequency region so that the reciprocity principle allows the estimation of the DL channel from the UL. This enables the BS to transmit beam-forming gain on the DL when multiple antennas are available at the BS. In some embodiments, the channel conditions of the UL channel can be estimated from the DL channel, for interference management, as described herein.

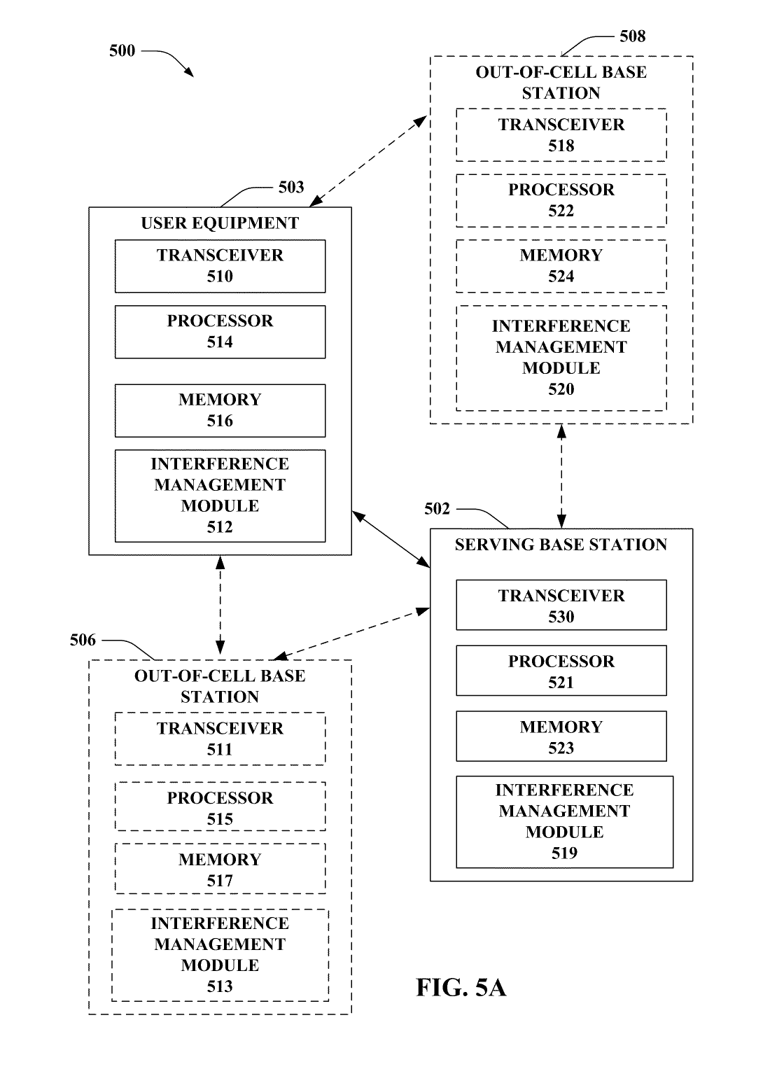

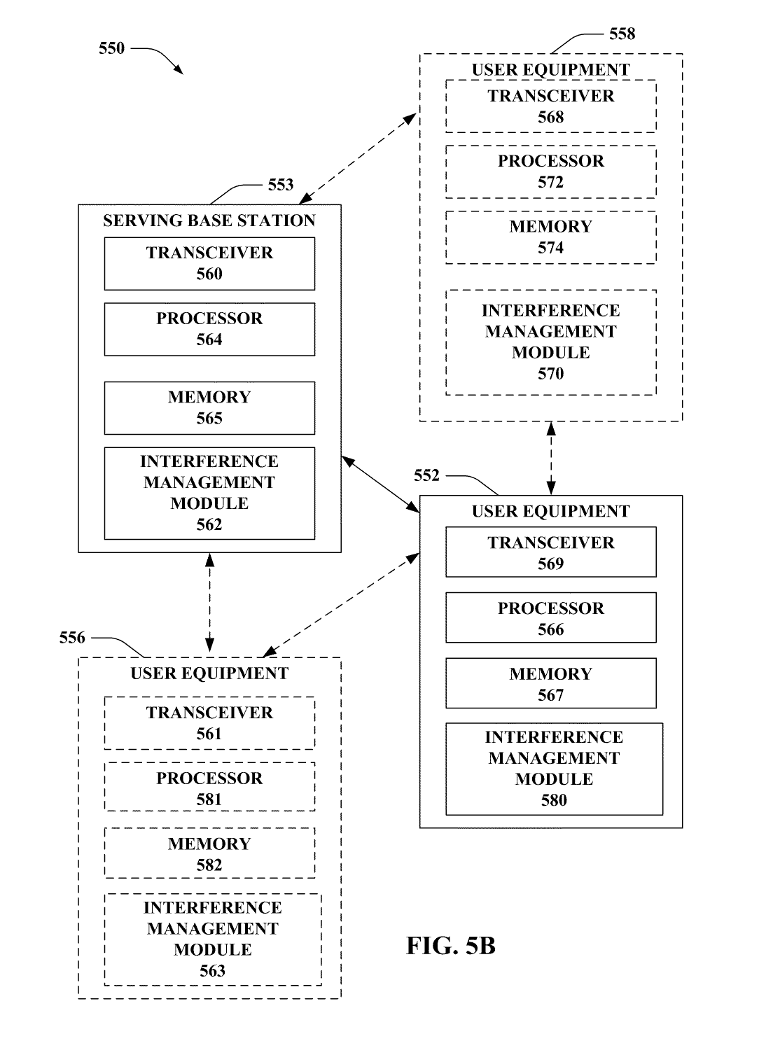

FIG. 5A illustrates an example block diagram of a wireless communication system for facilitating interference management on the DL. The system 500 can manage (e.g., control and/or reduce) interference between BSs and a UE on the DL. In various embodiments, system 500 can be an LTE system, an LTE-A system or any type of system in which the described operations can be performed.

In one or more embodiments, one or more of the BSs 502, 506, 508 and/or the UE 503 can perform one or more of the steps of the methods and/or claimed described herein.

The system 500 can include one or more BSs 502, 506, 508, and at least one UE 503. The UE 503 can be a receiver able to receive or detect the information transmitted by the BSs 502, 506, 508.

In some embodiments, BS 502 serves UE 503 and can transmit without causing interference to UE 503. In some embodiments, BSs 506, 508 are interfering BSs that do not serve UE 503. The BSs 506, 508 can transmit and cause interference to the UE 503 when the UE 503 receives or detects the transmission by the BSs 506, 508. The UE 503 and/or the BSs 502, 506, 508 can be configured to provide interference management in the system 500 for managing and/or controlling the interference at the UE 503.

In various embodiments, a serving communication link can be indicated by a solid line between the serving BS 502 and the UE 503 while a cross communication link can be indicated by a dotted line between the out-of-cell BSs 506, 508 and the UE 503. The serving communication link can indicate a non-interfering link and a cross communication link can indicate an interfering link.

The BSs 502, 506, 508 can include transceivers 530, 511, 518, respectively, and the UE 503 can include a transceiver 510, configured to transmit and/or receive information. The information transmitted and/or received, can include, but is not limited to, data, control channel information, pilot signals and/or any information that can be transmitted or received over a wireless communication channel.

The BSs 502, 506, 508 can include interference management modules 519, 513, 520, respectively, and the UE 503 can include an interference management module 512. Interference management module 519, 513, 520 can differ in structure and/or functionality from interference management module 512. Similarly, interference management modules 519, 513, 520 can differ according to the functionality with which the associated BS is configured.

In some embodiments, the interference management modules 519, 513, 520, 512 can be configured to perform one or more of the functions for interference management described herein with reference to the systems, methods, apparatus and/or computer program products. By way of example, but not limitation, the functions for interference management can include computing and/or determining and/or setting a value for nominal interference, interference, nominal signal-to-interference and noise ratio, intended transmit powers, and transmit powers, priority of traffic, channel gain, channel gain information and/or buffer state information. The channel gain can be the receiving signal power relative to a nominal transmit power. The channel gain can be expressed as a log value comparing, a fraction comparing or a difference between, the received signal power relative to a nominal transmit power. In some embodiments, the nominal transmit power is known to the UE or the BS computing the channel gain. Channel gain information can include the channel gain.

By way of other examples, but not limitation, the functions for interference management can include scheduling transmissions. By way of other examples, but not limitation, the functions for interference management can include comparing, for an intended transmission by a BS in a first cell, the benefit to the BS in the first cell (or a UE served by the BS in the first cell) to transmit as compared to the degradation to a UE in a second cell, for the BS in the first cell to transmit. The degradation can be due to the transmission by the BS.

The BSs 502, 506, 508 can include processors 521, 515, 522, respectively. The UE 503 can include a processor 514. Processors 521, 515, 522, 514 can be configured to perform one or more of the functions described herein with reference to any of the systems, methods, apparatus and/or computer program products.

The BSs 502, 506, 508 can include memory 523, 517, 524, respectively, and the UE 503 can include a memory 516. The memory 523, 517, 524, 516 can be for storing computer-executable instructions and/or information for performing the functions described herein with reference to any of the systems, methods, apparatus and/or computer program products.

In some embodiments, the BSs 502, 506, 508 can include a provisioning interface (not shown) for mapping one or more parameters to a priority metric indicative of a priority of traffic at UEs served by the BSs 502, 506, 508.

In the embodiment shown, which illustrates an interference relationship on the downlink, the BSs 502, 506, 508 can be BSs and the UE 503 can be a UE. The BSs 506, 508 can be interfering BSs that are located in cells other than the cell in which the UE 503 is located. The transmissions by the BSs 506, 506 can create interference at the UE 503. The BS 502 can be a serving BS located in the cell with the UE 503 and serving the UE 503. Accordingly, the transmissions by the BS 502 can be non-interfering transmissions in various embodiments.

FIG. 5B illustrates an example block diagram of a wireless communication system for facilitating interference management on the UL. The system 550 can manage (e.g., control and/or reduce) interference between UEs and a serving BS on the UL. In various embodiments, system 550 can be an LTE system, an LTE-A system or any type of system in which the described operations can be performed.

In one or more embodiments, one or more of the components of system 550 can perform one or more of the steps of the methods and/or claimed described herein.

The system 550 can include UEs 552, 556, 558, and at least one serving BS 553. In some embodiments, the UEs 552, 556, 558 can be UEs transmitting information over wireless communication channels in the wireless communication system. The serving BS 553 can be a receiver able to receive or detect the information transmitted by the UEs. By way of example, the serving BS 553 can be a BS able to receive or detect information transmitted on the UL, and the UEs 552, 556, 558 can be UEs able to transmit information on the UL.

In some embodiments, UE 552 is served by serving BS 553 and can transmit without causing interference to serving BS 553. In some embodiments, UEs 556, 558 are interfering UEs that are not served by the serving BS 553. The UEs 556, 558 can transmit and cause interference to the serving BS 553 when the serving BS 553 receives or detects the transmission by the UEs 556, 558. The serving BS 553 and/or the UEs 552, 556, 558 can be configured to provide interference management in the system 550 for managing and/or controlling the interference at the serving BS 553.

In various embodiments, a serving communication link can be indicated by a solid line between the UE 552 and the serving BS 553 while a cross communication link can be indicated by a dotted line between the UEs 556, 558 and the serving BS 553. The serving communication link can indicate a non-interfering link and a cross communication link can indicate an interfering link.

The UEs 552, 556, 558 can include transceivers 569, 561, 568, respectively, and the serving BS 553 can include a transceiver 560, configured to transmit and/or receive information. The information transmitted and/or received, can include, but is not limited to, data, control channel information, pilot signals and/or any information that can be transmitted or received over a wireless communication channel.

The UEs 552, 556, 558 can include interference management modules 580, 563, 570, respectively, and the serving BS 553 can include an interference management module 562, configured to performing one or more of the functions for interference management described herein with reference to any of the systems, methods, apparatus and/or computer program products. Interference management modules 580, 563, 570 can differ in structure and/or functionality from interference management module 563. Similarly, interference management modules 580, 563, 570 can differ according to the functionality with which the UE is configured.

In some embodiments, the interference management modules 580, 563, 570, 562 can be configured to perform one or more of the functions for interference management described herein with reference to the systems, methods, apparatus and/or computer program products. By way of example, but not limitation, the functions for interference management can include computing and/or determining and/or setting a value for nominal interference, interference, nominal signal-to-interference and noise ratio, intended transmit powers, and transmit powers, priority of traffic, channel gain information and/or buffer state information. By way of other examples, but not limitation, the functions for interference management can include scheduling transmissions. By way of other examples, but not limitation, the functions for interference management can include comparing, for an intended transmission by a UE in a first cell, the benefit to the UE in the first cell to transmit as compared to the degradation to a UE in a second cell and/or a BS in a second cell. The degradation can be due to the transmission by the UE in the first cell.

The UEs 552, 556, 558 can include processors 566, 581, 572, respectively. The serving BS 553 can include a processor 564. Processors 566, 581, 572, 564 can be configured to perform one or more of the functions described herein with reference to any of the systems, methods, apparatus and/or computer program products.

The UEs 552, 556, 558 can include memory 567, 582, 574, respectively, and the serving BS 553 can include a memory 565. The memory 567, 582, 574, 565 can be for storing computer-executable instructions and/or information for performing the functions described herein with reference to any of the systems, methods, apparatus and/or computer program products.

In some embodiments, the BS 553 can include a provisioning interface (not shown) for mapping one or more parameters to a priority metric indicative of a priority of traffic at UE 552 served by the BS 553.

In the embodiment shown, which illustrates an interference relationship on the UL, the serving BS 553 can be a serving BS for UE 552. The UEs 556, 588 can be interfering UEs that are located in cells other than the cell in which the serving BS 553 is located. The transmissions by the UEs 556, 558 can create interference at the serving BS 553. The serving BS 553 can be a serving BS located in the cell with the UE 552. Accordingly, the transmissions by the UE 552 can be non-interfering transmissions in various embodiments.

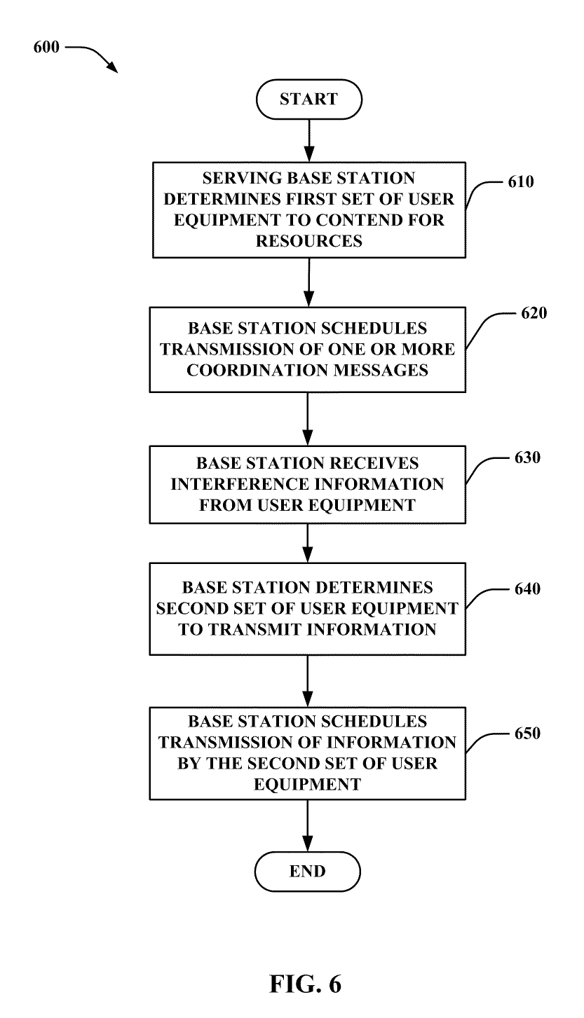

FIG. 6 is an illustration of an example of a flowchart of a method for distributed scheduling to facilitate interference management in accordance with various aspects set forth herein. Method 600 can be employed to facilitate a serving BS scheduling transmission of coordination messages and/or information generally, by UEs in a cell. The information that the UEs can transmit can include, but is not limited to, data, control channel information, pilot signals and/or any information that can be transmitted or received over a wireless communication channel. In various embodiments, the UE that is scheduled for transmission can be served by the serving BS in the cell.

At 610, the method 600 can include the serving BS determining whether a UE served by the serving BS should contend for resources. The resources can include, but are not limited, a time slot and/or bandwidth over which the UE can transmit information.

To determine the UEs that should contend for resources, the serving BS can determine the priority of the traffic that the serving BS intends to transmit to the UE. The serving BS can also determine the transmit power level for an interfering BS. In various embodiments, the interfering BS can be a BS located in a cell outside of the cell in which the UE is located. The interfering BS can interfere with the UE when the interfering BS transmits information on the DL to a UE in the cell served by the interfering BS but the UE (in the other cell) experiences interference as a result of the transmission.

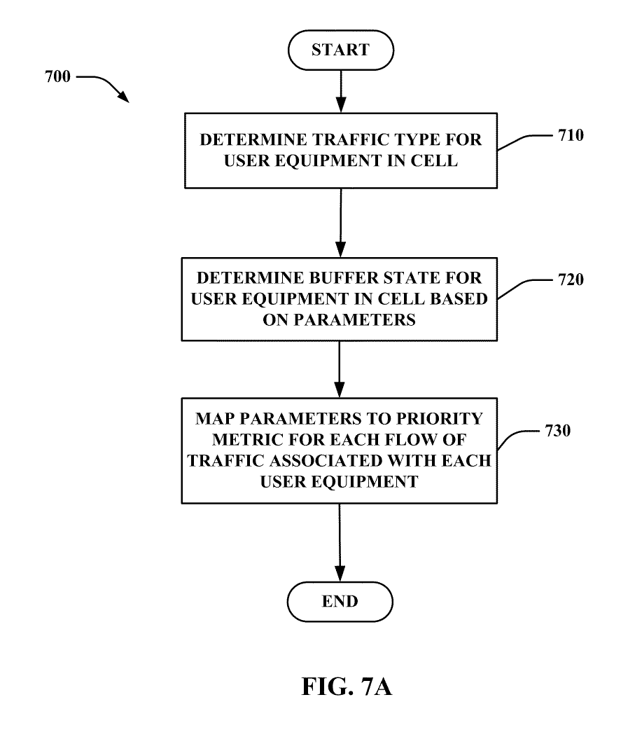

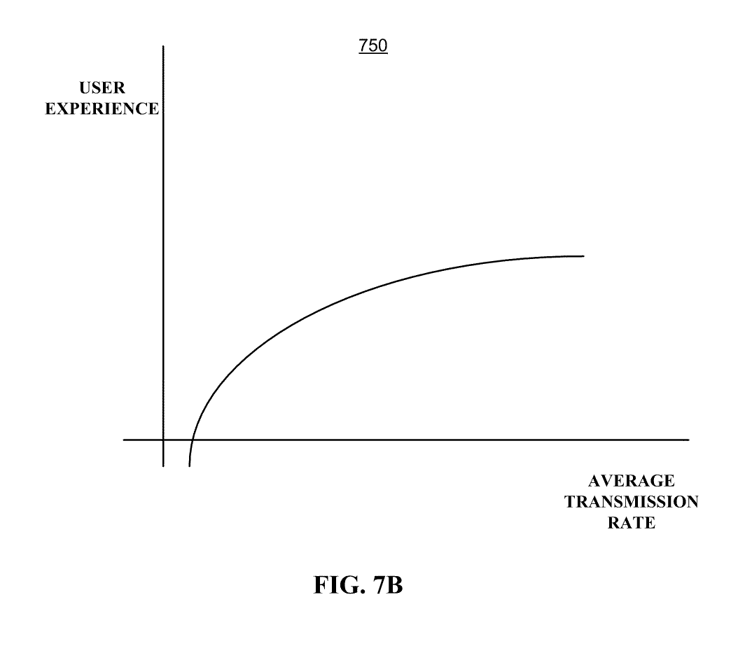

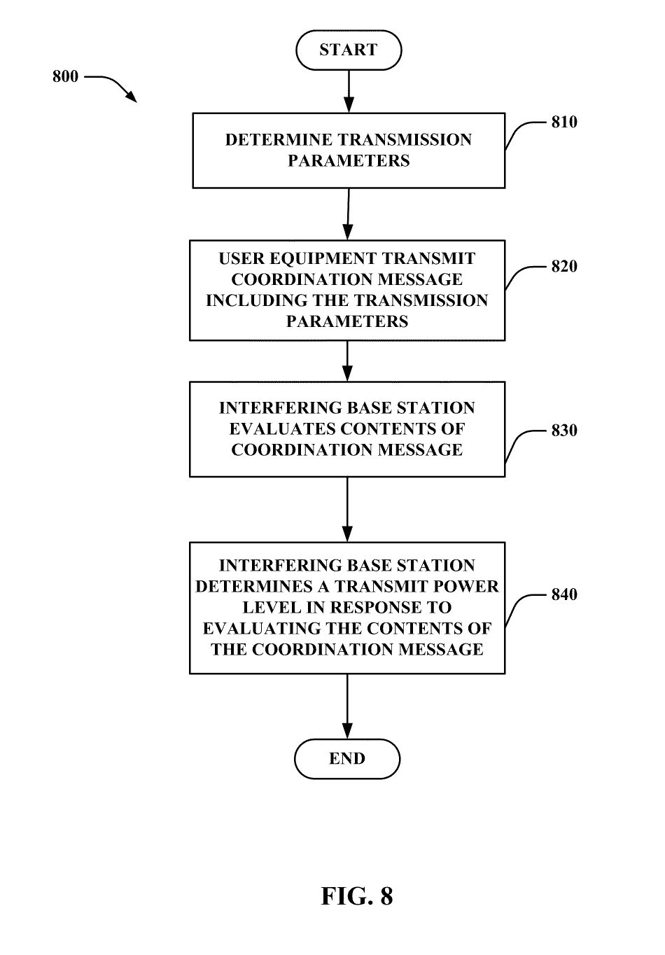

The priority of the traffic can be determined as described below with reference to FIGS. 7A and 7B. The transmit power level for an interfering BS can be determined as described below with reference to FIG. 8.

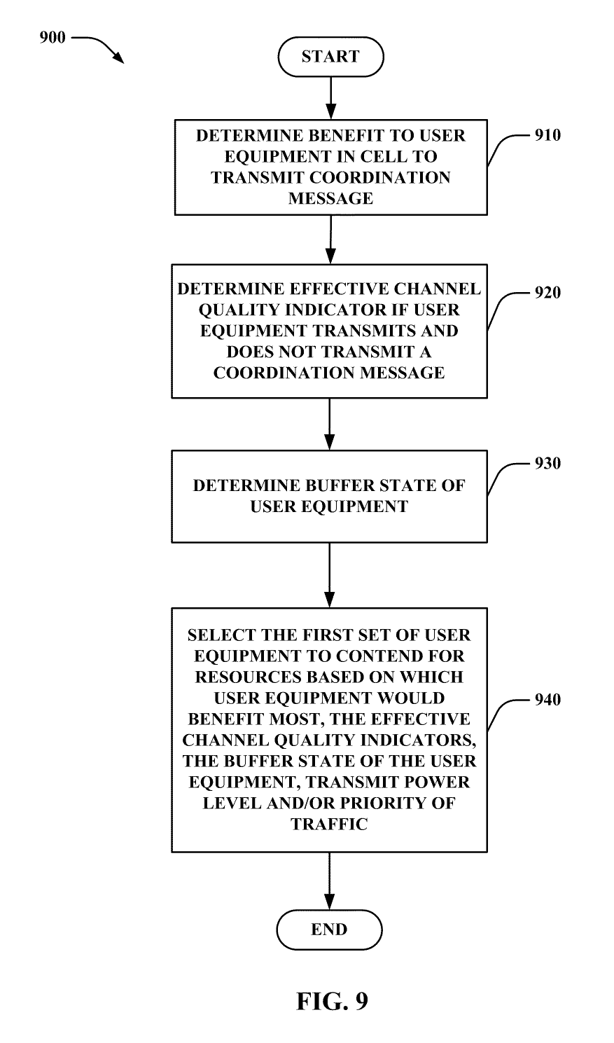

The serving BS can select a first set of UEs for transmission of coordination messages. A method for selecting the first set of UEs can be as discussed with reference to FIG. 9. The serving BS can also have constraints on the number of the UEs that can send the coordination messages.

Referring back to FIG. 6, at 620, the method 600 can include the serving BS scheduling transmission of one or more coordination messages. In one embodiment, a coordination message can be an interference management request. In some embodiments, the interference management request can be a resource utilization message (RUM). The interference management request and/or a RUM can include information regarding one or more resources on which the UE desires to experience reduced interference relative to the interference when an interference management request and/or a RUM is not transmitted, or to experience interference below a selected threshold. By way of example, but not limitation, the interference management request and/or a RUM can include information regarding one or more subbands on which the UE would like to have interference below a selected threshold. As such, interfering BSs (or interfering UEs) that receive the interference management request and/or a RUM may backoff or adjust the transmit power level of the interfering BS (or interfering UE) to reduce the contribution from the interferer on the interference experienced on the one or more resources.

At 630, the method 600 can include the serving BS receiving interference information from the UE. The interference information can include, but is not limited to, effective channel quality indicator (effective CQI) and/or a transmit power level indicative of the power level at which the interfering BS intends to transmit. In some embodiments, the effective CQI can be channel quality indicator information that is calculated based on an assumed nominal interference in the system. The nominal interference can be estimated by the interfering BS in some embodiments. By contrast, a CQI can be calculated based on an assumed maximum transmit power level being transmitted from all interfering BSs. In some embodiments, when a first interfering BS in a system is computing nominal interference, the nominal interference can be the interference contribution from one or more of the other interfering BSs, besides the first interfering BS, in the system.

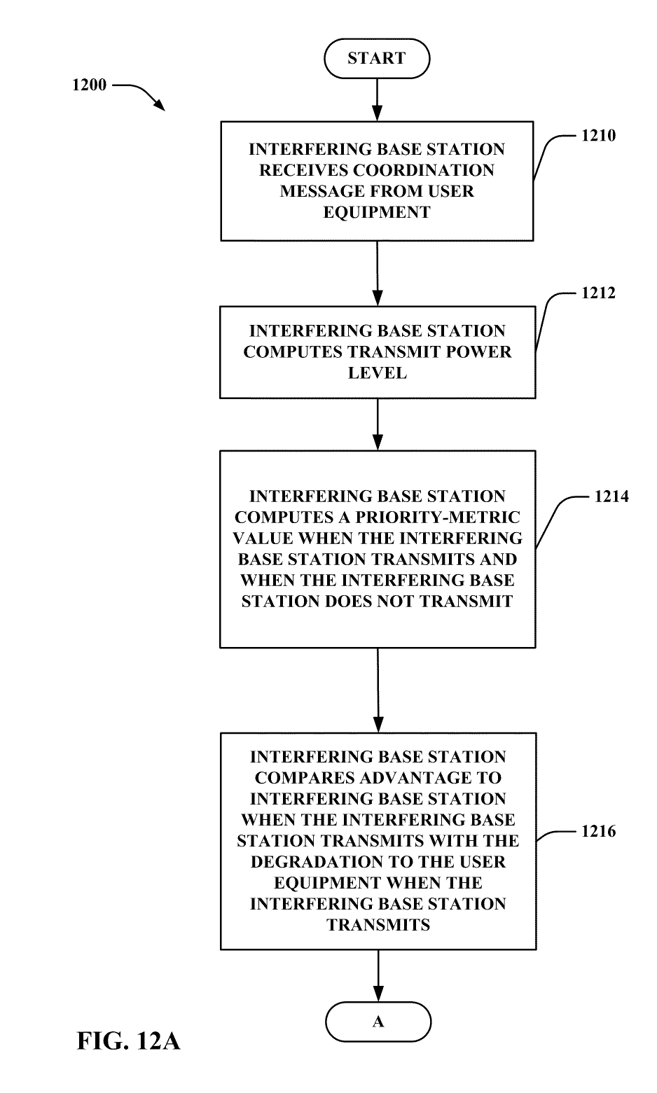

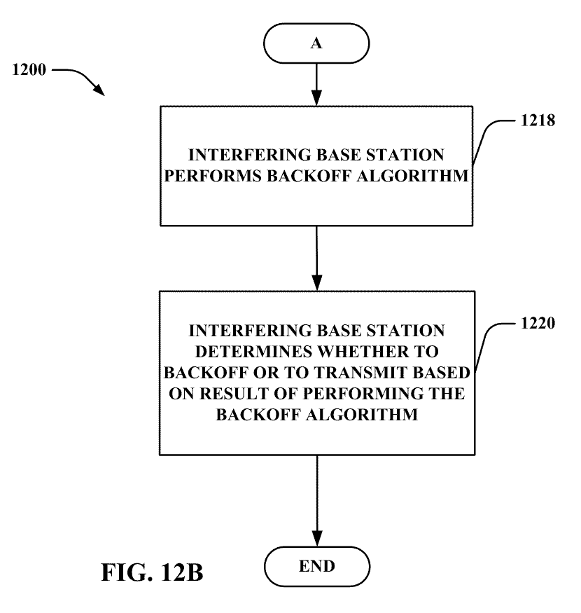

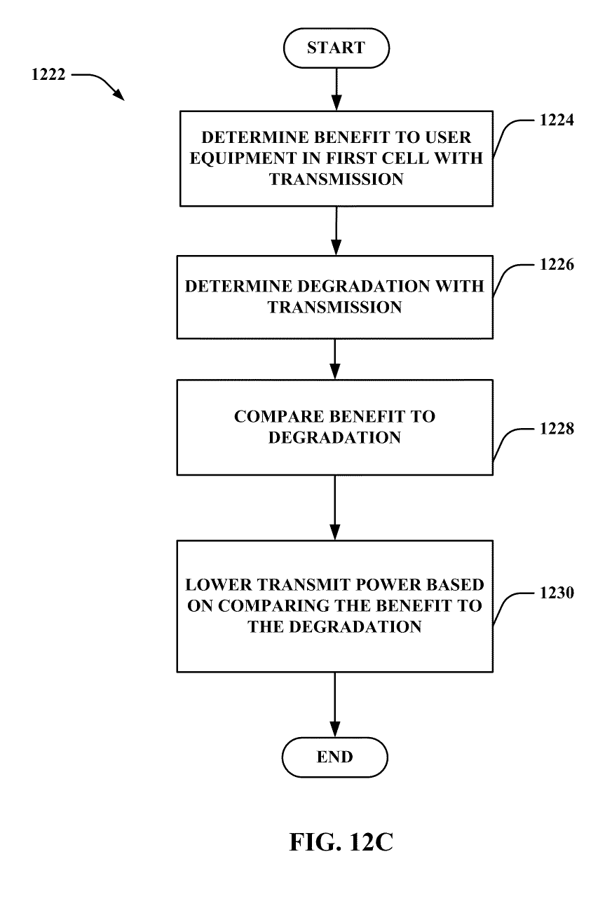

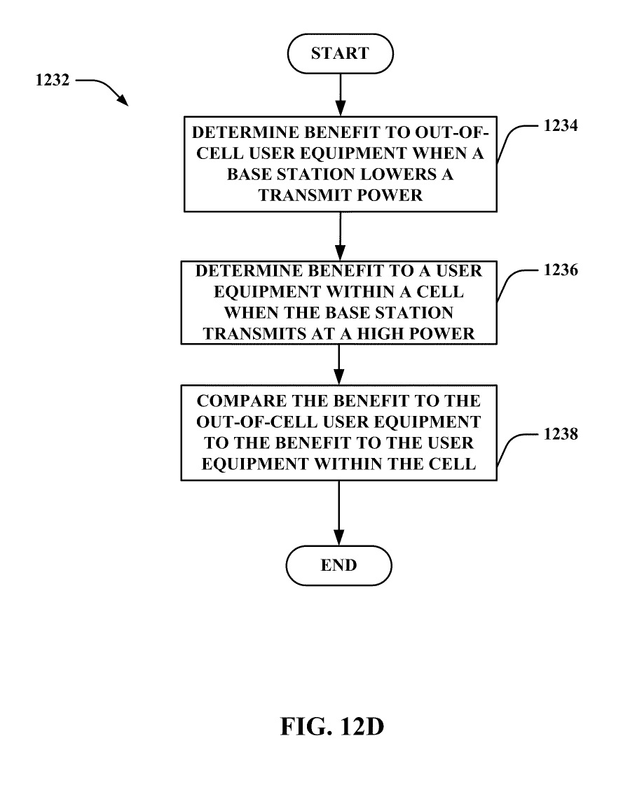

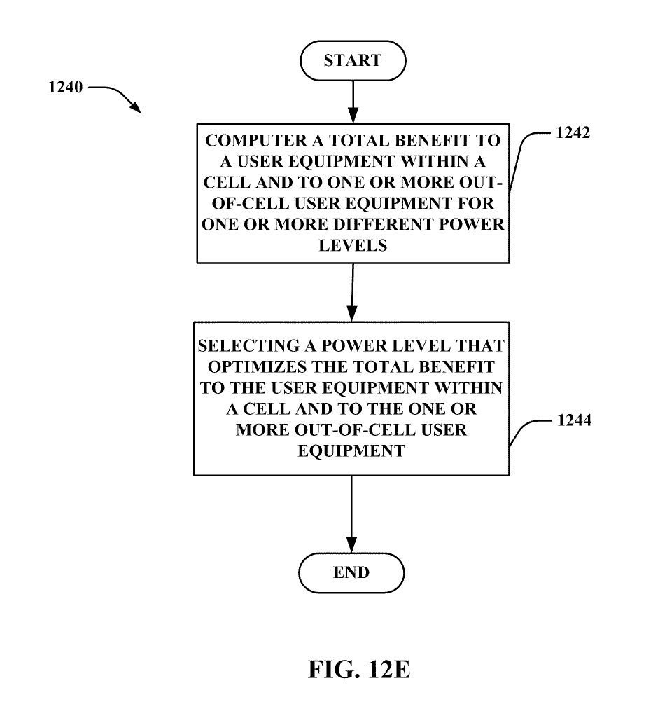

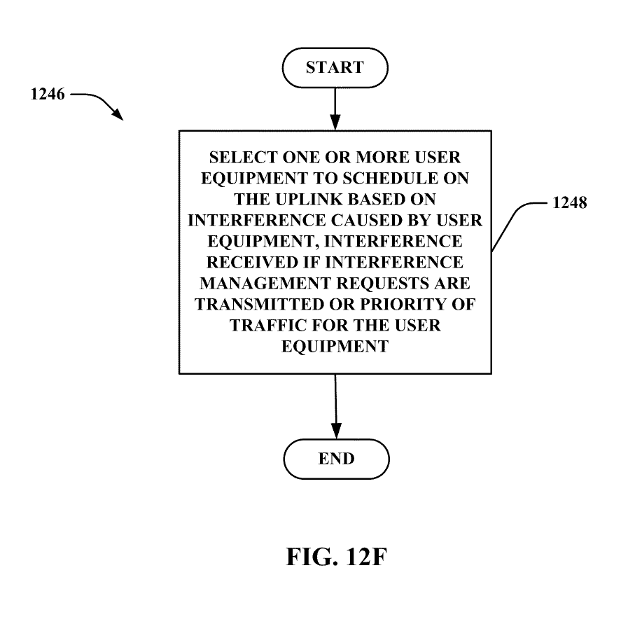

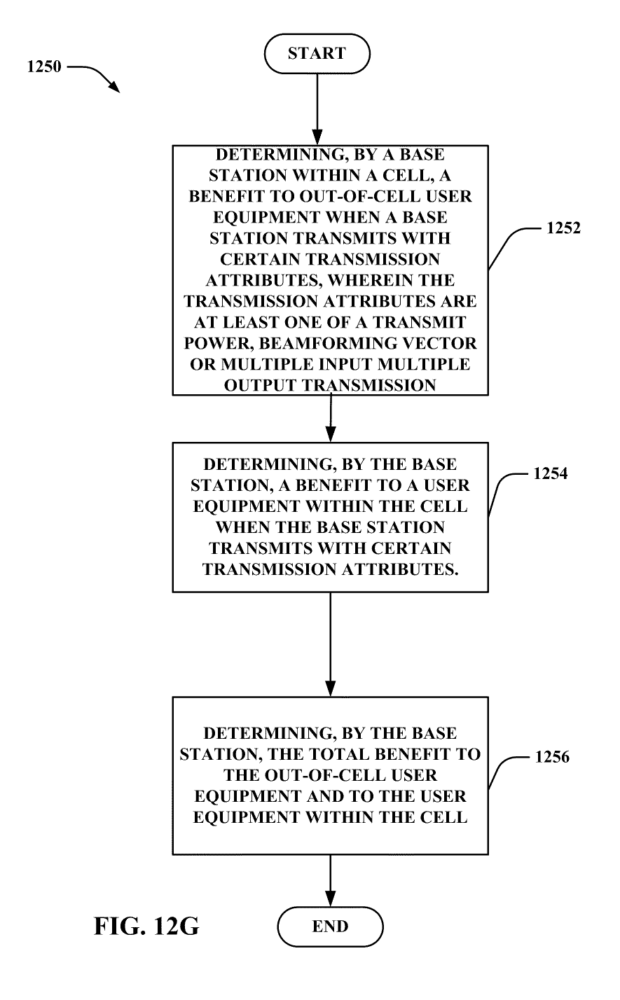

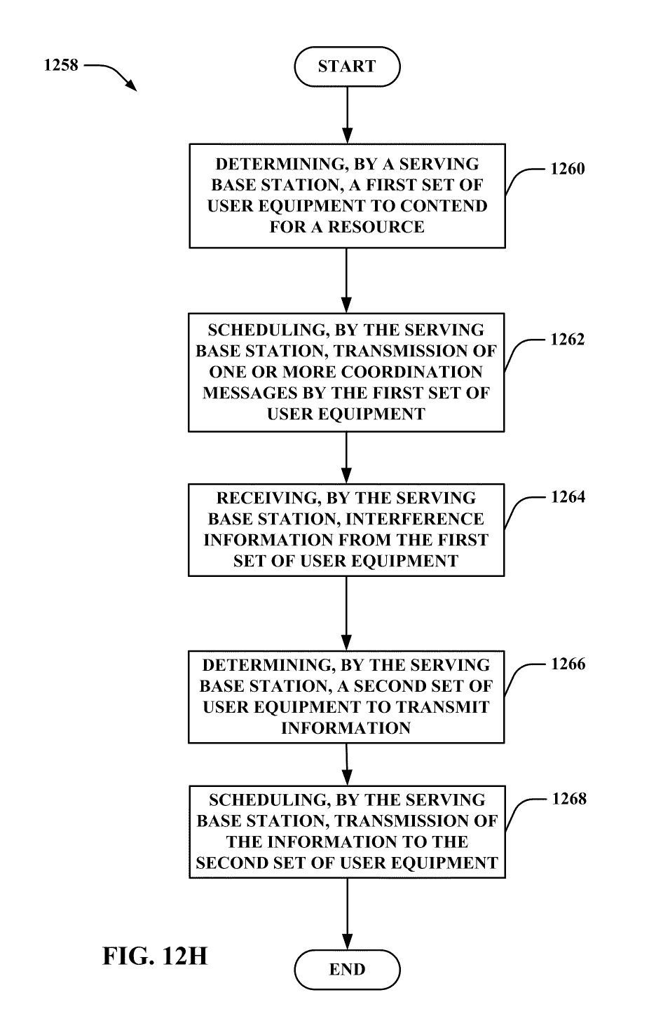

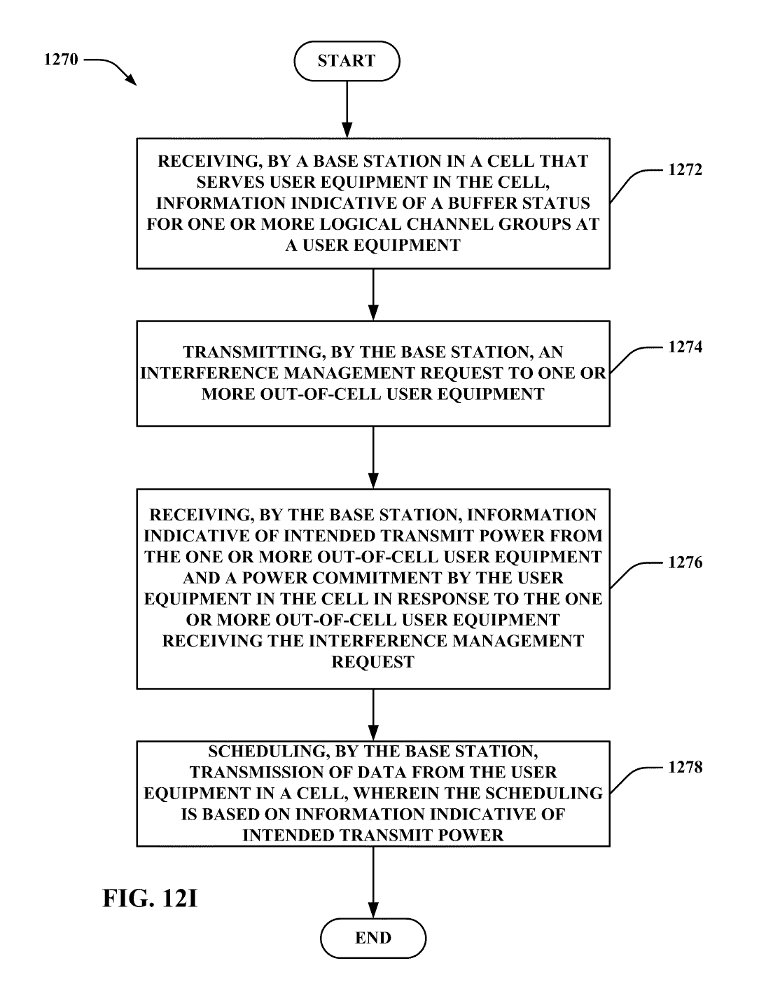

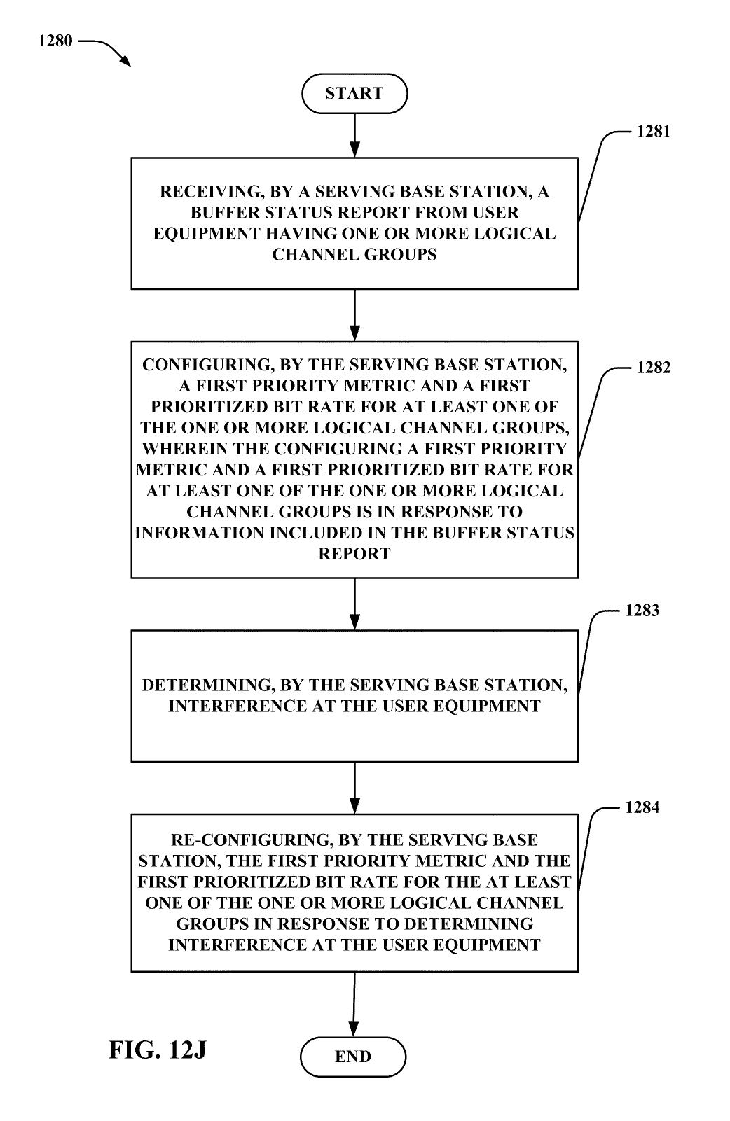

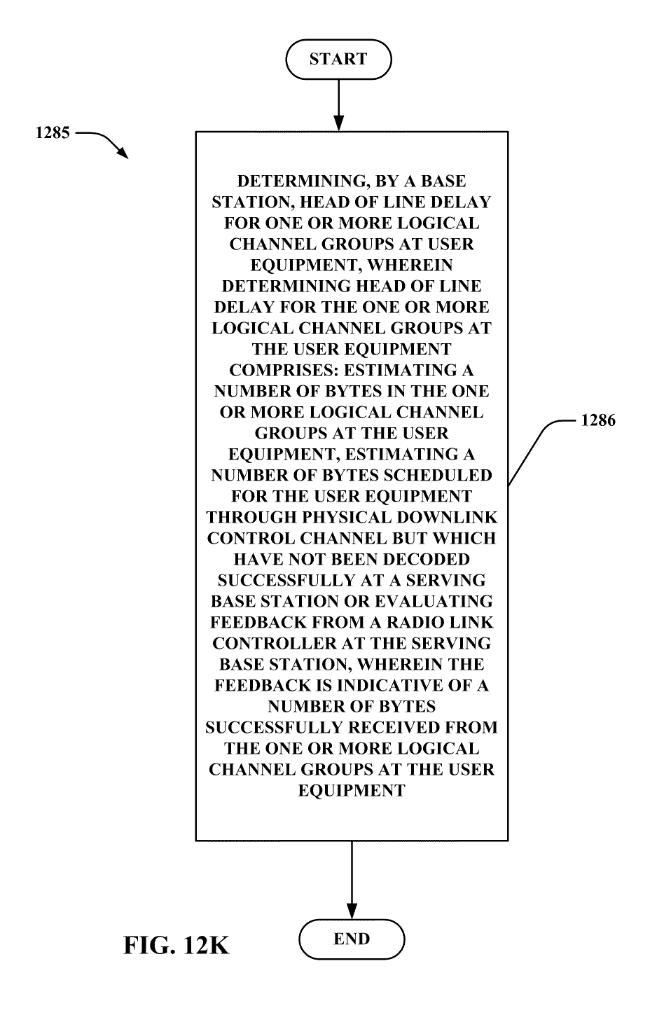

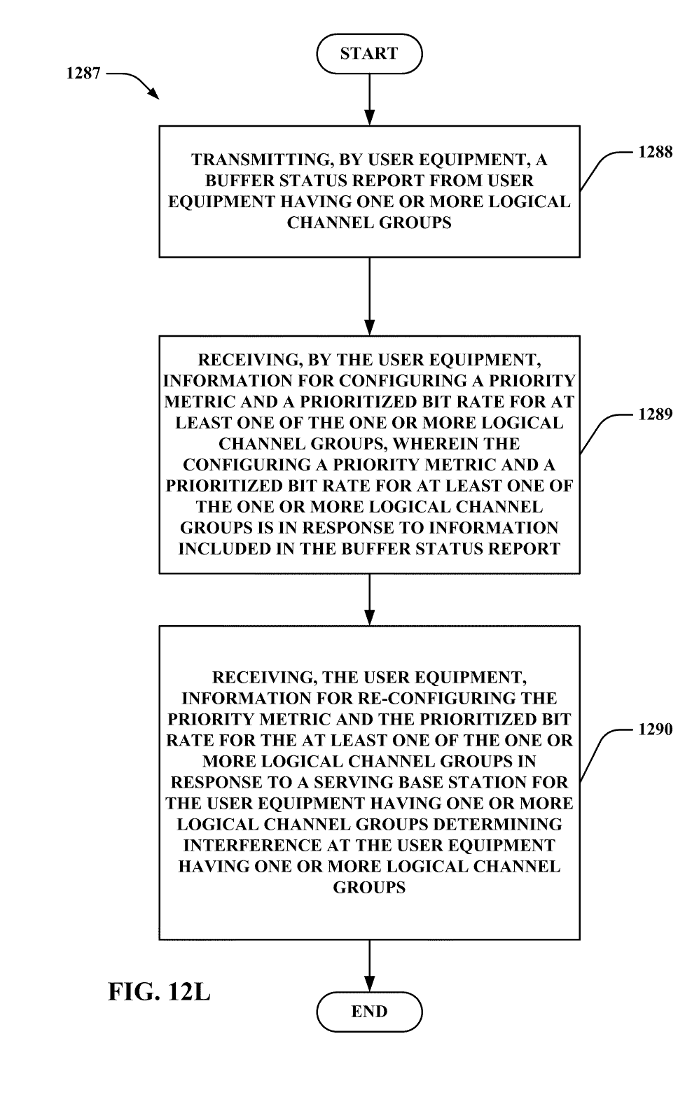

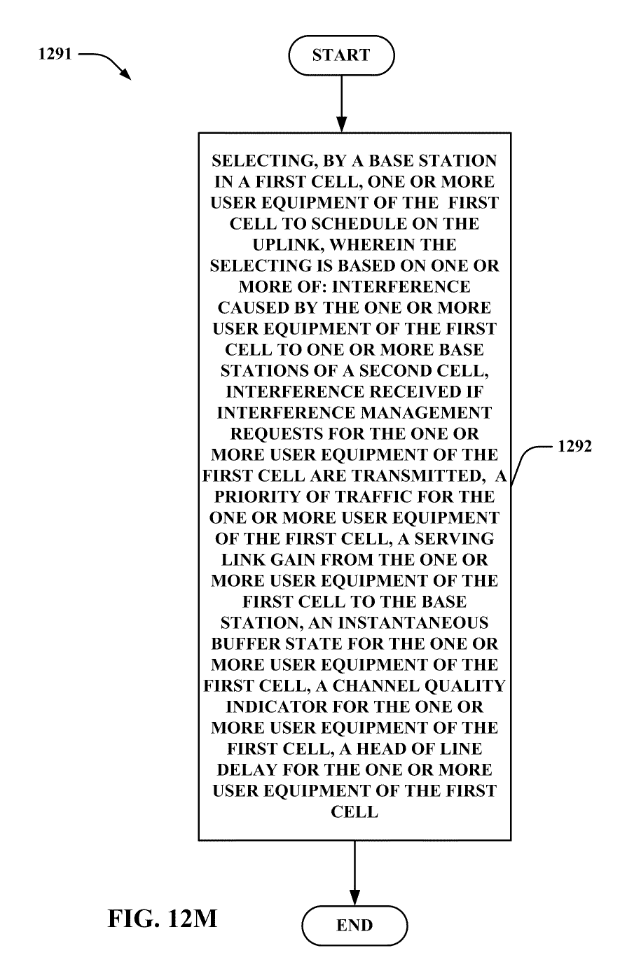

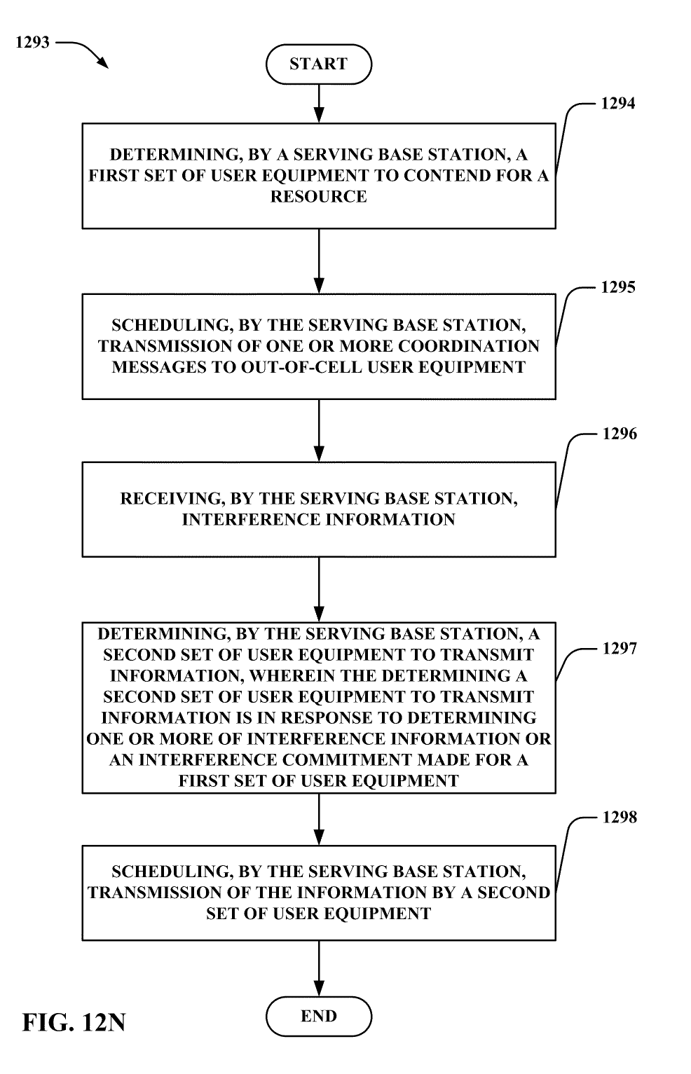

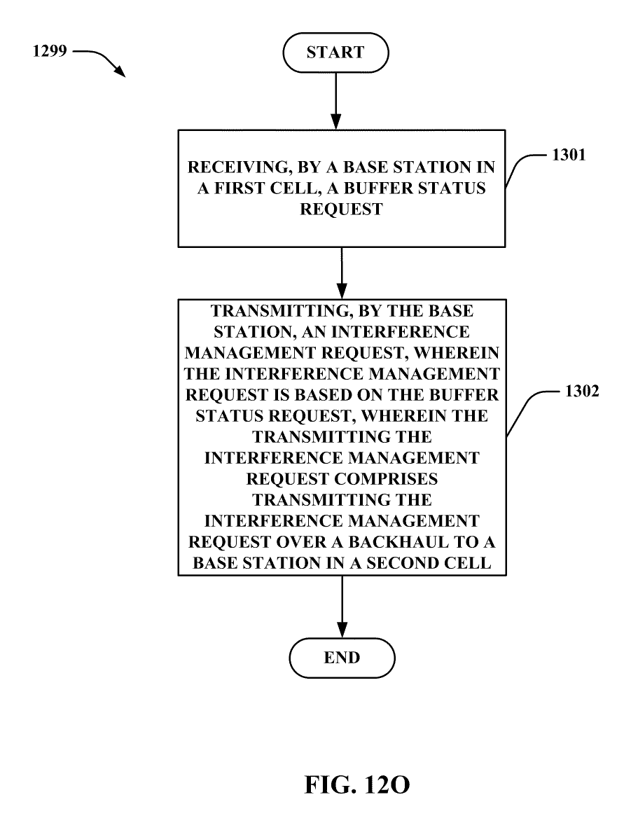

In some embodiments, the interference information received by the UE can include information indicative of one or more of the interfering BSs scheduling a backoff. The backoff can be scheduled according to any number of backoff algorithms as described herein with reference to FIG. 12A. Accordingly, the UE can receive interference information indicative of a reduced level of interference compared to the level of interference that would result if each of the interfering BSs to which the UE transmitted the coordination message, transmitted.

At 640, method 600 can include the serving BS determining a second set of UE to transmit information, wherein the determining a second set of UE to transmit information can be in response to determining one or more of the interference information or an interference commitment made for a first set of UE.

At 650, method 600 can include the serving BS scheduling transmission of the information by a second set of UE. In various embodiments, one or more of the UE of the second set of UE is included in the first set of UE.

While the embodiment described with reference to FIG. 6 includes steps 610 and 620 for selecting UEs in cells wherein there are multiple UEs operating in the cell, embodiments wherein only a single UE is operating in the cell can be provided. In those embodiments, the serving BS need not determine which UEs should contend for resources and steps 610, 620 and 630 need not be performed. In some embodiments, only step 650 needs to be performed and the BS can schedule the transmission of information by the UE.

FIG. 7A is an illustration of a flowchart of an example method of determining the priority of traffic for a UE on the DL. The method 700 can be one, or be included as part of, an embodiment of step 610 of FIG. 6. In some embodiments, the steps of method 700 and method 800 can be performed as, or as part of, step 610 of FIG. 6.

At 710, method 700 can include determining a traffic type. There can be a number of different types of traffic. The traffic types can be best effort traffic, assured forwarding traffic and delay sensitive traffic.

Best effort traffic can be a traffic type wherein a user experience at a UE increases as the average transmission rate at the UE increases, until the user experience reaches a maximum value and flattens as the transmission rate at the UE continues to increase. FIG. 7B is an illustration of an example graph showing user experience for average transmission rate with best effort traffic. As shown, as the average transmission rate increases the user experience can increase until a maximum user experience is reached. After reaching the maximum user experience value, the user experience is substantially the same for higher average transmission rates. The average transmission rate at the UE can be the transmission rate averaged over a plurality of time slots (e.g., over hundreds of milliseconds).

Assured forwarding traffic can be a traffic type wherein a minimum transmission rate at the UE can be guaranteed. Delay sensitive traffic can be a traffic type wherein the traffic has a maximum delay at which the traffic is transmitted.

At 720, method 700 can include determining the buffer state for the UE. The buffer state can be determined based on one or more parameters associated with the buffer. Parameters associated with the buffer can include, but are not limited to, a past rate of serving the queue for the UE, a queue length for the UE, the head of line (HOL) delay for the UE, Quality of Service (QoS) parameters and/or a Quality of Service Class Identifier (QCI) in an LTE system. In some embodiments, the HOL delay can be the delay of the first packet in the queue for the UE. In some embodiments, the QCI in an LTE system can be a value provided in a particular field of a packet transmitted.

At 730, method 700 can include mapping one or more of the parameters of the buffer to a priority metric for the UE. The priority metric can be calculated for one or more flows of traffic of a UE. The BS serving the UE can calculate the priority metric for the UE. The priority metric can be a value that indicates the priority of the traffic associated with the flow. Therefore, the priority metric can differ for flows having different traffic types. In some embodiments, the priority metric can be used by an interfering BS to determine whether the interfering BS should transmit or whether the interfering BS should backoff to reduce interference with the UE.

In some embodiments, mapping to a priority metric can be performed in accordance with a broad class of parametric priority functions. For example, in some embodiments, the priority function for mapping parameters to a priority metric can be as shown in equation one:

Wᵢx^{a}+W₂ log(x)+W₃D+W₄q+W₅e^{D/w}^{₆}+W₇e^{q/w}^{₈}+W₉ log(D)+W₁₀ log(q) (1)

where x is average rate of serving the queue for the UE, D is the HOL delay for the UE, and q is the queue length for the UE, and, in an LTE system, a and Wᵢ are constants configured as functions of the QCI parameters.

Equation one is one embodiment of a parametric priority function for mapping parameters associated with a buffer for the UE to a priority metric for the UE. In other embodiments, more general priority functions can be used. By way of example, but not limitation, the priority function can include any number of functions to determine a priority of traffic for the UE. The functions can include, but are not limited to, those that utilize: the instantaneous HOL delay for the UE, delays of various packets in the queue for the UE, queue length for the UE, packet sizes for the UE, and/or the average rate at which the queue for the UE has been served in the past.

In some embodiments, the priority function can be a generic numerical function. For example, the generic numerical function can be specified as a table of values. By way of example, but not limitation, with reference to equation one, the values can include values for x, q and/or D.

In some embodiments, the mapping to the priority function can vary depending on the QCI parameters. For example, in some embodiments, flows with different QCI parameters could have different mappings to priority metrics.

In some embodiments, strict priority can be provided between different types of traffic. As such, in one embodiment, a threshold for a transmit power level for an interfering BS can be determined. The interfering BS can be required to maintain transmit power levels below the threshold to improve the likelihood of an acceptable signal-to-interference and noise ratio (SINR) in the system. The SINR can include a signal portion of the SINR that can be transmitted on the serving communication link and an interference portion that can be transmitted on the cross communication link. The amount of SINR that is deemed as acceptable can differ for different types of traffic. By way of example, but not limitation, in some embodiments, a relatively high SINR can be provided for high priority traffic to enable the system to achieve the QoS level associated with the traffic type.

In some embodiments, slow time scale prioritization can be performed to generate priority metrics. Using this approach, power and/or bandwidth resources can be allocated to different cells at a slow time scale. The priority function can depend on the QCI parameters and slow time scale information. Slow time scale information can include, but is not limited to, average delay of data for the UE, average arrival rate of data for the UE, average service rate of a queue for the UE, and/or average queue length for the UE. In various embodiments, the function can be parametric or specified as a table.

FIG. 8 is an illustration of a flowchart of an example method of determining a transmit power level by an interfering BS. The method 800 can be another embodiment of, or be included in an embodiment of, step 610 of FIG. 6. In some embodiments, the steps of method 700 and method 800 can be performed as, or as part of, step 610 of FIG. 6.

At 810, method 800 can include a UE determining transmission parameters. The transmission parameters can include, but are not limited to, a priority metric for the UE, the nominal interference at the UE and/or the channel gain information indicative of the channel gain between the UE and an interfering BS.

At 820, method 800 can include the UE transmitting a coordination message including the transmission parameters. The UE can transmit the coordination message to the interfering BS. In some embodiments, the channel gain is not transmitted in the coordination message. Rather, the channel gain can be determined by inference based on the strength of the signal that includes the coordination message. In some embodiments, the coordination message can be an interference management request and/or a RUM.

At 830, method 800 can include the interfering BS evaluating the contents of the coordination message. At 840, method 800 can include the interfering BS determining a transmit power level. The transmit power level can be determined in response to the evaluation of the contents of the coordination message. To determine the transmit power level, the interfering BS can select a power level, Pᵢ, on a range of power levels.

In some embodiments, the selected power level can be the level that maximizes equation two:

W(1)R(1)+ΣᵢW(i)R(i) (2)

where W(1) is a priority metric for the UE, R(1) is the transmission rate that the interfering BS will experience when the interfering BS transmits, W(i) is a priority metric for the i^{th} UE in the system, and that transmitted a coordination message to the interfering BS, and R (i) is a transmission rate for the i^{th} UE in the system and that transmitted a coordination message to the interfering BS.

In some embodiments, in order to maximize equation two, the interfering BS can determine the maximum transmission rate that a UE served by the interfering BS will obtain if a UE outside of the cell in which the interfering BS is located performs a backoff. The interfering BS can perform this calculation for one or more UEs outside of the cell. The interfering BS can then remove from equation two, the transmission rate contribution from the UEs outside of the cell that cause the greatest detriment to the transmission rate of the UE served by the interfering BS. Removing the contribution from the worst UEs outside of the cell can maximize the value of the transmission rate in equation two.

FIG. 9 is an illustration of an example of a flowchart of a method for selecting a first set of UE for transmission of coordination messages. The method 900 can be one embodiment of step 610 of FIG. 6.

At 910, the method 900 can include the serving BS determining, for one or more of the UEs in the cell served by the BS, which UEs in the cell would benefit most from transmitting a coordination message to contend for transmission. In some embodiments, the coordination message can be an interference management request and/or a RUM. The BS can evaluate factors such the distance between the UE and the BS, the priority of the traffic for the UE, and/or the channel gain information for the UE relative to one or more of the interfering BSs. By way of example, but not limitation, UEs that are within a close geographic proximity to the BS may not benefit as much from transmitting a coordination message as UEs that are not within a close geographic proximity to the BS because the UEs that are closer may experience less damaging interference notwithstanding the UE did not contend for resources.

At 920, the method 900 can include the BS determining, for one or more of the UEs that can be scheduled, the effective CQI if the UE transmits a coordination message and the effective CQI if the UE does not transmit a coordination message.

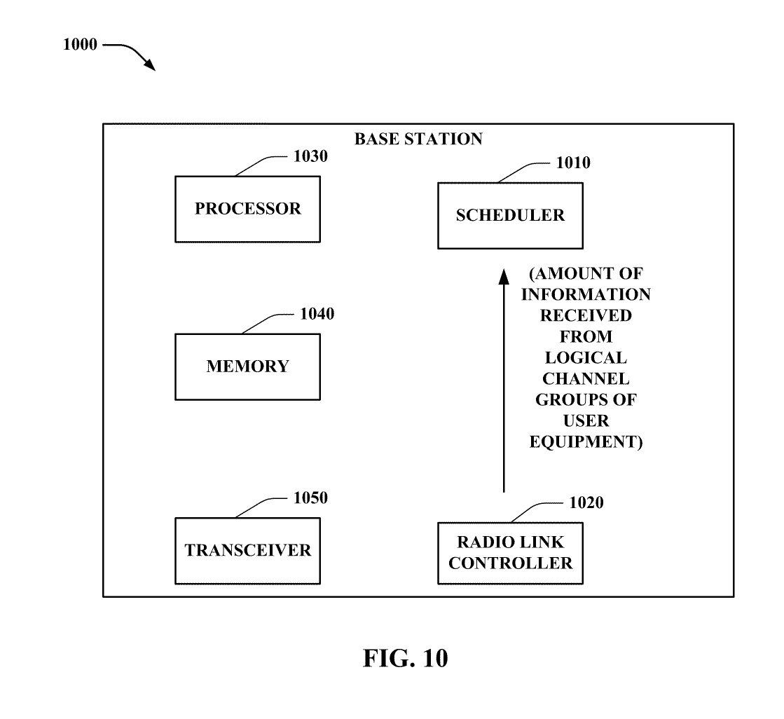

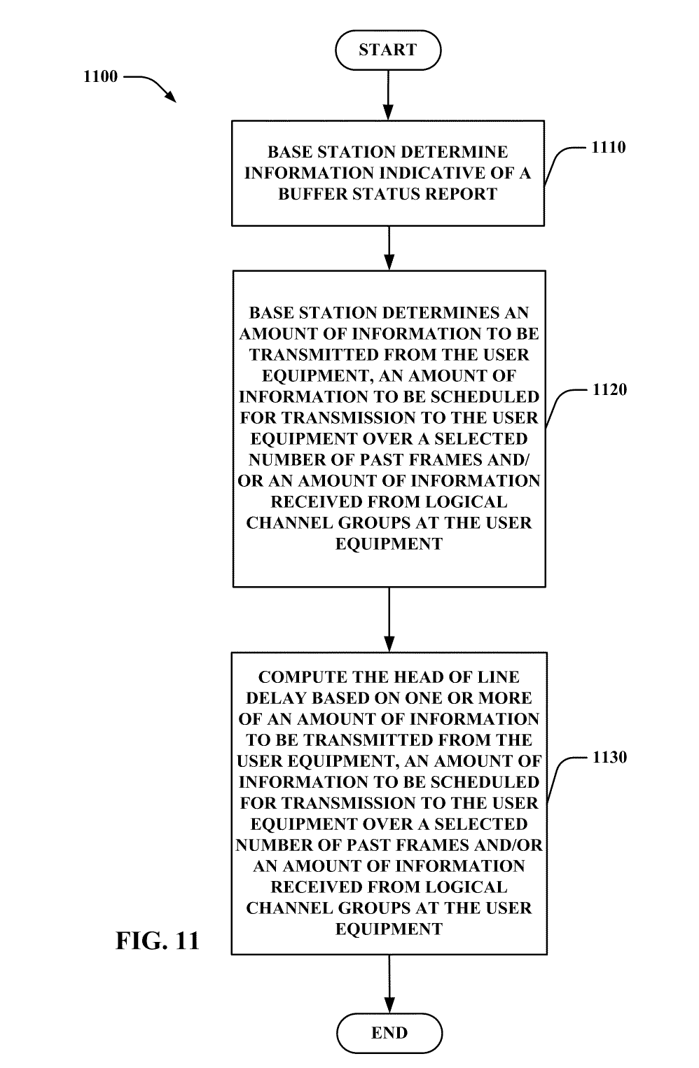

At 930, the method 900 can include determining the buffer state for one or more of the UEs. The buffer state can include the average transmission rate for the UE and/or the HOL delay at the queue for the UE. The HOL delay can be computed as described with reference to FIGS. 10 and 11.

Referring back to FIG. 9, at 940, method 900 can include the BS selecting the first set of UEs to contend for resources by evaluating which UE would benefit most, the effective CQIs of the UEs, the buffer state of the UEs, the transmit power level calculated with reference to FIG. 8 and/or the priority of traffic calculated with reference to FIGS. 7A and 7B.

FIG. 10 is a block diagram of an example BS for computing a HOL delay at a UE for use in distributed scheduling to facilitate interference management. BS 1000 can include a scheduler 1010, a radio link controller (RLC) 1020, a processor 1030, a memory 1040 and a transceiver 1050. In some embodiments, the scheduler 1010, the RLC 1020, the processor 1030, the memory 1040 and/or the transceiver 1050 can be communicatively coupled to one another.

The scheduler 1010 can be configured to evaluate a buffer status report associated with a UE (not shown) that the BS 1000 serves and determine the amount of information to be transmitted from a UE. The scheduler 1010 can also, in some embodiments, determine an amount of information scheduled for the UE over a selected number of past frames.

The RLC 1020 can determine an amount of information received from logical channel groups (LCGs) of the UE. In some embodiments, the amount of information can be specified in a number of bytes received from each LCG of the UE. The RLC 1020 can provide the information to the scheduler 1010.

The processor 1030 can implement one or more functions described with regard to the BS 1000, and the memory 1040 can be configured to store information for performing the functions. For example, the memory 1040 can be configured to store the buffer status report information, the information indicative of the amount of information to be transmitted from the UE, the information indicative of the amount of data scheduled for the UE over a selected number of past frames and/or the information indicative of the amount of information received from the LCGs of the UE. The transceiver 1050 can transmit information from and/or receive information at the BS 1000.

The scheduler 1010 can compute an HOL delay for the UE based on at least one of the information to be transmitted from the UE, the amount of information scheduled for the UE over a selected number of past frames and/or the amount of information received from the LCGs of the UE.

FIG. 11 is an illustration of an example of a flowchart of a method for computing a HOL delay at a UE for use in distributed scheduling to facilitate interference management. At 1110, method 1100 can include a BS determining information indicative of a buffer status report. At 1120, method 1100 can include determining an amount of information to be transmitted from the UE, an amount of information scheduled for transmission to the UE over a selected number of past frames and/or information indicative of an amount of information received from one or more logical channel groups (LCGs) of the UE.

In some embodiments, the amount of information received from one or more LCGs can be specified in a number of bytes of information. In some embodiments, the amount of information received from one or more LCGs can be included in a buffer status report for the UE.

At 1130, method 1100 can include computing the HOL delay based on the information indicative of an amount of information to be transmitted from the UE, the information indicative of the amount of information scheduled for the UE over the selected number of past frames and/or the information indicative of the number of bytes received from one or more LCGs of the UE.

FIGS. 12A and 12B represent a flowchart of an example of a method of scheduling backoff in accordance with aspects described herein. At 1210, an interfering BS receives a coordination message from a UE. In some embodiments, the UE can be in a first cell and the interfering BS can be a second cell that is different from the first cell. The coordination message can be an interference management request and/or a RUM and/or can include a priority metric, information indicative of the priority of the traffic associated with the UE, a nominal interference selected by the UE and/or the channel gain information indicative of the channel gain between the UE and the interfering BS.

At 1212, the interfering BS can compute a transmit power level at which the interfering BS intends to transmit. In some embodiments, the transmit power level be computed as described above with reference to FIG. 8.

At 1214, for each UE for which a coordination message is received at the interfering BS, the interfering BS can compute a difference value between a priority metric-rate value when the interfering BS does not transmit and a priority metric-rate value when the interfering BS transmits. In some embodiments, a priority metric-rate value for a UE, U, can be generally computed as:

$$W ( U ) log ( 1 + \frac{1 + G ( U ) P}{{I}_{nom} ( U ) + N} ) ,$$

which is elaborated upon in equation four below.

At 1216, the interfering BS can compare, for a transmission from the interfering BS, the advantage to the interfering BS (or to a UE that is served by the interfering BS) with the degradation (due to interference) to the UE from which the interfering BS received the coordination message.

As shown in FIG. 12B, at 1218, the interfering BS can perform a backoff algorithm indicated by the computation of equation three below:

$$W ( 1 ) log ( 1 + \frac{1 + G ( 1 ) P}{{I}_{nom} ( 1 ) + N} ) + W ( {m}^{*} ) log ( 1 + \frac{{P}_{{m}^{*}} {G}_{{m}^{*}}}{{I}_{nom} ( {m}^{*} ) N ( {m}^{*} , 1 )} ) \qquad ( 3 )$$

where W(1) is a priority metric for the UE, G is the channel gain between the UE and the serving BS that serves the UE, P is the transmitter power to the UE, N is noise power, Iₙₒₘ(m) is the nominal interference caused by the m^{th} most dominant interfering BS and

$$W ( 1 ) log ( 1 + \frac{1 + G ( 1 ) P}{{I}_{nom} ( 1 ) + N} )$$

is a priority metric-rate value for the UE while W(m*)log

$$( 1 + \frac{{P}_{{m}^{*}} {G}_{{m}^{*}}}{{I}_{nom} ( {m}^{*} ) N ( {m}^{*} , 1 )} )$$

is a priority metric-rate value utilizing a maximized condition, as described below.

The channel gain can be the receiving signal power relative to a nominal transmit power. The channel gain can be expressed as a log value comparing, a fraction comparing or a difference between, the signal power received at a receiving node relative to a nominal transmit power. In some embodiments, the nominal transmit power is known to the receiving computing the channel gain. The receiving node can be a UE, a serving BS and/or an interfering BS or interfering UE, depending on whether the channel gain is being computed on the UL or the DL and/or the entity performing the computation. In various embodiments, channel gain information can include the channel gain. Further, equation four:

$$log ( 1 + \frac{1 + G ( 1 ) P}{{I}_{nom} ( 1 ) + N} ) \qquad ( 4 )$$

is an embodiment of an equation for computing a transmission rate that the UE will experience when the interfering BS transmits, and W(m*) is a maximum priority metric for the UEs that transmitted a coordination message to the interfering BS. Further, equation five:

$$log ( 1 + \frac{{P}_{{m}^{*}} {G}_{{m}^{*}}}{{I}_{nom} ( {m}^{*} ) N ( {m}^{*} , 1 )} ) \qquad ( 5 )$$

is an embodiment of an equation for computing the maximum transmission rate for the UE that transmitted the coordination messages to the interfering BS.

In some embodiments, the interfering BS can perform the computations associated with performing the backoff algorithm for each UE from which the interfering BS receives a coordination message. At 1220, method 1200 can include the interfering BS determining whether to transmit or backoff based on the result of performing the backoff algorithm.

If the benefit to the interfering BS is greater than the degradation to the UE, the interfering BS can transmit and not backoff. If the degradation to the UE is greater than the benefit to the interfering BS, the interfering BS can backoff and not transmit.

While the embodiment described above includes illustrating the backoff algorithm equation three, in lieu of performing the computations associated with the equation, the backoff algorithm can include any number of comparisons. For example, the backoff algorithm can be any algorithm that compares and balances the benefit to the interfering BS (or a UE served by the interfering BS), with the degradation to the UE that transmitted the coordination message, when the interfering BS transmits. As another example, the backoff algorithm can be any algorithm that balances the detriment to the interfering BS (or a UE served by the interfering BS) when the interfering BS does not transmit, with the benefit to the UE that transmitted the coordination message, when the interfering BS does not transmit. If the benefit to the interfering BS is greater than the degradation to the UE, the interfering BS can transmit and not backoff. If the degradation to the UE is greater than the benefit to the interfering BS, the interfering BS can backoff and not transmit.

In some embodiments, the comparison performed via the backoff algorithm can be a function of an underlying buffer state at and/or transmission rate of the UE that transmitted the coordination message, and the interference contributed by the interfering BS when the interfering BS does not transmit and when the interfering BS transmits.

With reference to FIG. 6 again, in some embodiments (not shown), a method for transmitting interference management requests and/or RUMs can be as follows. The UEs can contend for resources by first contending for a preferred subband, then contending for one or more subbands that are not preferred subbands of neighbors on interference graph, then contended for subbands that are preferred subbands of neighbors on interference graph. It can be assumed that the nominal SINR will be achieved on all subbands for which the UEs contend.

In some embodiments, another backoff algorithm can be employed for use in the method 600. For example, an interfering BS to determine whether the interfering BS should transmit or backoff according to equation six below. For example, for the case where interfering BS, j, either transmits at maximum power or schedules a backoff (and therefore is silent), the UE, i*, can determine which interfering BS, j, causes the most loss in utility when the BS, j, transmits at maximum power according to equation six:

$$Δ U ( 0 ) = W ( {i}^{*} ) log ( 1 + \frac{h ( {i}^{*} ) {P}_{max} ( {i}^{*} )}{{I}_{nom} ( {i}^{*} )} )$$

$$Δ U ( {P}_{max} ( j ) ) = W ( j ) log ( 1 + \frac{h ( j ) {P}_{max} ( j )}{{I}_{nom} ( j )} ) + W ( {i}^{*} ) log ( 1 + \frac{h ( {i}^{*} ) {P}_{max} ( {i}^{*} )}{h ( {i}^{*} , j ) {P}_{max} ( j ) + {I}_{nom} ( {i}^{*} )} )$$

where U is the utility function value, P is the transmission power, W is the priority metric and h is the channel gain at or between the UE and the interfering BS.

Whether or not backoff is performed can depend on which increase in utility is higher. Iₙₒₘ(i) can influence whether interfering BS, j, computes its interference to be significant or not. Additionally, assured forwarding traffic and/or delay sensitive traffic can have a much higher utility than best effort traffic.

To calculate the utility functions, strict priority between levels of QoS traffic can be assumed in some embodiments. In some embodiments, a complete hearing graph can be assumed and therefore an implication that whenever a QoS interference management request and/or QoS RUM is sent all best effort traffic in a cluster backoff.

In some embodiments, a rate averaging algorithm can be employed to determine relative priorities of the traffic. In one embodiment, a two millisecond (ms) delay can be assumed to have the same priority as a median best effort traffic rate, which can be approximated offline.

In some embodiments, the number of interfering transmitters can be denoted by N, and can be ordered in decreasing order of interference caused to the UE. For each n=1, . . . , N, the transmission rate at equation seven can be computed:

$$rate ( n ) = \frac{1}{n} C ( \frac{GP}{{N}_{0} + {\sum }_{k = n + 1}^{N} {I}_{k}} ) \qquad ( 7 )$$

where C(sinr) is the capacity function, G is the channel gain between the UE and the serving BS that serves the UE, P is the transmitter power to the UE, N₀ is noise power, and Iₖ is the interference caused by the k^{th} most dominant interferer.

The nominal interference can be computed by equation eight:

$${I}_{nom} = {N}_{0} + {\sum }_{k = {n}_{opt} + 1}^{N} {I}_{k} \qquad ( 8 )$$

where nₒₚₜ can be the value of n which maximizes the value of equation seven.

In some embodiments, opportunistic transmission of QoS packets can be as follows. An assured forwarding or delay sensitive QoS packet can be transmitted even if no interference management request and/or RUMs are transmitted to contend for the channel if all the conditions below apply: (1) no QoS interference management request and/or QoS RUMs from the neighbors on the interference graph (which can be used to determine the preferred subband) are heard for current slot; (2) for other QoS interference management request and/or QoS RUMs heard for the current slot, the reduction in rate is less than 15% (and all calculations assume the transmitter of the interference management request and/or a RUM will see nominal SINR). In embodiments, the above-described rules can err on the side of being conservative in QoS packet transmission. In some embodiments, the 15% threshold need not be considered if an improved interference graph is used such that the threshold is no longer necessary to achieve acceptable QoS provisioning.

In some embodiments, a hybrid scheme can be as follows. The default mode can be to always transmit an interference management request and/or a RUM to contend for the channel. In this case, priority can be equivalent to that of a packet with delay of 5 ms and the interference management request and/or a RUM can be cancelled if no packet is in queue 8 ms before transmission of the interference management request and/or a RUM is scheduled.

FIG. 12C is a flowchart of an example of a method of scheduling backoff in accordance with aspects described herein. At 1224, method 1222 can include a BS in a first cell determining a benefit to a UE in a first cell and to which a transmission can be scheduled. At 1226, method 1222 can include the BS in the first cell determining a degradation with the transmission. The degradation can be to a UE in a second cell. The second cell can be different from the first cell.

At 1228, method 1222 can include the BS in the first cell comparing the benefit to the degradation.

At 1230, method 1222 can include the BS in the first cell lowering a transmit power based on comparing the benefit to the degradation. In some embodiments, lowering the transmit power can be performed in response to the degradation to the UE in a second cell being greater than the benefit to the UE in the first cell.

FIG. 12D is a flowchart of an example of a method of scheduling on a DL of a wireless communication system. At 1234, method 1232 can include determining a benefit to out-of-cell UE when a BS lowers a transmit power of the BS. At 1236, method 1232 can include determining a benefit to a UE within a cell when the BS transmits at a high power. At 1238, method 1232 can include comparing the benefit to the out-of-cell UE to the benefit to the UE within a cell.

FIG. 12E is a flowchart of another method of facilitating interference management on a DL of a wireless communication system. At 1242, method 1240 can include computing a total benefit to a UE within a cell and to one or more out-of-cell UE for one or more different power levels. At 1244, method 1240 can include selecting a power level that optimizes the total benefit to the UE within a cell and to the one or more out-of-cell UE. In some embodiments, the computing and the selecting is performed by a BS within the cell.

FIG. 12F is a flowchart of an example of a method of scheduling in accordance with aspects described herein. At 1248, method 1246 can include selecting one or more UE of a first cell to schedule on the uplink. In some embodiments, selecting is based on one or more of: interference caused by the one or more UE of the first cell to one or more BSs of a second cell, interference received if interference management requests for the one or more UE of the first cell are transmitted or a priority of traffic for the one or more UE of the first cell.

FIG. 12G is a flowchart of an example of a method of scheduling in accordance with aspects described herein. The method 1250 can be a method for facilitating interference management on a downlink of a wireless communication system.

At 1252, method 1250 can include determining, by a base station within a cell, a benefit to out-of-cell user equipment when a base station transmits with certain transmission attributes, wherein the transmission attributes are at least one of a transmit power, beamforming vector or multiple input multiple output transmission. At 1254, method 1250 can include determining, by the base station, a benefit to a user equipment within the cell when the base station transmits with certain transmission attributes. At 1256, method 1250 can include determining, by the base station, the total benefit to the out-of-cell user equipment and to the user equipment within the cell.

FIG. 12H is a flowchart of an example of a method for facilitating interference management for transmission of data packets on a downlink of a wireless communication system in accordance with aspects described herein. At 1260, the method 1258 can include: determining, by a serving base station, a first set of user equipment to contend for a resource. At 1262, method 1258 can include scheduling, by the serving base station, transmission of one or more coordination messages by the first set of user equipment. At 1264, method 1258 can include receiving, by the serving base station, interference information from the first set of user equipment. At 1266, method 1258 can include determining, by the serving base station, a second set of user equipment to transmit information. At 1268, method 1258 can include scheduling, by the serving base station, transmission of the information to the second set of user equipment.

In some embodiments, one or more of the user equipment of the second set of user equipment is included in the first set of user equipment. The first set of user equipment can include a primary set and a secondary set, wherein the primary set includes ones of the first set of user equipment having at least one of: a signal-to-interference and noise ratio determined from a channel quality indicator estimated with an interference base station lowering power, a signal-to-interference and noise ratio determined from a channel quality indicator estimated without an interference base station lowering power, a traffic priority or a benefit to the user equipment.

In some embodiments, one or more coordination messages are interference management requests that include information indicative of a request to contend for a resource by the first set of user equipment.

In some embodiments, interference information from at least one of the first set of user equipment to contend for a resource includes at least one of transmit power level from one of more base-stations, information indicative of a backoff in transmission by at least one of one or more base stations, or information indicative of signal-to-interference and noise ratio or channel quality indicator determined from a power of one or more pilots.

In some embodiments, scheduling transmission of the information to the second set of user equipment comprises transmitting downlink transmission grants to the second set of user equipment to transmit information.

In some embodiments, determining the second set of user equipment to transmit data further comprises selecting a plurality of user equipment based on at least one of: a traffic priority, a signal-to-interference and noise ratio computed at a user equipment as a result of measuring interference based on at least one of pilots signaled by an interference base station in response to a coordination message received from the user equipment or a signal-to-interference and noise ratio computed based on pilots used to compute a channel quality indicator.

In some embodiments, determining the second set of user equipment to transmit data comprises selecting a plurality of user equipment having a predicted interference less than a selected threshold or a signal-to-interference and noise ratio being more than a selected threshold. In some embodiments, determining the first set of user equipment to contend for a resource comprises determining one or more user equipment in a cell that will benefit at a level that is greater than a level of benefit associated with one or more other user equipment in the cell. In some embodiments, determining the first set of user equipment to contend for a resource comprises determining an amount of interference a user equipment of the first set of user equipment is likely to see if a coordination message for the user equipment is transmitted to a base station in a neighboring cell.

In some embodiments, determining the first set of user equipment to contend for a resource comprises: determining if a benefit to the user equipment of the first set of user equipment is greater than a selected threshold; and selecting the user equipment of the first set of user equipment if the benefit is greater than the selected threshold.

In some embodiments, determining the first set of user equipment to contend for a resource comprises: determining if a benefit to the user equipment of the first set of user equipment is greater than a benefit to a second set of user equipment; and selecting the user equipment of the first set of user equipment if the benefit is greater than the second set of user equipment.

In some embodiments, determining the first set of user equipment to contend for a resource comprises determining a priority of traffic associated with one or more user equipment in a cell, wherein the determining a priority of traffic associated with one or more user equipment in a cell comprises: determining a traffic type associated with the one or more user equipment in a cell; determining a buffer state for the one or more user equipment in a cell, wherein the buffer state for the one or more user equipment in the cell is based on one or more parameters associated with the one or more user equipment in the cell, wherein the one or more parameters include a head-of-line delay for the user equipment in a cell, packet delay for the user equipment in a cell, queue length for the user equipment in a cell, packet sizes for the user equipment in a cell or an average rate at which a queue for the user equipment in a cell has been served in the past; mapping the one or more parameters associated with the one or more user equipment in a cell to a priority metric for one or more flows of traffic associated with the one or more user equipment in a cell; and selecting as the first set of user equipment to contend for a resource.

In some embodiments, a priority of traffic is transmitted to the user equipment when a serving base station schedules the user equipment to transmit the one or more coordination messages.

In some embodiments, selecting is performed based on one or more of: a priority metric being greater than a priority metric for a second set of the one or more user equipment, an expected signal-to-interference and noise ratio when no coordination message is transmitted, an expected signal-to-interference and noise ratio when a coordination message is transmitted, a quality of service class identifier label or a buffer state, wherein the buffer state is indicated by one or more of a head of line delay, a packet delay, a packet size, a queue length, a queue size, an average rate or an average rate at which the queue for the user equipment in the cell has been served in the past.

In some embodiments, selecting as the first set of user equipment to contend for a resource comprises selecting a plurality of the one or more user equipment in the cell having a priority metric greater than a selected threshold. In some embodiments, the buffer state is for one or more logical channels of the one or more user equipment in the cell. In some embodiments, the expected signal-to-interference and noise ratio when no coordination message is transmitted is obtained via a channel quality indicator report.

In some embodiments, the expected signal-to-interference and noise ratio when a coordination message is transmitted is obtained via at least one of a history of past interference reported by the user equipment or one or more measurement reports from the user equipment to a base station.

FIG. 12I is a flowchart of an example of a method for facilitating interference management on an uplink of a wireless communication system. At 1272, the method 1270 can include receiving, by a base station in a cell that serves user equipment in the cell, information indicative of a buffer status for one or more logical channel groups at a user equipment. At 1274, method 1270 can include transmitting, by the base station, an interference management request to one or more out-of-cell user equipment. At 1276, method 1270 can include receiving, by the base station, information indicative of intended transmit power from the one or more out-of-cell user equipment and a power commitment by the user equipment in the cell in response to the one or more out-of-cell user equipment receiving the interference management request.

At 1278, method 1270 can include scheduling, by the base station, transmission of data from the user equipment in a cell, wherein the scheduling is based on information indicative of intended transmit power.

FIG. 12J is a flowchart of an example of a method for facilitating scheduling in a wireless communication system. At 1281, method 1280 can include receiving, by a serving base station, a buffer status report from user equipment having one or more logical channel groups. At 1282, method 1280 can include configuring, by the serving base station, a first priority metric and a first prioritized bit rate for at least one of the one or more logical channel groups, wherein the configuring a first priority metric and a first prioritized bit rate for at least one of the one or more logical channel groups is in response to information included in the buffer status report.

At 1283, method 1280 can include determining, by the serving base station, interference at the user equipment. At 1284, method 1280 can include re-configuring, by the serving base station, the first priority metric and the first prioritized bit rate for the at least one of the one or more logical channel groups in response to determining interference at the user equipment.

In some embodiments, the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group. In some embodiments, configuring the first prioritized bit rate is performed via radio resource control signaling.

In some embodiments, the first priority metric or the second priority metric is based on one or more of: a priority of a logical channel group, an estimated head of line delay, an estimated queue length, an estimated packet delay, an estimated packet size, an estimated average rate at which a queue has been served in the past.

FIG. 12K is a flowchart of an example of a method for facilitating interference management on an uplink of a wireless communication system. At 1286, method 1285 can include determining, by a base station, head of line delay for one or more logical channel groups at user equipment, wherein determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

FIG. 12L is a flowchart of an example of a method for facilitating interference management on an uplink of a wireless communication system. At 1288, method 1287 can include transmitting, by user equipment, a buffer status report from user equipment having one or more logical channel groups. At 1289, method 1287 can include receiving, by the user equipment, information for configuring a priority metric and a prioritized bit rate for at least one of the one or more logical channel groups, wherein the configuring a priority metric and a prioritized bit rate for at least one of the one or more logical channel groups is in response to information included in the buffer status report.

At 1290, method 1287 can include receiving, the user equipment, information for re-configuring the priority metric and the prioritized bit rate for the at least one of the one or more logical channel groups in response to a serving base station for the user equipment having one or more logical channel groups determining interference at the user equipment having one or more logical channel groups.

In some embodiments, configuring is performed via radio resource control signaling.

FIG. 12M is a flowchart of an example of a method for facilitating interference management on an uplink of a wireless communication system. At 1292, method 1291 can include selecting, by a base station in a first cell, one or more user equipment of the first cell to schedule on the uplink, wherein the selecting is based on one or more of: interference caused by the one or more user equipment of the first cell to one or more base stations of a second cell, interference received if interference management requests for the one or more user equipment of the first cell are transmitted, a priority of traffic for the one or more user equipment of the first cell, a serving link gain from the one or more user equipment of the first cell to the base station, an instantaneous buffer state for the one or more user equipment of the first cell, a channel quality indicator for the one or more user equipment of the first cell, a head of line delay for the one or more user equipment of the first cell.

FIG. 12N is a flowchart of an example of a method for facilitating interference management on an uplink of a wireless communication system. At 1294, method 1293 can include determining, by a serving base station, a first set of user equipment to contend for a resource. At 1295, method 1293 can include scheduling, by the serving base station, transmission of one or more coordination messages to out-of-cell user equipment. At 1296, method 1293 can include receiving, by the serving base station, interference information. At 1297, method 1293 can include determining, by the serving base station, a second set of user equipment to transmit information, wherein the determining a second set of user equipment to transmit information is in response to determining one or more of interference information or an interference commitment made for a first set of user equipment. At 1298, method 1293 can include scheduling, by the serving base station, transmission of the information by a second set of user equipment.

In some embodiments, one or more user equipment of the second set of user equipment is included in the first set of user equipment.

FIG. 12O is a flowchart of an example of a method for facilitating interference management on an uplink of a wireless communication system. At 1301, method 1299 can include receiving, by a base station in a first cell, a buffer status request. At 1302, method 1299 can include transmitting, by the base station, an interference management request, wherein the interference management request is based on the buffer status request, wherein the transmitting the interference management request comprises transmitting the interference management request over a backhaul to a base station in a second cell.

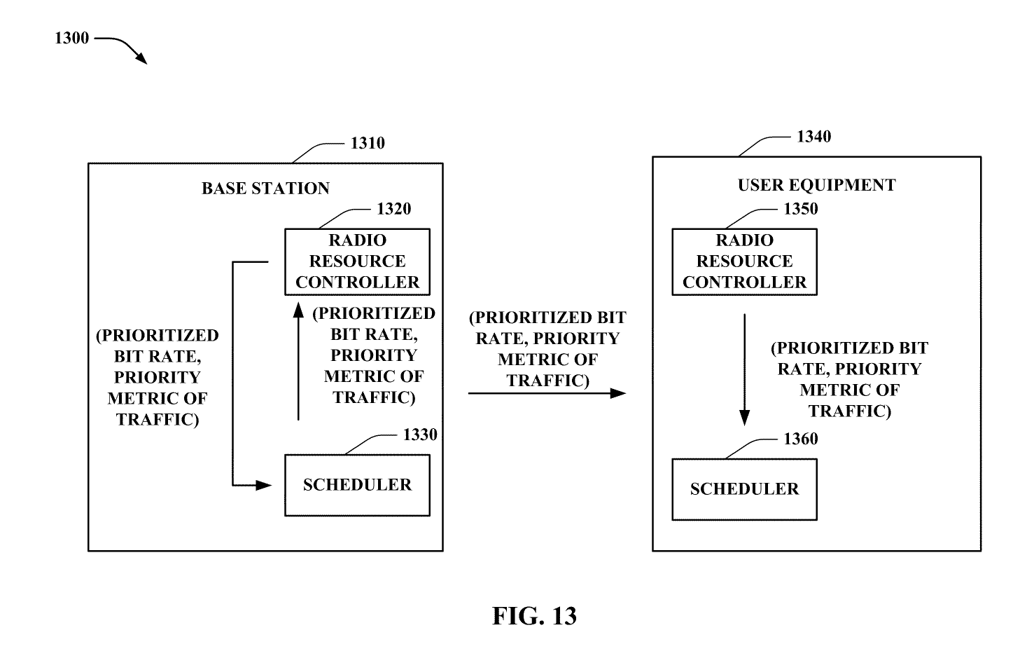

FIG. 13 is an illustration of a block diagram of a system employing feedback for configuring parameters to facilitate interference management on the UL in wireless communication systems.

In some embodiments, the wireless communication system can be an LTE system. In some embodiments, the environment can be a macro cell, a Femto cell or a Pico cell. Scheduling can be performed at the media access control (MAC) layer on the UL in some embodiments.

The system 1300 can include a BS 1310 having a radio resource controller (RRC) 1320 and a scheduler 1330 and a UE 1340 having a RRC 1350 and a scheduler 1360. The RRC 1320 and the scheduler 1330 can be communicatively coupled to one another. Similarly, the RRC 1350 and the scheduler 1360 can be communicatively coupled to one another.

On the LTE UL, resource allocation to the UE 1340 can be specified by the BS 1310. The UE 1340 can also use the allocated resource to multiplex packets for different logical channels for transmission of information on the UL. For example, the UE 1340 can use the allocated resource to multiplex packets for different logical channels for transmission of data on the UL.

A number of parameters in the scheduling policy for multiplexing these different logical channels at the UE 1340 can be configured by the serving BS 1310 via radio resource control signaling. For example, multiple logical channels at the UE can be aggregated into an LCG by the serving BS. The serving BS 1310 can aggregate multiple logical channels at the UE 1340 via radio resource control signaling. In some embodiments, the prioritized bit rate (PBR) and the priority metric of the traffic at the UE 1340 can be configured. The PBR and the priority metric of the traffic can be configured for one or more LCGs at the UE 1340.

The UE 1340 can use the priority and PBR to maintain an average rate at which an LCG is served. For a given configuration, the UE 1340 can select the highest priority LCG for which the average rate at which an LCG is served is less than the PBR for the LCG. For example, the number of packets served from this LCG can be such that either the PBR for this LCG is met or the assigned resources are exhausted. If resources remain after serving the LCG, the UE 1340 can repeat the process selecting LCGs in decreasing order of priority. If the PBR of all LCGs has been satisfied, then the UE 1340 can serve packets from the LCGs such that packets of a higher priority LCG have strict priority above packets of a lower priority LCG.

In the embodiments described herein, the scheduler 1330 can be configured to control the manner in which the UE 1340 prioritizes and selects packets from different logical channels at the UE 1340 for multiplexing the packets. The RRC 1320 can communicate the configured value of the PBR and the priority metric of the traffic to the RRC 1350 at the UE 1340. The RRC 1350 can provide the received PBR and the priority metric of the scheduler 1360. The scheduler 1360 can use the configured values for the PBR and/or the priority metric of the traffic to prioritize and select packets from the different logical channels at the UE 1340.

The scheduler 1330 at the BS 1310 can adapt the PBR and the priority metric of the traffic parameters on the basis of interference that the UE 1340 experiences and/or the relative priority of the UE 1340 as compared to other UEs (not shown) in the cell. Any number of methods, including those described herein, can be used to determine the interference at the UE.

The updated PBR and priority metric of the traffic can be transmitted to the RRC 1350 from the scheduler 1330, and provided to the scheduler 1360. Because the scheduler 1360 at the UE 1340 can also adapt its transmission due to interference and relative priorities, over time, the scheduler 1330 and the scheduler 1360 can converge.

In the serving BS 1310, a feedback mechanism can be employed between the RRC 1320 and the scheduler 1330 for each of the LCGs at the UE. Further, in various embodiments, the functions performed by system 1300 can be performed periodically to maintain consistency in scheduling between the BS 1310 and the UE 1340.

In some embodiments, the serving BS 1310 can schedule resources for UE 1340 and other UEs (not shown) served by the serving BS 1310. The serving BS can provide resource allocation of the UEs for different QoS flows at the LCGs of the UE.

In some embodiments, the QoS flows can be grouped in LCGs in strict priority according to the priority of the traffic at the LCGs of the UEs and/or the relative ordering of delay targets at the LCGs of the UEs.

In some embodiments, for example, one or more LCGs can be configured with an infinite (or extremely large) PBR to improve the likelihood of strict priority of packets wherein information in a higher priority LCG is transmitted from the UE 1340, and/or multiplexed into a media access control packet data unit (MAC PDU), before data of a lower priority LCG. At the serving BS 1310, UEs can be prioritized according to the following rules.

The first rule can be that the priority of an LCG can be a function of the HOL delay for the UE 1340, a number of packets in a buffer for the UE 1340 and/or the strength of the serving communication link between each UE 1340 served by the serving BS and the serving BS 1310.

In some embodiments, for the UE 1340, for example, the strength of the serving communication link can be the channel gain between the serving BS 1310 and the UE 1340. In some embodiments, the HOL delay can be estimated at the serving BS 1310 based on the method 1100 described with reference to FIG. 11. In some embodiments, the HOL delay for the LCGs at a UE (e.g., UE 1340) can be estimated at the serving BS 1310 by using a Long Buffer Status Report, which can provide the number of bytes in each LCG at the UE, the number of bytes scheduled for a UE through physical downlink control channel (PDCCH) assignments, but which have not been decoded successfully at the serving BS 1310 on the UL as yet, and/or (with reference to FIG. 10) feedback from the RLC 1020 of the serving BS 1310 on the number of bytes successfully received from each LCG of a UE.

The second rule can be that the priority at a UE 1340 is determined by the highest priority LCG at the UE that has packets in the buffer for the UE.

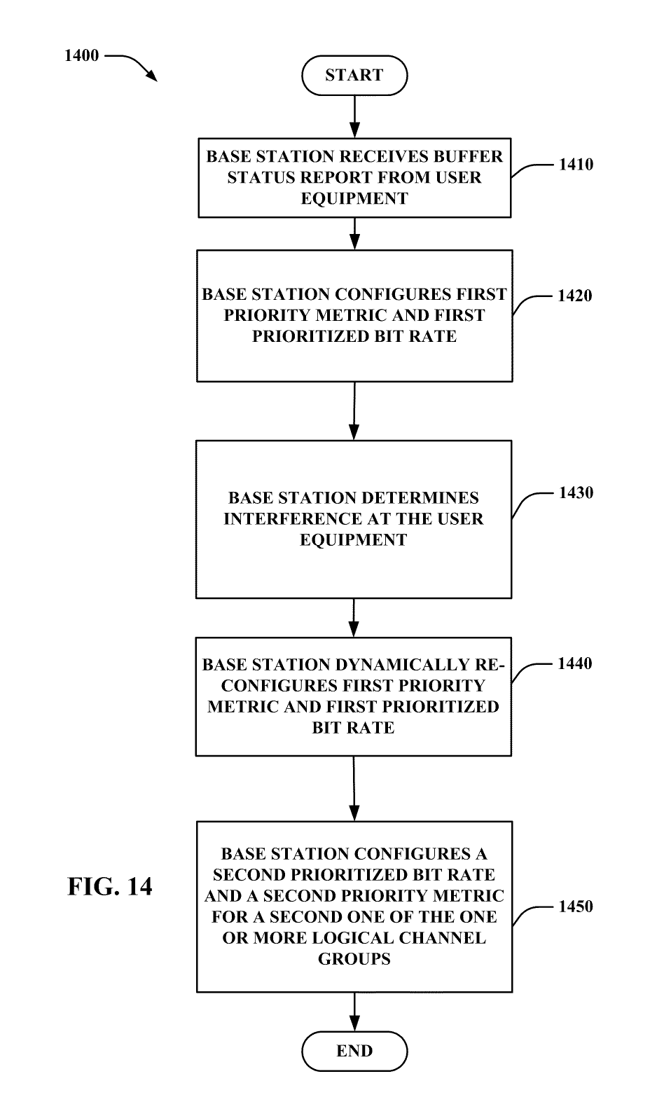

FIG. 14 is an illustration of an example of a method of configuring parameters at a UE to facilitate interference management on the UL in a wireless communication system.

At 1410, the method 1400 can include the serving BS receiving a buffer status report from the UE that the serving BS serves. The buffer status report can include, but is not limited to, information regarding an amount of information to be transmitted from the UE and/or information regarding an amount of information in different LCGs at the UE. In some embodiments, the amount of information in the different LCGs at the UE can be specified in bytes.

Because the UE usually transmits multiple times before the BS can decode the buffer status report, the BS can assume that some of the bytes reported in the LCGs in the buffer status report reported have already been transmitted by the time that the BS decodes the buffer status report. Accordingly, in some embodiments, the serving BS reduces the amount of the bytes by a selected amount upon receipt of the buffer status report.

At 1420, the method 1400 can include the serving BS configuring the PBR and the priority metric for one or more LCGs at the UE. In some embodiments, a PBR and a priority metric can be configured for each LCG at the UE. The configuring can be performed via radio resource control signaling in some embodiments.

At 1430, the method 1400 can include the serving BS determining the interference at the UE. Interference at the UE can be determined by any number of methods described herein.

At 1440, the method 1400 can include re-configuring the UE with a new PBR and/or a new priority metric based on the interference at the UE. Accordingly, feedback of the interference can be employed in the system to adapt the PBR and the priority metric.

In some embodiments, a PBR and a priority metric can be re-configured for each LCG at the UE. The re-configuring can be performed via the radio resource control signaling between the RRC in the serving BS and the RRC in the UE.

At 1450, the method 1400 can include the BS configuring a second priority metric and a second prioritized bit rate for a second one of the one or more logical channel groups. The scheduling transmission of information from the one or more logical channel groups can be such that an order of transmission from the one or more logical channel groups is in decreasing order of priorities. Scheduling transmission of information from the at least one of the one or more logical channel groups to transmit prior to the second one of the one or more logical channel groups can be response to the second priority metric being less than the first priority metric, wherein the configuring a second priority metric and a second prioritized bit rate is performed by the BS.

The method 1400 can be repeated at periodic intervals to update the PBR and the priority metric.

In another embodiment (not shown), closed loop adaptation of UE scheduling parameters can be performed on the UL. In some environments, the standard approach is to configure the priority and the PBR based on the QoS parameters of the LCs in a LCG. When an LC is admitted, the PBR and the priority can be set. If the load increases, the admission control mechanism can terminate the LCs. While the PBR value can follow naturally for guaranteed bit rate (GBR) flows, the definition of PBR for best effort traffic such as FTP/HTTP is not obvious. In fact, one may want to increase/decrease the PBR for such traffic based on the load in the system. For example, when the load increases, the PBR for such flows may be decreased. In addition, in some embodiments, all best effort flows cannot be collected into one logical channel group because one best effort traffic flow can be prioritized over another best effort flow. For example, HTTP may have higher priority than FTP. Feedback from the scheduler may also be useful in setting PBR values for streaming/live video. For example, the video quality can be upgraded or degraded based on the load.

In some embodiments (not shown), the PBR of the LCGs in a UE can be configured based on feedback from the scheduler. The scheduler can then use the values of the PBR to modify the scheduling policy as the PBRs evolve in time. Similar feedback can also be obtained from the RLC layer. For example, the RLC can provide feedback to the RRC (not shown) and the RRC can receive feedback from the scheduler 1010 and provide a PBR to the scheduler.

One quantity that can be transmitted via feedback from the scheduler to the RRC is the resource allocation to the UE, which can be provided via a number of resource blocks (RBs), transport format. This information can be averaged over time. Other quantities that can be transmitted via feedback from the scheduler to the RRC can be the average rate at which the UE is served, statistics of the inter-service times, average carrier-to-interference ratio (C/I) at which a signal from a UE is received, any function of the resource allocation, transport format, average rate at which the UE is served, statistics of the inter-service times, and/or the average C/I, and the PBRs assigned to each LCG of a UE, and/or the PBRs for the different LCGs based on the above information and the QCI parameters.

In some embodiments, the feedback from the RLC can include the average rate at which a UE is served, the rate at which each LC of a UE is served, any function of the average rate at which a UE is served and/or the rate at which each LC of a UE is served and the PBRs assigned to each LCG of a UE and/or the PBRs for the different LCGs based on the above information and the QCI parameters.

One embodiment of the feedback mechanism is as follows. The implementation can include each LCG of a UE being associated with a utility function that maps the average rate at which a LCG is served to the value seen by the LCG. GBR requirements can be modeled via utility functions that have a high slope at values less than the GBR and a small slope at value greater than the GBR.

The scheduling policy at the MAC layer can be aim to maximize the sum of the utilities of all LCGs across all UEs. Specifically, it can aim to maximize equation nine:

$${\sum }_{ue}^{ } {\sum }_{lcg}^{ } {U}_{ue , lcg} ( {x}_{ue , lcg} ) \qquad ( 9 )$$

where U_{ue, lcg} is the utility function for UE ue and LCG lcg, while x_{ue, lcg} is the average rate at which the LCG for the UE is served. The optimization at the scheduler can compute the amount of bandwidth and power allocated at an LCG level. The resources allocated to all LCGs for a given UE can be aggregated to generate the resource assignment for that UE. However, since the scheduler at the UE can be based on the priorities and the PBRs for the different LCGs, the UE can multiplex packets in a way that is inconsistent with the resource allocation computed by the scheduler. Over time, the average resource allocation for a UE can be computed and conveyed back to the RRC layer. The RRC layer can then configure the PBRs such that the sum of the utilities across the LCGs for each UE is maximized for the resources allocated to that UE. Alternatively, the computation of the PBRs can be done at the scheduler (or MAC layer) itself.

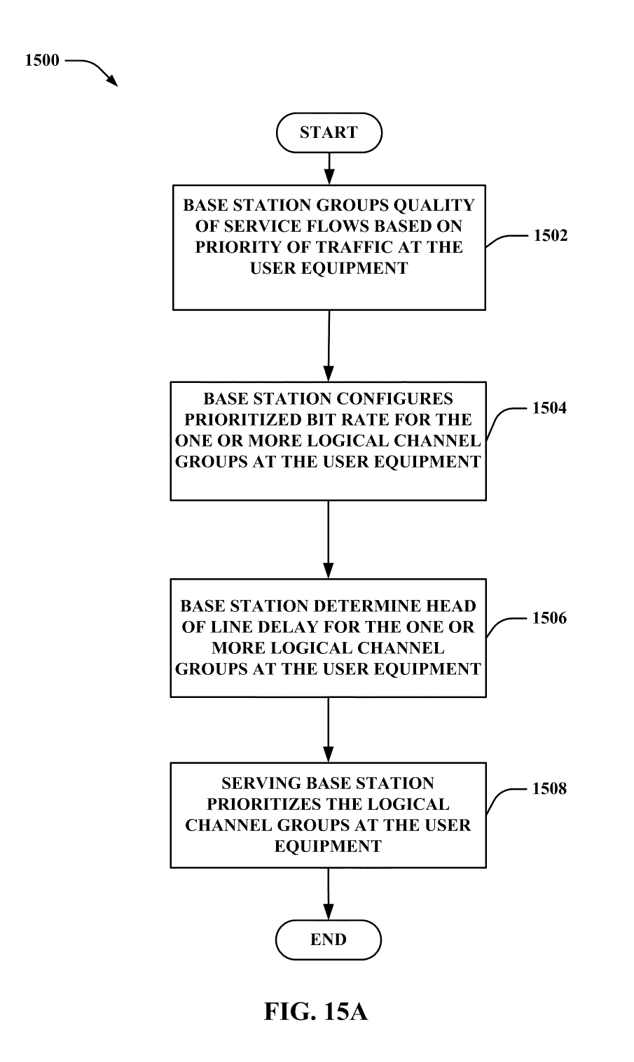

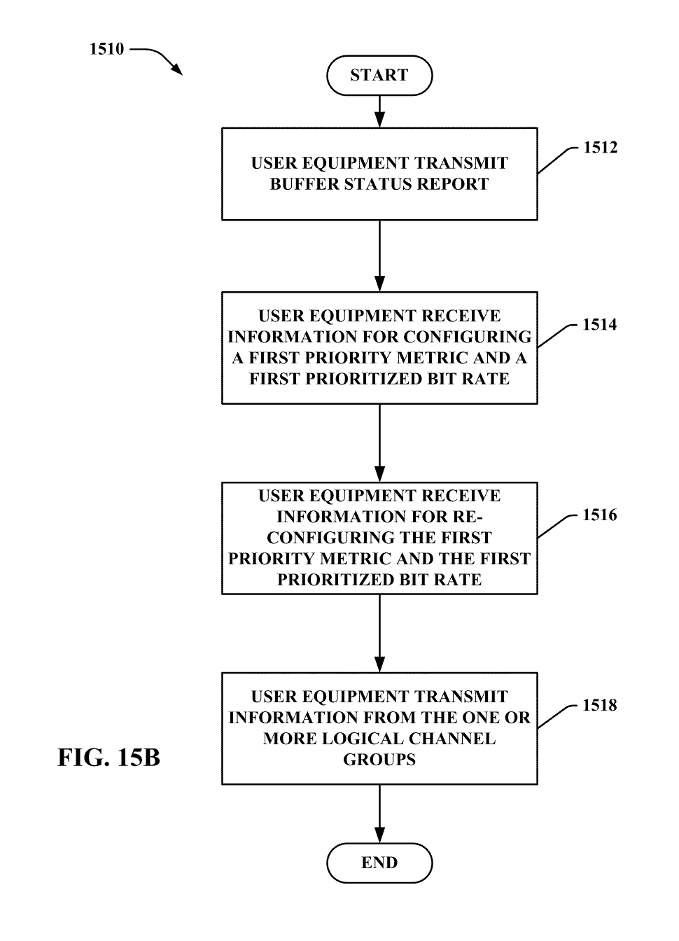

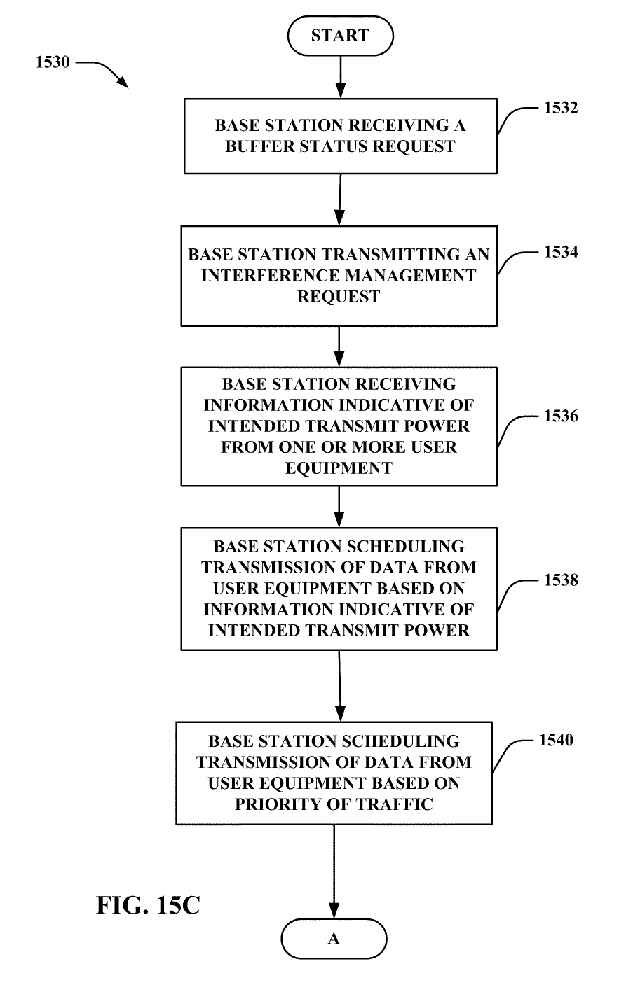

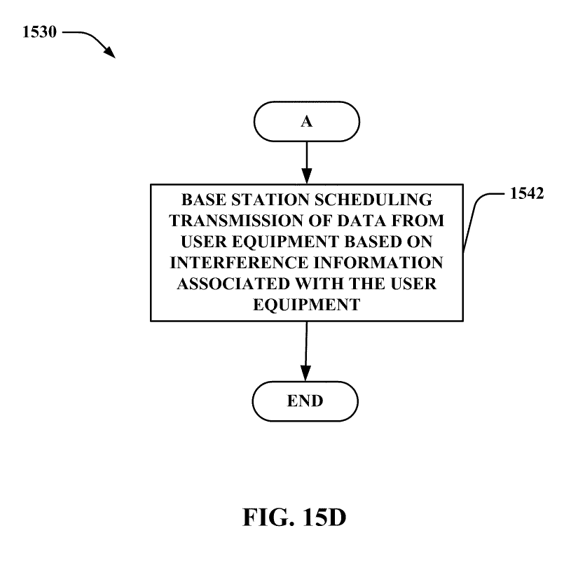

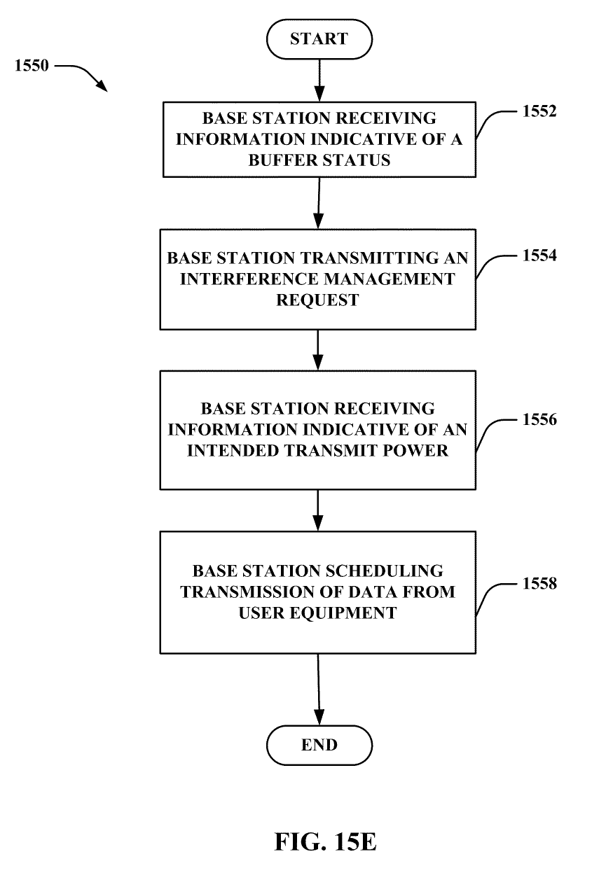

FIG. 15A is an illustration of an example of a method of resource allocation for UEs on an UL in a wireless communication system. At 1502, the method 1500 can include the serving BS grouping QoS flows in strict priority according to the priority of the traffic at the UE and/or the relative ordering of delay targets of traffic at the UE. At 1504, the method 1500 can include the serving BS configuring a PBR for each LCG at a UE. In some embodiments, the PBR configured can be infinite (or a very large value).

At 1506, the method 1500 can include the serving BS determining the HOL delay for each LCG at each UE served by the BS. In some embodiments, the HOL delay can be estimated by the serving BS based on a Long Buffer Status Report, which can provide the number of bytes in each LCG at the UE, the number of bytes scheduled for a UE through PDCCH assignments, but which have not been decoded successfully at the serving BS on the UL as yet, and/or feedback from the RLC of the serving BS on the number of bytes successfully received from each LCG of a UE.

At 1508, the method 1500 can include the serving BS prioritizing the LCGs at the UEs. Each LCG priority can be a function of the HOL delay for the UE, a number of packets in a buffer for the UE and/or the strength of the serving communication link between each UE served by the serving BS and the serving BS.

In some embodiments (not shown), the method 1500 can also include the serving BS prioritizing the UEs. The UE priority (amongst all UEs served by the serving BS) can be determined by the highest priority LCG at the UE that has packets in the buffer.

FIG. 15B is an illustration of an example of a method of resource allocation for UEs on an UL in a wireless communication system. At 1512, method 1510 can include transmitting a buffer status report from UE having one or more logical channel groups. At 1514, method 1510 can include receiving information for configuring a first priority metric and a first prioritized bit rate for at least one of the one or more logical channel groups, wherein the configuring a first priority metric and a first prioritized bit rate for at least one of the one or more logical channel groups is in response to information included in the buffer status report. At 1516, method 1510 can include receiving information for re-configuring the first priority metric and the first prioritized bit rate for the at least one of the one or more logical channel groups in response to a serving BS for the UE having one or more logical channel groups determining interference at the UE having one or more logical channel groups. At 1518, method 1510 can include transmitting information from the one or more logical channel groups such that an order of transmission from the one or more logical channel groups is in decreasing order of priorities. In some embodiments, the configuring is performed via RRC signaling.

FIGS. 15C and 15D are illustrations of an example of a method of resource allocation on an UL in a wireless communication system. At 1532, method 1530 can include a BS in first cell receiving a buffer status request.

At 1534, method 1530 can include the BS in the first cell transmitting an interference management request, wherein the interference management request is based on the buffer status request. In some embodiments, transmitting the interference management request can include transmitting the interference management request over-the-air to out-of-cell UE. In some embodiments, transmitting the interference management request can include transmitting the interference management request over a backhaul to a BS in a second cell. In some embodiments, the interference management request can be a RUM.

At 1536, method 1530 can include receiving information indicative of intended transmit power from one or more of the out-of-cell UE is in response to the one or more out-of-cell UE receiving the interference management request.

At 1538, method 1530 can also include scheduling transmission of data from UE in the first cell, wherein the scheduling is based on the information indicative of intended transmit power. At 1540, method 1530 can include scheduling transmission of data from UE in the first cell based on priority of traffic. At 1542, method 1530 can include scheduling transmission of data from UE in the first cell based on interference information associated with the UE. In some embodiments, the interference information can include interference incident on resources assigned to the UE in the first cell or interference the UE in the first cell causes to a BS in a second cell.

FIG. 15E is an illustration of an example of a method of resource allocation on an UL in a wireless communication system. At 1552, method 1550 can include receiving information indicative of a buffer status for one or more logical channel groups at a UE. At 1554, method 1550 can include transmitting an interference management request to one or more out-of-cell UE. At 1556, method 1550 can include receiving information indicative of intended transmit power from one or more of the out-of-cell UE in response to the one or more out-of-cell UE receiving the interference management request.

At 1558, method 1550 can include scheduling transmission of data from the UE in the cell, wherein the scheduling is based on the information indicative of intended transmit power.

In some embodiments, scheduling transmission of data from the UE in the cell can be based on a determined priority of traffic intended for the UE in the cell. In some embodiments, scheduling transmission of data from the UE in the cell is based on interference information associated with the UE in the cell. In some embodiments, interference information can include interference incident on resources assigned to the UE in the cell or interference the UE in the cell causes to an out-of-cell BS.

Another method (not shown) of facilitating interference management on an UL of a wireless communication system can be as follows. The method can include determining a benefit to a UE in a first cell and to which a transmission can be scheduled. The method can also include determining a degradation with the transmission, wherein the degradation is to a UE in a second cell. The second cell can be different from the first cell. The degradation can result from interference at a BS in the second cell and caused by the UE in the first cell. The method can also include comparing the benefit to the degradation. The method can also include scheduling transmission by the UE in the first cell if the benefit to the UE in the first cell is greater than the degradation to the UE in the second cell.

Another method (not shown) facilitating interference management on an UL of a wireless communication system can be as follows. The method can include determining a first set of UE to contend for a resource. The method can also include scheduling transmission of one or more coordination messages by the first set of UE.

The method can also include receiving interference information from at least one of the first set of UE to contend for a resource, wherein interference information from at least one of the first set of UE to contend for a resource is received by the first set of UE to contend for a resource in response to the first set of UE to contend for a resource transmitting the one or more coordination messages to one or more BSs, and the one or more BSs transmitting interference information to the at least one of the first set of UE to contend for a resource.

The method can also include determining a second set of UE to transmit information, wherein the determining a second set of UE to transmit information is in response to determining one or more of interference information, an interference commitment made for the BS to out-of-cell UE, a channel quality indicator or a traffic priority for at least one of the first set of UE to contend for a resource.

The method can also include scheduling transmission of the information by the second set of UE. In some embodiments, determining a first set of UE, the scheduling transmission of one or more coordination messages, the receiving, the determining and the scheduling transmission of the information by the second set of UE can be performed by a serving BS.

In some embodiments, one or more of the UE of the second set of UE is included in the first set of UE. In some embodiments, the first set of UE includes a primary set and a secondary set, wherein the primary set includes ones of the first set of UE that are associated with a channel quality indicator or a traffic priority having first values and the secondary set includes ones of the first set of UE that are associated with a channel quality indicator or a traffic priority having second values, wherein the first values are greater than the second values, and wherein the second set of UE is the primary set.

In some embodiments, the one or more coordination messages are interference management requests that include information indicative of a request for a resource by the first set of UE to contend for a resource.

In some embodiments, the interference information from at least one of the first set of UE to contend for a resource includes at least one of an effective channel quality indicator or a transmit power level from the one or more BSs.

In some embodiments, the interference information from at least one of the first set of UE to contend for a resource includes information indicative of a backoff in transmission by the at least one of the one or more BSs.

In some embodiments, the scheduling transmission of the information by the second set of UE comprises transmitting downlink transmission grants to the second set of UE to transmit information.

In some embodiments, determining the second set of UE to transmit data comprises selecting a plurality of UE having the predicted interference less than a selected threshold.

In some embodiments, determining the first set of UE to contend for a resource comprises determining one or more of a first plurality of UE for which the benefit is greater than a benefit to the second plurality of UE.

In some embodiments, determining the second set of UE to transmit data further comprises selecting a plurality of UE based on one or more of a traffic priority or a quality channel indicator.

In some embodiments, determining the first set of UE to contend for a resource comprises determining at least one of: determining a buffer state for the one or more UE in a cell, determining an effective channel quality indicator for the one or more UE in a cell or determining channel gain information between the one or more UE and one or more BSs.

In some embodiments, determining the first set of UE to contend for a resource comprises determining one or more UE in a cell that will benefit at a level that is greater than a level of benefit associated with one or more other UE in the cell.

In some embodiments, determining the first set of UE to contend for a resource comprises determining an amount of interference a UE of the first set of UE is likely to see if a coordination message for the UE is transmitted to a BS in a neighboring cell.

In some embodiments, determining the first set of UE to contend for a resource comprises: determining if a benefit to the UE of the first set of UE is greater than a selected threshold; and selecting the UE of the first set of UE if the benefit is greater than the selected threshold.

In some embodiments, determining the first set of UE to contend for a resource comprises: determining if a benefit to the UE of the first set of UE is greater than a benefit to a second set of UE; and selecting the UE of the first set of UE if the benefit is greater than the second set of UE.

In some embodiments, determining the first set of UE to contend for a resource comprises determining a priority of traffic associated with one or more UE in a cell. In some embodiments, determining the priority of traffic associated with one or more UE in a cell comprises: determining a traffic type associated with the one or more UE in a cell; determining a buffer state for the one or more UE in a cell; mapping the one or more parameters associated with the one or more UE in the cell to a priority metric for one or more flows of traffic associated with the one or more UE in the cell; and selecting as the first set of UE to contend for a resource a plurality of the one or more UE in the cell having a priority metric greater than a selected threshold.

In some embodiments, determining the buffer state is based on one or more parameters associated with the one or more UE in the cell. The one or more parameters can include a head-of-line delay for the UE in the cell, packet delay for the UE in the cell, queue length for the UE in the cell, packet sizes for the UE in the cell or the average rate at which the queue for the UE in the cell has been served in the past.

In some embodiments, determining the first set of UE to contend for a resource comprises determining a priority of traffic associated with one or more UE in a cell, wherein the determining a priority of traffic associated with one or more UE in a cell comprises: determining a traffic type associated with the one or more UE in a cell; determining a buffer state for the one or more UE in a cell; mapping the one or more parameters associated with the one or more UE in the cell to a priority metric for one or more flows of traffic associated with the one or more UE in the cell; and selecting as the first set of UE to contend for a resource a plurality of the one or more UE in the cell having a priority metric greater than a priority metric for a second set of the one or more UE in the cell.

In some embodiments, the buffer state for the one or more UE in the cell is based on one or more parameters associated with the one or more UE in the cell, wherein the one or more parameters include a head-of-line delay for the UE in the cell, packet delay for the UE in the cell, queue length for the UE in the cell, packet sizes for the UE in the cell or the average rate at which the queue for the UE in the cell has been served in the past.

In some embodiments, the buffer state is for one or more logical channels of the one or more UE in the cell.

In some embodiments, determining the first set of UE to contend for a resource comprises determining a priority of traffic associated with one or more UE in a cell, wherein the determining a priority of traffic associated with one or more UE in a cell comprises: determining a traffic type associated with the one or more UE in a cell; determining a buffer state for the one or more UE in a cell, wherein the buffer state for the one or more UE in the cell is based on one or more parameters associated with the one or more UE in the cell, wherein the one or more parameters include a head-of-line delay for the UE in the cell, packet delay for the UE in the cell, queue length for the UE in the cell, packet sizes for the UE in the cell or the average rate at which the queue for the UE in the cell has been served in the past; mapping the one or more parameters associated with the one or more UE in the cell to a priority metric for one or more flows of traffic associated with the one or more UE in the cell; and selecting as the first set of UE to contend for a resource a plurality of the one or more UE in the cell. In some embodiments, selecting is performed based on one or more of: an expected signal-to-interference noise ratio when no coordination message is transmitted, an expected signal-to-interference noise ratio when a coordination message is transmitted, a quality of service class identifier label or a buffer state, wherein the buffer state is indicated by one or more of a head of line delay, a packet delay, a packet size, a queue length, a queue size, an average rate or an average rate at which the queue for the UE in the cell has been served in the past.

In some embodiments, the expected signal-to-interference noise ratio when no coordination message is transmitted is obtained via a channel quality indicator report. In some embodiments, the expected signal-to-interference noise ratio when a coordination message is transmitted is obtained via determining the interference received at one or more different BSs based on measurement reports.

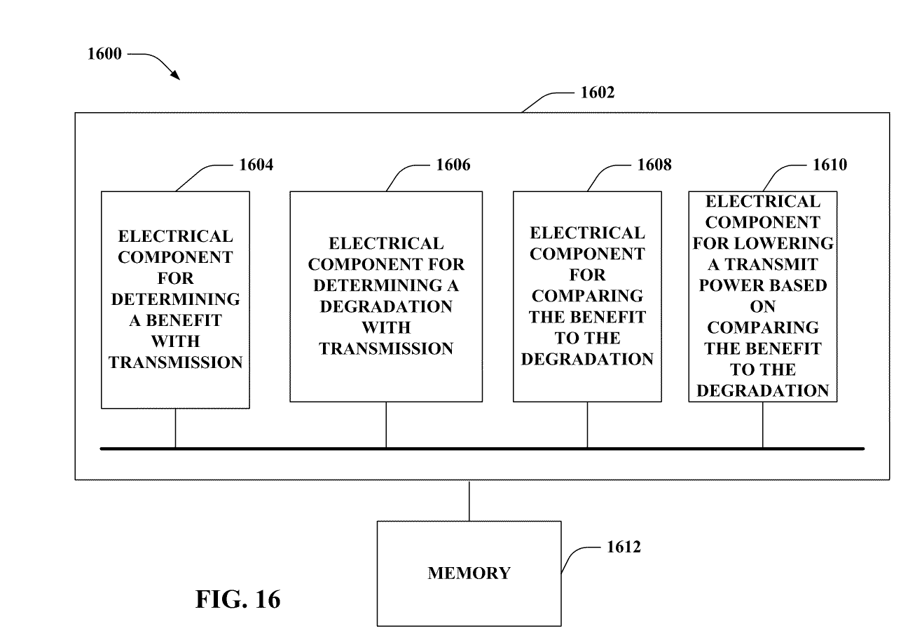

FIG. 16 is an illustration of a block diagram of an example system for facilitating interference management in accordance with various aspects set forth herein. It is to be appreciated that system 1600 is represented as including functional blocks, which can be functional blocks that represent functions implemented by a processor, hardware, software, firmware, or combination thereof. System 1600 can include a logical or physical grouping 1602 of electrical components for facilitating interference management.

The electrical components can act in conjunction. For instance, the logical or physical grouping 1602 can include an electrical component 1604 for determining a benefit with transmission, wherein the benefit is to an interfering BS in a first cell and from which the transmission would be provided. The logical or physical grouping 1602 can also include an electrical component 1606 for determining a degradation with the transmission, wherein the degradation is to a UE in a second cell, the second cell being different from the first cell. The logical or physical grouping 1602 can also include an electrical component 1608 for comparing the benefit to the degradation.

The logical or physical grouping 1602 can also include an electrical component 1610 for lowering a transmit power based on comparing the benefit to the degradation. In some embodiments, lowering the transmit power is in response to the degradation to the UE in a second cell being greater than the benefit to the UE in a first cell.

The logical or physical grouping 1602 can also include an electrical component 1612 for storing. The electrical component 1612 for storing can be configured to store information indicative of a benefit or a degradation with transmission by an interfering BS.

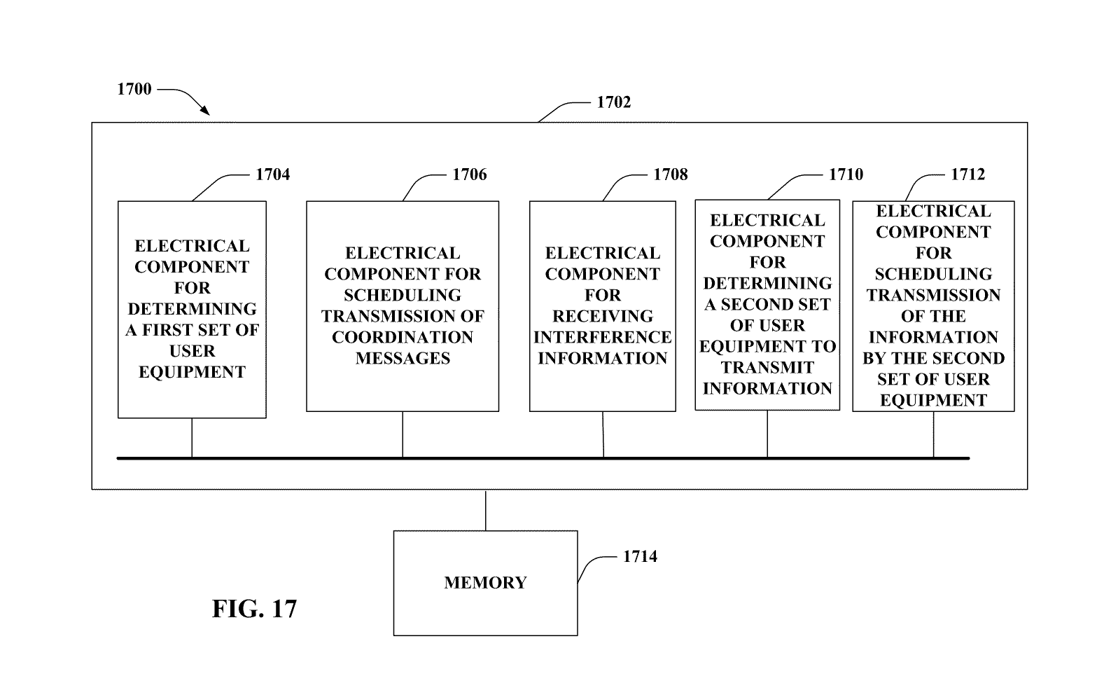

FIG. 17 is an illustration of a block diagram of an example system for facilitating interference management in accordance with various aspects set forth herein. It is to be appreciated that system 1700 is represented as including functional blocks, which can be functional blocks that represent functions implemented by a processor, hardware, software, firmware, or combination thereof. System 1700 can include a logical or physical grouping 1702 of electrical components for facilitating interference management.

The electrical components can act in conjunction. For instance, the logical or physical grouping 1702 can include an electrical component 1704 for determining a first set of UEs to contend for a resource, an electrical component 1706 for scheduling transmission of one or more coordination messages by the first set of UE. The logical or physical grouping 1702 can also include an electrical component 1708 for receiving interference information from at least one of the first set of UEs to contend for a resource, wherein interference information from the first set of UEs is received by the first set of UEs to contend for a resource in response to the first set of UEs to contend for a resource transmitting the one or more coordination messages to one or more interfering BSs, and the one or more interfering BSs transmitting interference information to the at least one of the first set of UE. The logical or physical grouping 1702 can also include an electrical component 1710 for determining a second set of UEs to transmit information, wherein determining a second set of UEs to transmit information is in response to determining a predicted interference on the at least one of the first set of UEs to contend for a resource; and an electrical component 1712 for scheduling transmission of the information by the second set of UE.

The logical or physical grouping 1702 can also include an electrical component 1714 for storing. The electrical component 1714 for storing can be configured to store information indicative of the first set of UE, the second set of UE, scheduling transmission of coordination messages by the first set of UE, scheduling transmission of information by the second set of UEs and/or interference information.

In some embodiments, the one or more coordination messages are interference management request and/or RUMs that include information indicative of a request for a resource by the first set of UEs to contend for a resource. In some embodiments, the interference information from at least one of the first set of UEs to contend for a resource includes at least one of an effective channel quality indicator or a transmit power level from the one or more interfering BSs. In some embodiments, the interference information from at least one of the first set of UEs to contend for a resource includes information indicative of a backoff in transmission by the at least one of the one or more interfering BSs.

In some embodiments, scheduling transmission of the information by the second set of UEs can include transmitting DL transmission grants to the second set of UEs to transmit information.

In some embodiments, determining the second set of UEs to transmit data can include selecting a plurality of UE having the predicted interference less than a selected threshold.

In some embodiments, determining the first set of UEs to contend for a resource can include determining at least one of: one or more UEs in a cell that will benefit at a level that is greater than a selected threshold, determining a buffer state for the one or more UEs in the cell, determining an effective channel quality indicator for the one or more UEs in the cell, determining channel gain information between the one or more UEs and one or more interfering BSs.

In some embodiments, determining the first set of UEs to contend for a resource can include determining a priority of traffic associated with one or more UEs in the cell, wherein the determining the priority of traffic associated with one or more UEs in the cell can include: determining a traffic type associated with the one or more UEs in the cell; determining buffer state for the one or more UEs in the cell, wherein the buffer state is based on one or more parameters associated with the one or more UEs in the cell; mapping the one or more parameters associated with the one or more UEs in the cell to a priority metric for one or more flows of traffic associated with the one or more UEs in the cell; and selecting as the first set of UEs to contend for a resource a plurality of the one or more UEs in the cell having a priority metric greater than a selected threshold.

In some embodiments, at least one of the one or more parameters is a head of line delay at the one or more UEs in the cell. In some embodiments, the apparatus also includes: means for computing the head of line delay at the one or more UEs in the cell based on at least one of: an amount of information to be transmitted from the one or more UEs in the cell, an amount of information to be scheduled for transmission to the one or more UEs in the cell over a selected number of past subframes or an amount of information received from a logical channel group at the one or more UEs in the cell.

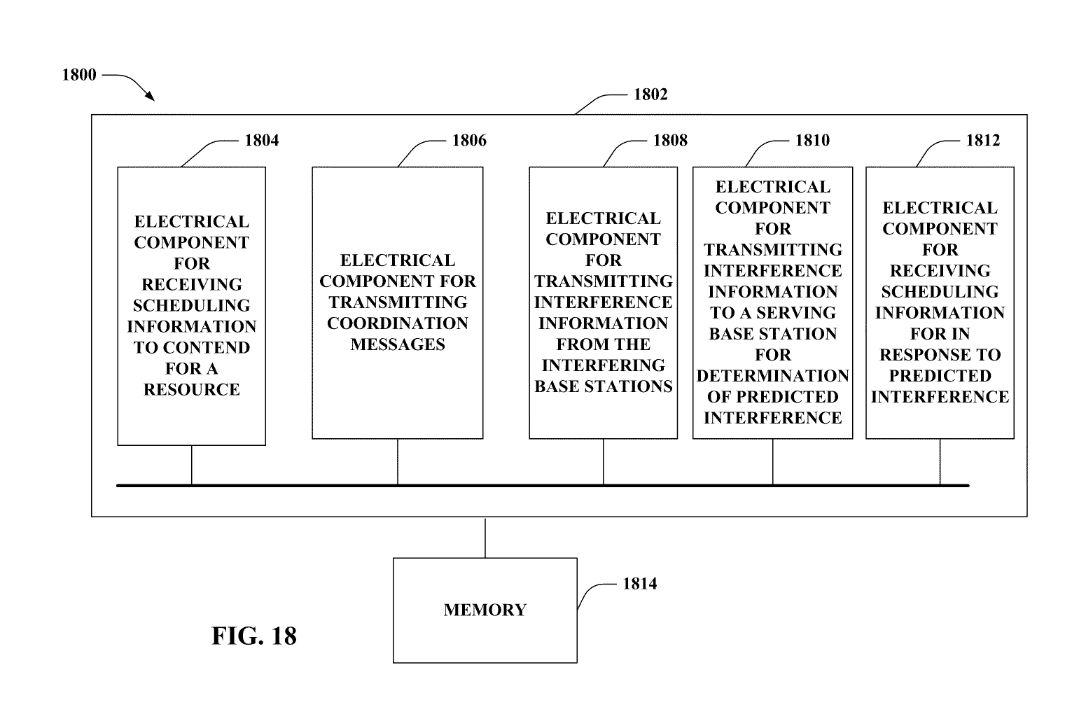

FIG. 18 is an illustration of a block diagram of an example system for facilitating interference management in accordance with various aspects set forth herein. It is to be appreciated that system 1800 is represented as including functional blocks, which can be functional blocks that represent functions implemented by a processor, hardware, software, firmware, or combination thereof. System 1800 can include a logical or physical grouping 1802 of electrical components for facilitating interference management.

The electrical components can act in conjunction. For instance, the logical or physical grouping 1802 can include an electrical component 1804 for receiving scheduling information to contend for a resource. The logical or physical grouping 1802 can also include an electrical component 1806 for transmitting one or more coordination messages to one or more interfering BSs, wherein the transmitting one or more coordination messages to one or more interfering BSs is in response to receiving the scheduling information to contend for a resource. The logical or physical grouping 1802 can also include an electrical component 1808 for receiving interference information from at least one of the one or more interfering BSs. The logical or physical grouping 1802 can also include an electrical component 1810 for transmitting interference information to a serving BS for determination of a predicted interference from the at least one of the one or more interfering BSs. The logical or physical grouping 1802 can also include an electrical component 1812 for receiving scheduling information for transmission of information in response to the predicted interference being less than a selected threshold.

The logical or physical grouping 1802 can also include an electrical component 1814 for storing. The electrical component 1814 for storing can be configured to store information indicative of predicted interference, interference information from one or more interfering BSs, coordination messages and/or scheduling information to contend for a resource.

In some embodiments, the one or more coordination messages are interference management request and/or RUMs that include information indicative of a request for a resource. In some embodiments, the interference information from the at least one of the one or more interfering BSs includes at least one of an effective channel quality indicator or a transmit power level from the one or more interfering BSs.

In some embodiments, the interference information from the at least one of the one or more interfering BSs includes information indicative of a backoff in transmission by at least one of the one or more interfering BSs. In some embodiments, the scheduling information to contend for a resource is received at a UE in response to determining at least one of: whether the UE will benefit at a level that is greater than a selected threshold, determining a buffer state for the one or more UEs in the cell, determining an effective channel quality indicator for the one or more UEs in the cell, determining channel gain information between the one or more UEs and one or more interfering BSs.

In some embodiments, the scheduling information to contend for a resource is received at a UE in response to a determination that a priority of traffic at the UE is above a selected threshold, wherein the determination that the priority of traffic at the UE is above a selected threshold can include: determining a traffic type associated with the UE; determining buffer state for the UE, wherein the buffer state is based on one or more parameters associated with the UE; and mapping the one or more parameters associated with the UE to a priority metric for one or more flows of traffic associated with the UE.

In some embodiments, at least one of the one or more parameters is a head of line delay at the UE. In some embodiments, the head of line delay is computed based on at least one of: an amount of information to be transmitted from the UE, an amount of information to be scheduled for transmission to the UE over a selected number of past subframes or an amount of information received from a logical channel group at the UE.

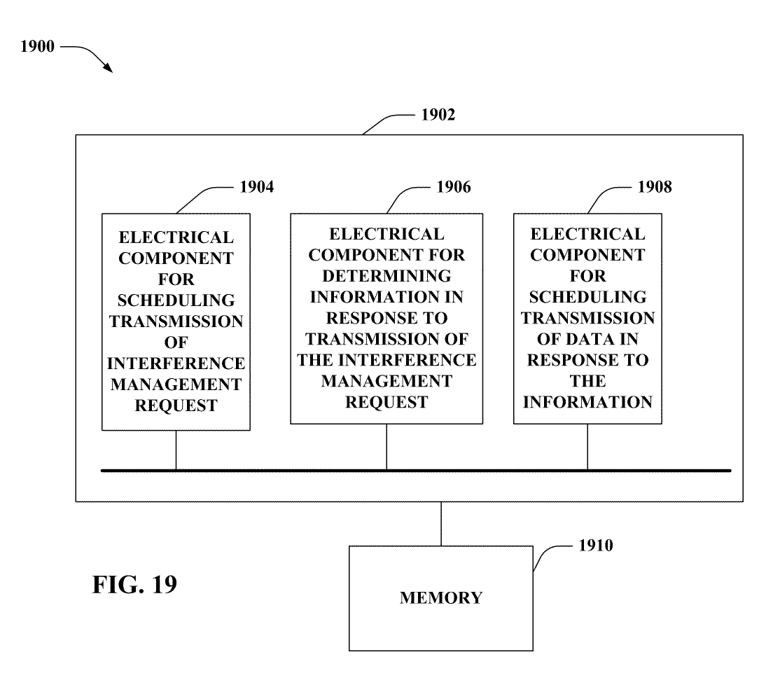

FIG. 19 is an illustration of a block diagram of an example system for facilitating interference management in accordance with various aspects set forth herein. It is to be appreciated that system 1900 is represented as including functional blocks, which can be functional blocks that represent functions implemented by a processor, hardware, software, firmware, or combination thereof. System 1900 can include a logical or physical grouping 1902 of electrical components for facilitating interference management.

The electrical components can act in conjunction. For instance, the logical or physical grouping 1902 can include an electrical component 1904 for scheduling transmission of interference management request and/or RUMs from a first UE and a second UE. The logical or physical grouping 1902 can also include an electrical component 1906 for determining information in response to the transmission of the interference management request and/or RUMs from the first UE and the second UE, wherein the information comprises a first buffer state for the first UE and a second buffer state for the second UE. The logical or physical grouping 1902 can also include an electrical component 1908 for scheduling transmission of data from the first UE and the second UE in response to the information.

The logical or physical grouping 1902 can also include an electrical component 1910 for storing. The electrical component 1910 for storing can be configured to store scheduling information for transmission of data, information in response to transmission of interference management request and/or RUMs.

In some embodiments, the information can also include a first priority of traffic at the first UE and a second priority of traffic at the second UE. In some embodiments, scheduling transmission of data from the first UE and the second UE in response to the information can include scheduling the first UE prior to the second UE in response to the first priority of traffic at the first UE being greater than the second priority of traffic at the second UE.

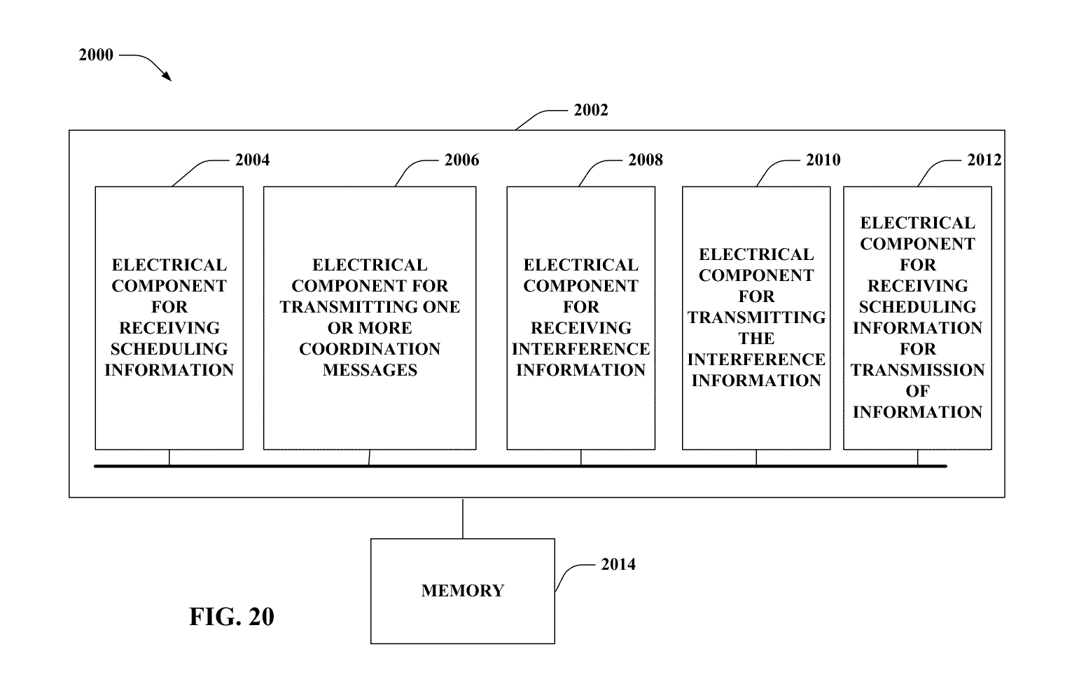

FIG. 20 is an illustration of a block diagram of an example system for facilitating interference management in accordance with various aspects set forth herein. It is to be appreciated that system 2000 is represented as including functional blocks, which can be functional blocks that represent functions implemented by a processor, hardware, software, firmware, or combination thereof. System 2000 can include a logical or physical grouping 2002 of electrical components for facilitating interference management.

The electrical components can act in conjunction. For instance, the logical or physical grouping 2002 can include an electrical component 2004 for receiving scheduling information to contend for a resource. The logical or physical grouping 2002 can also include an electrical component 2006 for transmitting one or more coordination messages to one or more BSs, wherein the transmitting one or more coordination messages to one or more BSs is in response to the receiving scheduling information to contend for a resource.

The logical or physical grouping 2002 can also include an electrical component 2008 for receiving interference information from at least one of the one or more BSs. The logical or physical grouping 2002 can also include an electrical component 2010 for transmitting the interference information from at least one of the one or more BSs to a serving BS for determination of a predicted interference from the at least one of the one or more BSs. The logical or physical grouping 2002 can also include an electrical component 2012 for receiving scheduling information for transmission of information in response to the predicted interference being less than a selected threshold.

In some embodiments, the one or more coordination messages to one or more BSs are interference management requests that include information indicative of a request for a resource.

In some embodiments, the interference information from at least one of the one or more BSs includes at least one of an effective channel quality indicator or a transmit power level from the one or more BSs. In some embodiments, the interference information from at least one of the one or more BSs includes information indicative of a backoff in transmission by the at least one of the one or more BSs.

In some embodiments, scheduling information to contend for a resource is received at a UE in response to determining at least one of: whether the UE will benefit at a level that is greater than a selected threshold, determining a buffer state for one or more UE in a cell, determining an effective channel quality indicator for one or more UE in a cell or determining channel gain information between the one or more UE in a cell and one or more BSs.

In some embodiments, scheduling information to contend for a resource is received at the UE and not at another UE in response to determining that the UE will benefit at a level that is greater than a benefit to the another UE.

In some embodiments, scheduling information to contend for a resource is received at a UE in response to a determination that a priority of traffic at the UE is above a selected threshold, wherein the determination that the priority of traffic at the UE is above a selected threshold includes: determining a traffic type associated with the UE; determining a buffer state for the UE, wherein the buffer state for the UE is based on one or more parameters associated with the UE; and mapping the one or more parameters associated with the UE to a priority metric for one or more flows of traffic associated with the UE.

In some embodiments, scheduling information to contend for a resource is received at a UE and not at another UE in response to a determination that a priority of traffic at the UE is greater than a priority of traffic at the another UE.

In some embodiments, at least one of the one or more parameters associated with the UE is a head of line delay for traffic buffered for a logical channel for a UE at the BS.

In some embodiments, the head of line delay at the UE is computed based on at least one of: an amount of information to be transmitted from the UE, an amount of information to be scheduled for transmission to the UE over a selected number of past subframes or an amount of information received from a logical channel group at the UE.

In some embodiments, each of the one or more coordination messages includes one or more of a priority of traffic for a UE, a strength of a channel from the BS to the UE, a strength of a channel from a serving BS to the UE or an amount of interference that the UE desires to receive.

In some embodiments, the priority of traffic for the UE is based on one or more of the following: a quality of service characteristic, a quality of service class identifier label, an average rate at which the UE has been served in the past, a number of delays for the packets in the buffer awaiting transmission, head-of-line delay, buffer length in bytes or buffer length in number of packets.

The logical or physical grouping 2002 can also include an electrical component 2014 for storing. The electrical component 2014 for storing can be configured to store scheduling information for transmission of data, information in response to transmission of interference management requests and/or RUMs.

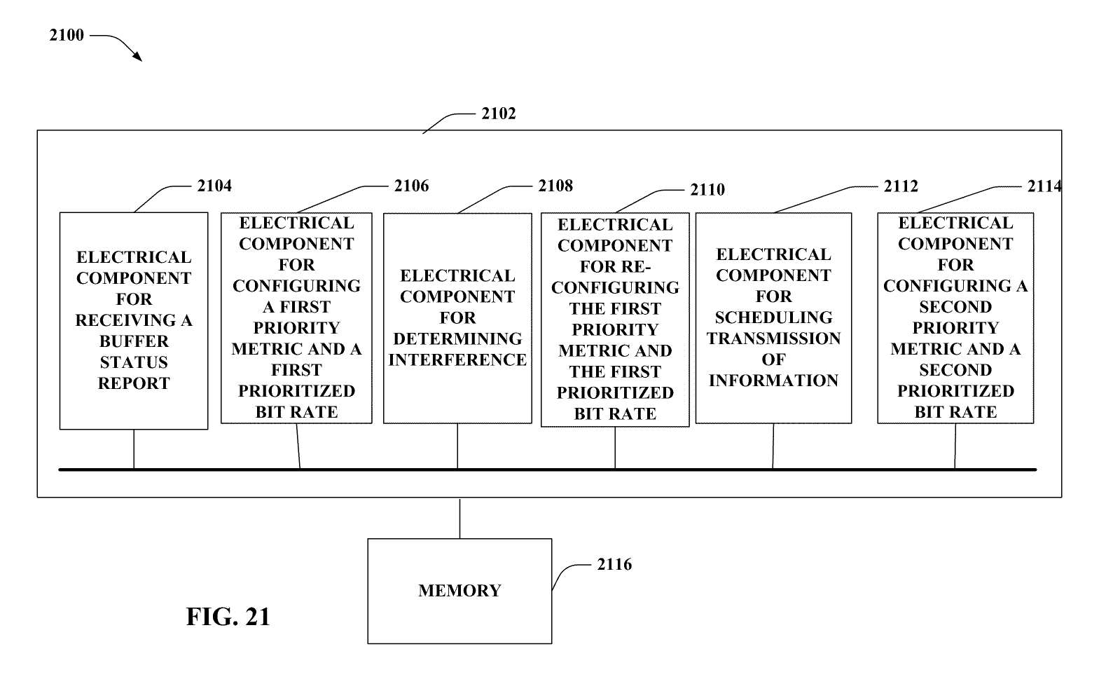

FIG. 21 is an illustration of a block diagram of an example system for facilitating interference management in accordance with various aspects set forth herein. It is to be appreciated that system 2100 is represented as including functional blocks, which can be functional blocks that represent functions implemented by a processor, hardware, software, firmware, or combination thereof. System 2100 can include a logical or physical grouping 2102 of electrical components for facilitating interference management.

The electrical components can act in conjunction. For instance, the logical or physical grouping 2102 can include an electrical component 2104 for receiving a buffer status report from UE having one or more logical channel groups. The logical or physical grouping 2102 can also include an electrical component 2106 for configuring a first priority metric and a first PBR for at least one of the one or more logical channel groups, wherein the configuring a first priority metric and a first PBR for at least one of the one or more logical channel groups is in response to information included in the buffer status report. The logical or physical grouping 2102 can also include an electrical component 2108 for determining interference at the UE. The logical or physical grouping 2102 can also include an electrical component 2110 for re-configuring the first priority metric and the first PBR for the at least one of the one or more logical channel groups in response to the determining interference at the UE.

The logical or physical grouping 2102 can also include an electrical component 2112 for scheduling transmission of information from the one or more logical channel groups such that an order of transmission from the one or more logical channel groups is in decreasing order of priorities.

The logical or physical grouping 2102 can also include an electrical component 2114 for configuring a second PBR and a second priority metric associated with a second one of the one or more logical channel groups.

The logical or physical grouping 2102 can also include an electrical component 2116 for storing. The electrical component 2116 for storing can be configured to store information indicative of interference, a first and second priority metric and/or a first and second PBR.

In some embodiments, configuring is performed via radio resource control signaling. In some embodiments, the means for scheduling transmission of information from the one or more logical channel groups such that an order of transmission from the one or more logical channel groups is in decreasing order of priorities.

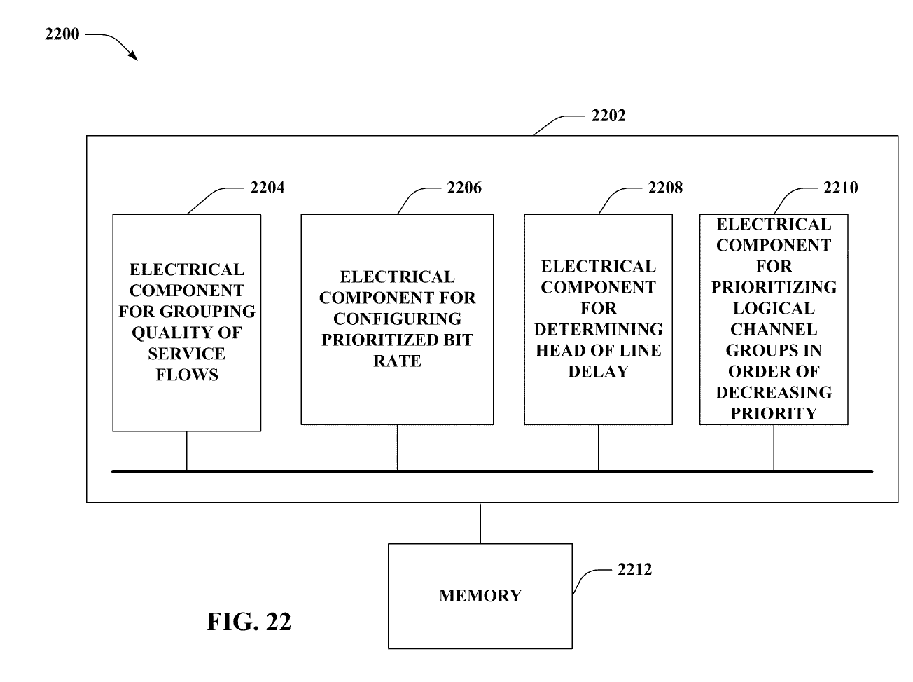

FIG. 22 is an illustration of a block diagram of an example system for facilitating interference management in accordance with various aspects set forth herein. It is to be appreciated that system 2200 is represented as including functional blocks, which can be functional blocks that represent functions implemented by a processor, hardware, software, firmware, or combination thereof. System 2200 can include a logical or physical grouping 2202 of electrical components for facilitating interference management.

The electrical components can act in conjunction. For instance, the logical or physical grouping 2202 can include an electrical component 2204 for grouping one or more quality of service flows at UE, wherein the grouping one or more quality of service flows at UE is based on a priority of traffic at the UE or a delay target of traffic at the UE. The logical or physical grouping 2202 can also include an electrical component 2206 for configuring PBR for one or more logical channel groups at the UE; an electrical component 2208 for determining head of line delay for the one or more logical channel groups at the UE. The logical or physical grouping 2102 can also include an electrical component 2210 for prioritizing the one or more logical channel groups at the UE in order of decreasing priority of the one or more logical channel groups.

The logical or physical grouping 2202 can also include an electrical component 2212 for storing. The electrical component 2112 for storing can be configured to store information indicative of one or more priorities, a head of line delay, an order of decreasing priority, a PBR and/or quality of service flows at a UE.

In some embodiments, determining the head of line delay for the one or more logical channel groups at the UE can include: determining the head of line delay for the one or more logical channel groups at the UE by estimating a number of bytes in the one or more logical channel groups at the UE, estimating a number of bytes scheduled for the UE through physical downlink control channel but which have not been decoded successfully at a serving BS or evaluating feedback from a radio link controller at the BS, wherein the feedback is indicative of a number of bytes successfully received from the one or more logical channel groups at the UE.

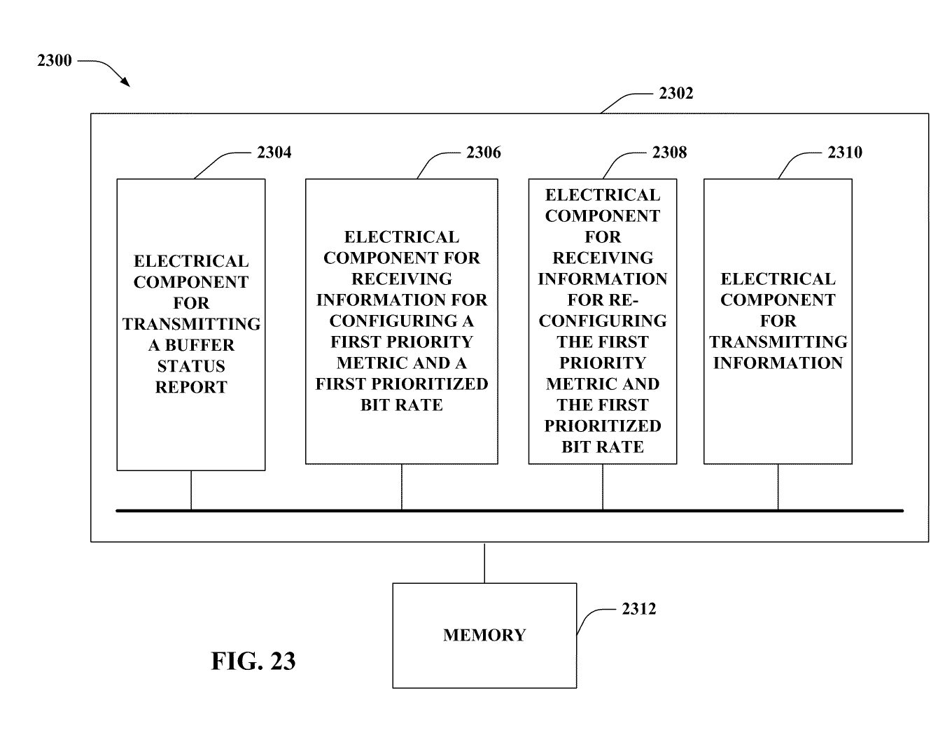

FIG. 23 is an illustration of a block diagram of an example system for facilitating interference management in accordance with various aspects set forth herein. It is to be appreciated that system 2300 is represented as including functional blocks, which can be functional blocks that represent functions implemented by a processor, hardware, software, firmware, or combination thereof. System 2300 can include a logical or physical grouping 2302 of electrical components for facilitating interference management.

The electrical components can act in conjunction. For instance, the logical or physical grouping 2302 can include an electrical component 2304 for transmitting a buffer status report from UE having one or more logical channel groups. The logical or physical grouping 2302 can also include an electrical component 2306 for receiving information for configuring a first priority metric and a first PBR for at least one of the one or more logical channel groups, wherein the configuring a first priority metric and a first PBR for at least one of the one or more logical channel groups is in response to information included in the buffer status report. The logical or physical grouping 2302 can also include an electrical component 2308 for receiving information for re-configuring the first priority metric and the first PBR for the at least one of the one or more logical channel groups in response to a serving BS for the UE having one or more logical channel groups determining interference at the UE having one or more logical channel groups.

The logical or physical grouping 2302 can also include an electrical component 2310 for transmitting information from the one or more logical channel groups such that an order of transmission from the one or more logical channel groups is in decreasing order of priorities. In some embodiments, configuring is performed via radio resource control signaling.

The logical or physical grouping 2302 can also include an electrical component 2312 for storing. The electrical component 2312 for storing can be configured to store information indicative of scheduling information, a buffer status report, one or more priorities, a priority metric and/or PBR.

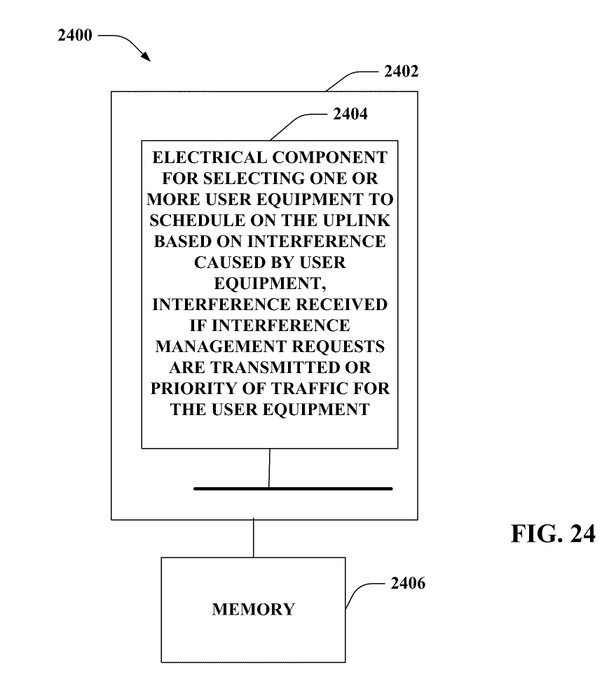

FIG. 24 is an illustration of a block diagram of an example system for facilitating interference management in accordance with various aspects set forth herein. It is to be appreciated that system 2400 is represented as including functional blocks, which can be functional blocks that represent functions implemented by a processor, hardware, software, firmware, or combination thereof. System 2400 can include a logical or physical grouping 2402 of electrical components for facilitating interference management.

The electrical components can act in conjunction. For instance, the logical or physical grouping 2402 can include an electrical component 2404 for selecting one or more UE of a first cell to schedule on the uplink, wherein the selecting is based on one or more of: interference caused by the one or more UE of the first cell to one or more BSs of a second cell, interference received if interference management requests for the one or more UE of the first cell are transmitted or a priority of traffic for the one or more UE of the first cell.

The logical or physical grouping 2402 can also include an electrical component 2406 for storing. The electrical component 2406 for storing can be configured to store information indicative of interference and/or priority of traffic.

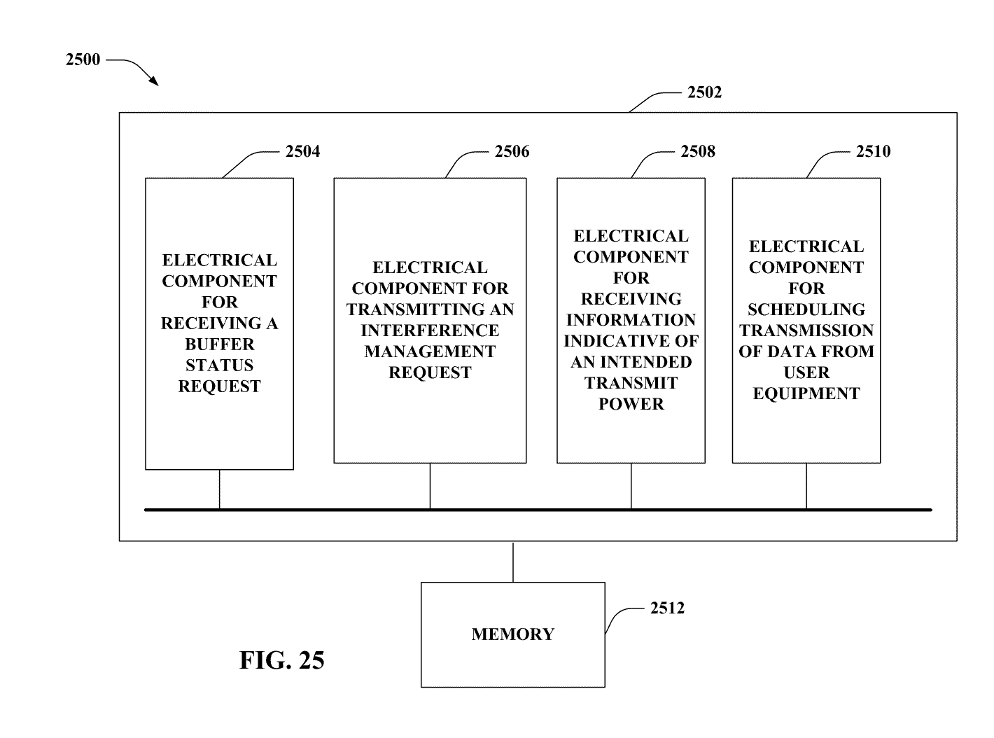

FIG. 25 is an illustration of a block diagram of an example system for facilitating interference management in accordance with various aspects set forth herein. It is to be appreciated that system 2500 is represented as including functional blocks, which can be functional blocks that represent functions implemented by a processor, hardware, software, firmware, or combination thereof. System 2500 can include a logical or physical grouping 2502 of electrical components for facilitating interference management.

The electrical components can act in conjunction. For instance, the logical or physical grouping 2502 can include an electrical component 2504 for receiving a buffer status request. The logical or physical grouping 2502 can also include an electrical component 2506 for transmitting an interference management request. The interference management request can be based on the buffer status request.

In some embodiments, transmitting the interference management request includes transmitting the interference management request over-the-air to out-of-cell UE. In some embodiments, transmitting the interference management request includes transmitting the interference management request over a backhaul to a BS in a second cell. In some embodiments, the interference management request is a RUM.

The logical or physical grouping 2502 can also include an electrical component 2508 for receiving information indicative of intended transmit power from one or more of the out-of-cell UE in response to the one or more out-of-cell UE receiving the interference management request.

The logical or physical grouping 2502 can also include an electrical component 2510 scheduling transmission of data from UE in the first cell.

The logical or physical grouping 2502 can also include an electrical component 2512 for storing. The electrical component 2502 for storing can be configured to store information indicative of interference, scheduling information and/or a buffer status request.

In some embodiments, the scheduling can be based on the information indicative of intended transmit power. In some embodiments, the scheduling can be based on a determined priority of traffic intended for the UE in the first cell. In some embodiments, the scheduling can be based on interference information associated with the UE in the first cell.

In some embodiments, the interference information can include interference incident on resources assigned to the UE in the first cell or interference the UE in the first cell causes to a BS in a second cell.

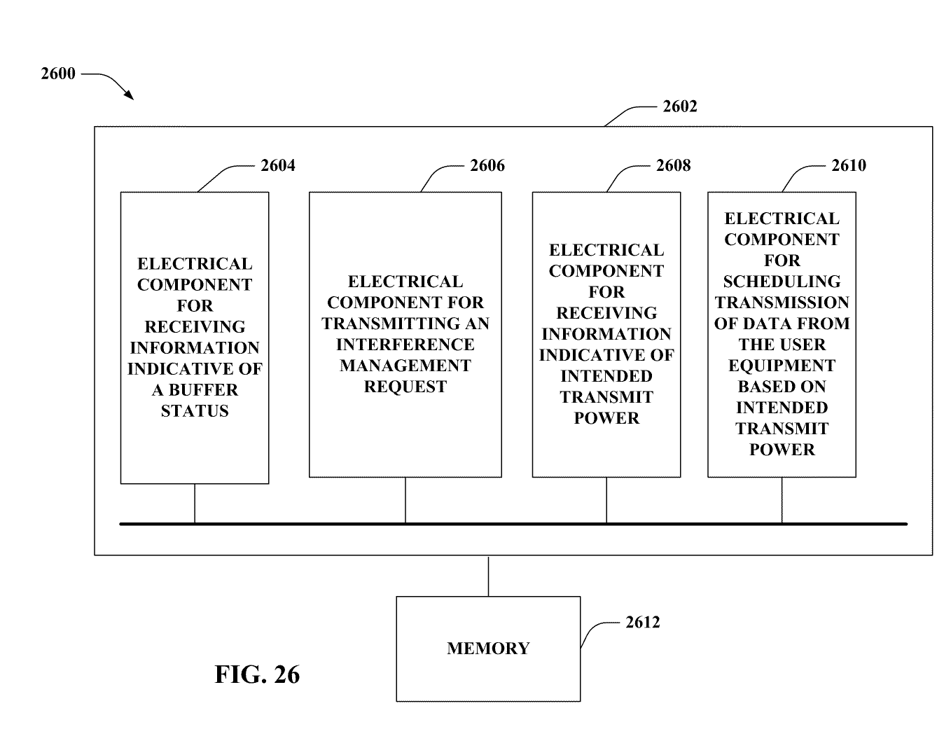

FIG. 26 is an illustration of a block diagram of an example system for facilitating interference management in accordance with various aspects set forth herein. It is to be appreciated that system 2600 is represented as including functional blocks, which can be functional blocks that represent functions implemented by a processor, hardware, software, firmware, or combination thereof. System 2600 can include a logical or physical grouping 2602 of electrical components for facilitating interference management.

The electrical components can act in conjunction. For instance, the logical or physical grouping 2602 can include an electrical component 2604 for receiving information indicative of a buffer status for one or more logical channel groups at a UE. The logical or physical grouping 2602 can also include an electrical component 2606 for transmitting an interference management request to one or more out-of-cell UE. The logical or physical grouping 2602 can also include an electrical component 2608 for receiving information indicative of intended transmit power from one or more of the out-of-cell UE in response to the one or more out-of-cell UE receiving the interference management request. The logical or physical grouping 2602 can also include an electrical component 2610 for scheduling transmission of data from the UE in the cell, wherein the scheduling is based on the information indicative of intended transmit power.

In some embodiments, scheduling transmission of data from the UE in the cell is based on a determined priority of traffic intended for the UE in the cell. In some embodiments, scheduling transmission of data from the UE in the cell is based on interference information associated with the UE in the cell.

In some embodiments, the interference information can include interference incident on resources assigned to the UE in the cell or interference the UE in the cell causes to an out-of-cell BS.

The logical or physical grouping 2602 can also include an electrical component 2612 for storing. The electrical component 2612 for storing can be configured to store information indicative of a buffer status, interference management requests, intended transmit powers and/or scheduling information.

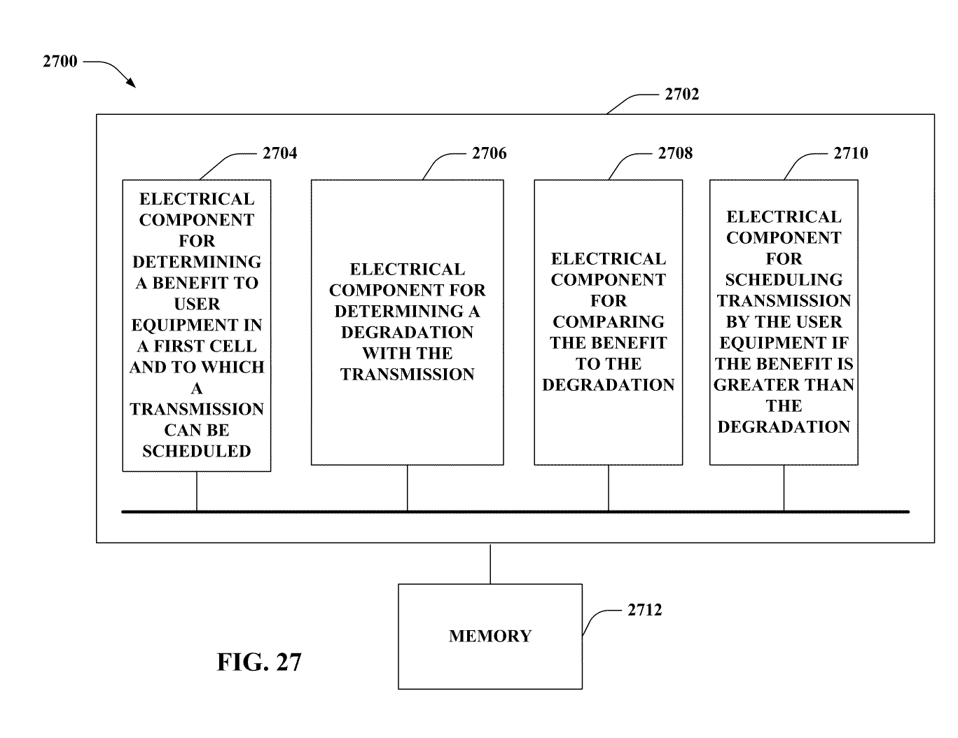

FIG. 27 is an illustration of a block diagram of an example system for facilitating interference management in accordance with various aspects set forth herein. It is to be appreciated that system 2700 is represented as including functional blocks, which can be functional blocks that represent functions implemented by a processor, hardware, software, firmware, or combination thereof. System 2700 can include a logical or physical grouping 2702 of electrical components for facilitating interference management.

The electrical components can act in conjunction. For instance, the logical or physical grouping 2702 can include an electrical component 2704 for determining a benefit to a UE in a first cell and to which a transmission can be scheduled. The logical or physical grouping 2702 can also include an electrical component 2706 for determining a degradation with the transmission. The degradation can be to a UE in a second cell. The second cell can be different from the first cell. The degradation can result from interference at the BS in the second cell and can be caused by the UE in the first cell.

The logical or physical grouping 2702 can also include an electrical component 2708 for comparing the benefit to the degradation. The logical or physical grouping 2702 can also include an electrical component 2710 for scheduling transmission by the UE in the first cell if the benefit to the UE in the first cell is greater than the degradation to the UE in the second cell.

The logical or physical grouping 2702 can also include an electrical component 2712 for storing. The electrical component 2702 for storing can be configured to store information indicative of scheduling information, a benefit and/or degradation to a UE and/or a comparison of the benefit and the degradation.

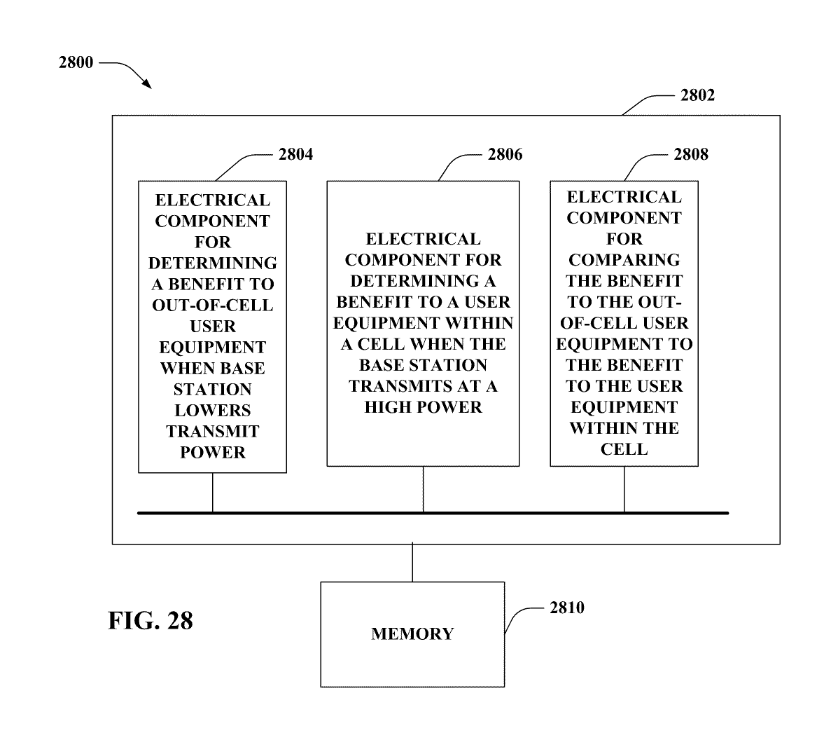

FIG. 28 is an illustration of a block diagram of an example system for facilitating interference management in accordance with various aspects set forth herein. It is to be appreciated that system 2800 is represented as including functional blocks, which can be functional blocks that represent functions implemented by a processor, hardware, software, firmware, or combination thereof. System 2800 can include a logical or physical grouping 2802 of electrical components for facilitating interference management.

The electrical components can act in conjunction. For instance, the logical or physical grouping 2802 can include an electrical component 2804 for determining a benefit to out-of-cell UE when a BS lowers a transmit power of the BS.

The logical or physical grouping 2802 can also include an electrical component 2806 for determining a benefit to a UE within a cell when the BS transmits at a high power.

The logical or physical grouping 2802 can also include an electrical component 2808 for comparing the benefit to the out-of-cell UE to the benefit to the UE within a cell.

The logical or physical grouping 2802 can also include an electrical component 2810 for storing. The electrical component 2802 for storing can be configured to store information indicative of a benefit to an out-of-cell UE, a benefit to a UE within a cell and/or a comparison of the benefits.

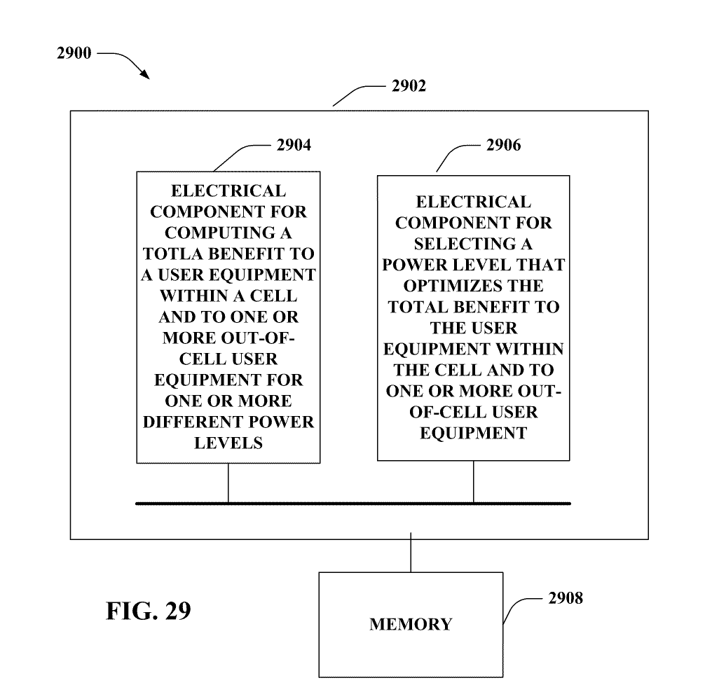

FIG. 29 is an illustration of a block diagram of an example system for facilitating interference management in accordance with various aspects set forth herein. It is to be appreciated that system 2900 is represented as including functional blocks, which can be functional blocks that represent functions implemented by a processor, hardware, software, firmware, or combination thereof. System 2900 can include a logical or physical grouping 2902 of electrical components for facilitating interference management.

The electrical components can act in conjunction. For instance, the logical or physical grouping 2902 can include an electrical component 2904 for computing a total benefit to a UE within a cell and to one or more out-of-cell UE for one or more different power levels.

The logical or physical grouping 2902 can also include an electrical component 2906 for selecting a power level that optimizes the total benefit to the UE within the cell and to the one or more out-of-cell UE.

The logical or physical grouping 2902 can also include an electrical component 2908 for storing. The electrical component 2902 for storing can be configured to store information indicative of the total benefit to a UE within a cell and to one or more out-of-cell UE for one or more different power levels, and/or a power level that optimizes the total benefit to the UE within the cell and to the one or more out-of-cell UE.

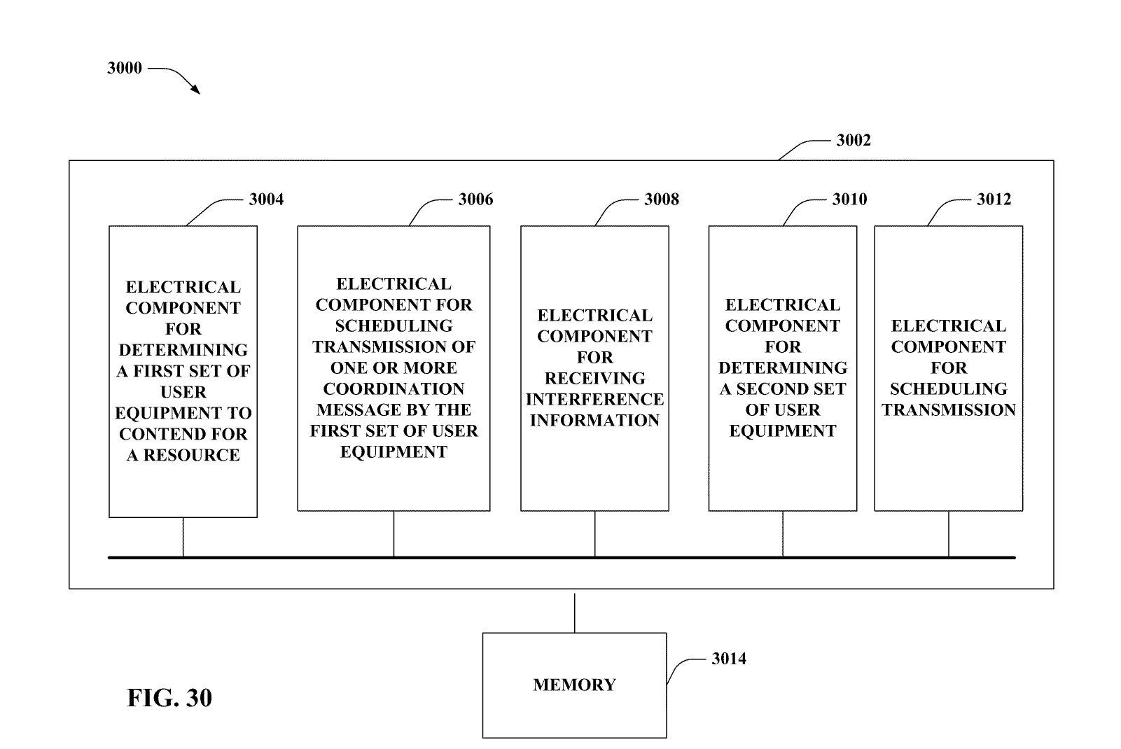

FIG. 30 is an illustration of a block diagram of an example system for facilitating interference management in accordance with various aspects set forth herein. It is to be appreciated that system 3000 is represented as including functional blocks, which can be functional blocks that represent functions implemented by a processor, hardware, software, firmware, or combination thereof. System 3000 can include a logical or physical grouping 3002 of electrical components for facilitating interference management.

The electrical components can act in conjunction. For instance, the logical or physical grouping 3002 can include an electrical component 3004 for determining a first set of UE to contend for a resource.

In some embodiments, determining the first set of UE to contend for a resource comprises determining at least one of: determining a buffer state for the one or more UE in a cell, determining an effective channel quality indicator for the one or more UE in a cell or determining channel gain information between the one or more UE and one or more BSs.

In some embodiments, determining the first set of UE to contend for a resource comprises determining one or more UE in a cell that will benefit at a level that is greater than a level of benefit associated with one or more other UE in the cell.

In some embodiments, determining the first set of UE to contend for a resource comprises determining a priority of traffic associated with one or more UE in a cell, wherein the determining a priority of traffic associated with one or more UE in the a comprises: determining a traffic type associated with the one or more UE in the cell; determining a buffer state for the one or more UE in a cell; mapping the one or more parameters associated with the one or more UE in the cell to a priority metric for one or more flows of traffic associated with the one or more UE in the cell; and selecting as the first set of UE to contend for a resource a plurality of the one or more UE in the cell having a priority metric greater than a selected threshold.

In some embodiments, the buffer state for the one or more UE in the cell is based on one or more parameters associated with the one or more UE in the cell, wherein the one or more parameters include a head-of-line delay for the UE in the cell, packet delay for the UE in the cell, queue length for the UE in the cell, packet sizes for the UE in the cell or the average rate at which the queue for the UE in the cell has been served in the past.

In some embodiments, determining the first set of UE to contend for a resource comprises determining a priority of traffic associated with one or more UE in a cell, wherein the determining a priority of traffic associated with one or more UE in a cell comprises: determining a traffic type associated with the one or more UE in a cell; determining a buffer state for the one or more UE in a cell; mapping the one or more parameters associated with the one or more UE in the cell to a priority metric for one or more flows of traffic associated with the one or more UE in the cell; and selecting as the first set of UE to contend for a resource a plurality of the one or more UE in the cell having a priority metric greater than a priority metric for a second set of the one or more UE in the cell. In some embodiments, the buffer state for the one or more UE in the cell is based on one or more parameters associated with the one or more UE in the cell, wherein the one or more parameters include a head-of-line delay for the UE in the cell, packet delay for the UE in the cell, queue length for the UE in the cell, packet sizes for the UE in the cell or the average rate at which the queue for the UE in the cell has been served in the past.

In some embodiments, the buffer state is for one or more logical channels of the one or more UE in the cell.

In some embodiments, determining the first set of UE to contend for a resource comprises determining a priority of traffic associated with one or more UE in a cell, wherein the determining a priority of traffic associated with one or more UE in a cell comprises: determining a traffic type associated with the one or more UE in a cell; determining a buffer state for the one or more UE in a cell, wherein the buffer state for the one or more UE in the cell is based on one or more parameters associated with the one or more UE in the cell, wherein the one or more parameters include a head-of-line delay for the UE in the cell, packet delay for the UE in the cell, queue length for the UE in the cell, packet sizes for the UE in the cell or the average rate at which the queue for the UE in the cell has been served in the past; mapping the one or more parameters associated with the one or more UE in the cell to a priority metric for one or more flows of traffic associated with the one or more UE in the cell; and selecting as the first set of UE to contend for a resource a plurality of the one or more UE in the cell, wherein the selecting is performed based on one or more of: an expected signal-to-interference noise ratio when no coordination message is transmitted, an expected signal-to-interference noise ratio when a coordination message is transmitted, a quality of service class identifier label or a buffer state, wherein the buffer state is indicated by one or more of a head of line delay, a packet delay, a packet size, a queue length, a queue size, an average rate, or an average rate at which the queue for the UE in the cell has been served in the past.

In some embodiments, the expected signal-to-interference noise ratio when no coordination message is transmitted is obtained via a channel quality indicator report.

In some embodiments, the expected signal-to-interference noise ratio when a coordination message is transmitted is obtained via determining the interference received at one or more different BSs based on measurement reports.

In some embodiments, the buffer state is for one or more logical channels of the one or more UE in the cell.

In some embodiments, determining the first set of UE to contend for a resource comprises determining an amount of interference a UE of the first set of UE is likely to see if a coordination message for the UE is transmitted to a BS in a neighboring cell.

In some embodiments, determining the first set of UE to contend for a resource comprises: determining if a benefit to the UE of the first set of UE is greater than a selected threshold; and selecting the UE of the first set of UE if the benefit is greater than the selected threshold.

In some embodiments, determining the first set of UE to contend for a resource comprises: determining if a benefit to the UE of the first set of UE is greater than a benefit to a second set of UE; and selecting the UE of the first set of UE if the benefit is greater than the second set of UE.

In some embodiments, one or more of the UE of the second set of UE is included in the first set of UE.

In some embodiments, the first set of UE includes a primary set and a secondary set, wherein the primary set includes ones of the first set of UE that are associated with a channel quality indicator or a traffic priority having first values and the secondary set includes ones of the first set of UE that are associated with a channel quality indicator or a traffic priority having second values, wherein the first values are greater than the second values, and wherein the second set of UE is the primary set.

The logical or physical grouping 3002 can also include an electrical component 3006 for scheduling transmission of one or more coordination messages by the first set of UE.

In some embodiments, one or more coordination messages are interference management requests that include information indicative of a request for a resource by the first set of UE to contend for a resource.

The logical or physical grouping 3002 can also include an electrical component 3008 for receiving interference information from at least one of the first set of UE to contend for a resource.

In some embodiments, the interference information from at least one of the first set of UE to contend for a resource includes at least one of an effective channel quality indicator or a transmit power level from the one or more BSs.

In some embodiments, the interference information from at least one of the first set of UE to contend for a resource includes information indicative of a backoff in transmission by the at least one of the one or more BSs.

The logical or physical grouping 3002 can also include an electrical component 3010 for determining a second set of UE to transmit information, a second set of UE to transmit information. In some embodiments, the determining a second set of UE to transmit information is in response to determining one or more of interference information, an interference commitment made for the BS to out-of-cell UE, a channel quality indicator or a traffic priority for at least one of the first set of UE to contend for a resource.

In some embodiments, determining the second set of UE to transmit data comprises selecting a plurality of UE having the predicted interference less than a selected threshold.

In some embodiments, determining the second set of UE to transmit data further comprises selecting a plurality of UE based on one or more of a traffic priority or a quality channel indicator.

The logical or physical grouping 3002 can also include an electrical component 3012 for scheduling transmission of the information by the second set of UE. In some embodiments, scheduling transmission of the information by the second set of UE comprises transmitting downlink transmission grants to the second set of UE to transmit information.

The logical or physical grouping 3002 can also include an electrical component 3014 for storing. The electrical component 3002 for storing can be configured to store information indicative of interference information, scheduling information and/or coordination messages.

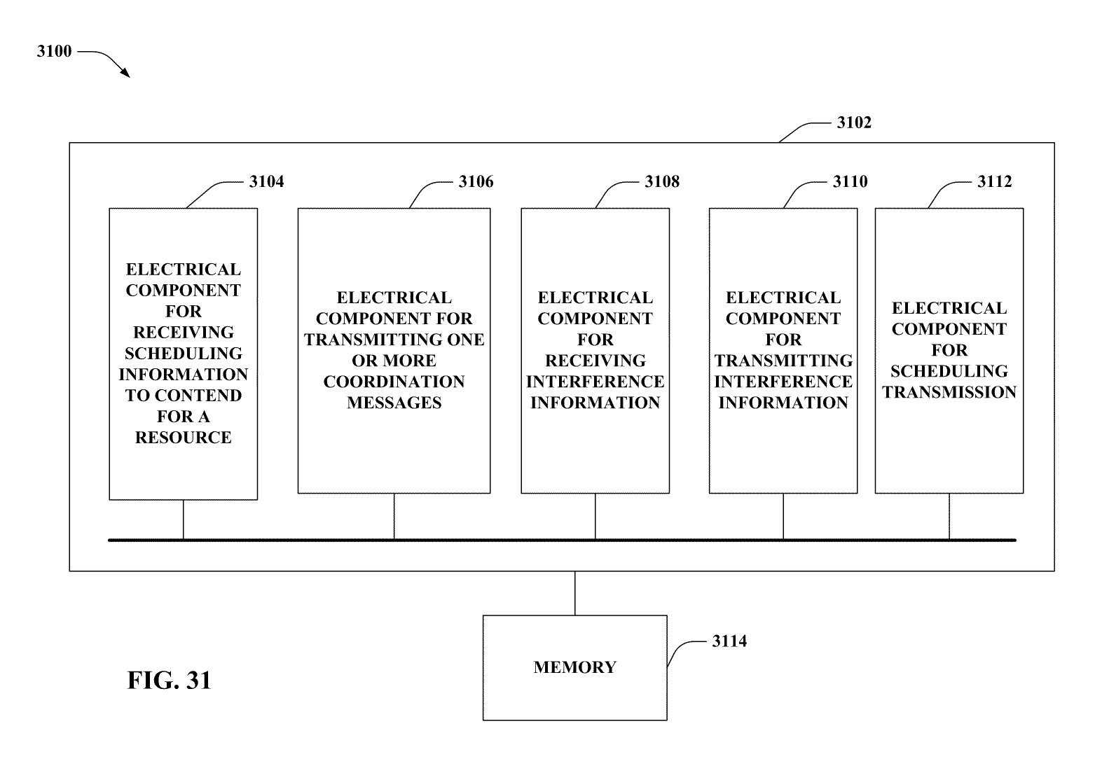

FIG. 31 is an illustration of a block diagram of an example system for facilitating interference management in accordance with various aspects set forth herein. It is to be appreciated that system 3100 is represented as including functional blocks, which can be functional blocks that represent functions implemented by a processor, hardware, software, firmware, or combination thereof. System 3100 can include a logical or physical grouping 3102 of electrical components for facilitating interference management.

The electrical components can act in conjunction. For instance, the logical or physical grouping 3102 can include an electrical component 3104 for receiving scheduling information to contend for a resource.

In some embodiments, scheduling information to contend for a resource is received at a UE in response to determining at least one of: whether the UE will benefit at a level that is greater than a selected threshold, determining a buffer state for one or more UE in a cell, determining an effective channel quality indicator for one or more UE in a cell or determining channel gain information between the one or more UE in a cell and one or more BSs.

In some embodiments, scheduling information to contend for a resource is received at the UE and not at another UE in response to determining that the UE will benefit at a level that is greater than a benefit to the another UE.

In some embodiments, scheduling information to contend for a resource is received at a UE in response to a determination that a priority of traffic at the UE is above a selected threshold, wherein the determination that the priority of traffic at the UE is above a selected threshold comprises: determining a traffic type associated with the UE; determining a buffer state for the UE, wherein the buffer state for the UE is based on one or more parameters associated with the UE; and mapping the one or more parameters associated with the UE to a priority metric for one or more flows of traffic associated with the UE.

In some embodiments, at least one of the one or more parameters associated with the UE is a head of line delay for traffic buffered for a logical channel for a UE at the BS.

In some embodiments, the head of line delay at the UE is computed based on at least one of: an amount of information to be transmitted from the UE, an amount of information to be scheduled for transmission to the UE over a selected number of past subframes or an amount of information received from a logical channel group at the UE.

The logical or physical grouping 3102 can also include an electrical component 3106 for transmitting one or more coordination messages to one or more BSs. In some embodiments, transmitting one or more coordination messages to one or more BSs is in response to receiving scheduling information to contend for a resource.

In some embodiments, one or more coordination messages to one or more BSs are interference management requests that include information indicative of a request for a resource.

In some embodiments, each of the one or more coordination messages includes one or more of a priority of traffic for a UE, a strength of a channel from the BS to the UE, a strength of a channel from a serving BS to the UE or an amount of interference that the UE desires to receive.

In some embodiments, the priority of traffic for the UE is based on one or more of the following: a quality of service characteristic, a quality of service class identifier label, an average rate at which the UE has been served in the past, a number of delays for the packets in the buffer awaiting transmission, head-of-line delay, buffer length in bytes or buffer length in number of packets.

The logical or physical grouping 3102 can also include an electrical component 3108 for receiving interference information from at least one of the one or more BSs.

In some embodiments, the interference information from at least one of the one or more BSs includes at least one of an effective channel quality indicator or a transmit power level from the one or more BSs.

In some embodiments, the interference information from at least one of the one or more BSs includes information indicative of a backoff in transmission by the at least one of the one or more BSs.

The logical or physical grouping 3102 can also include an electrical component 3110 for transmitting interference information to a serving BS for determination of a predicted interference from the at least one of the one or more BSs.

The logical or physical grouping 3102 can also include an electrical component 3112 for receiving scheduling information for transmission of information in response to the predicted interference being less than a selected threshold.

The logical or physical grouping 3102 can also include an electrical component 3114 for storing. The electrical component 3102 for storing can be configured to store information indicative of interference information, scheduling information and/or coordination messages.

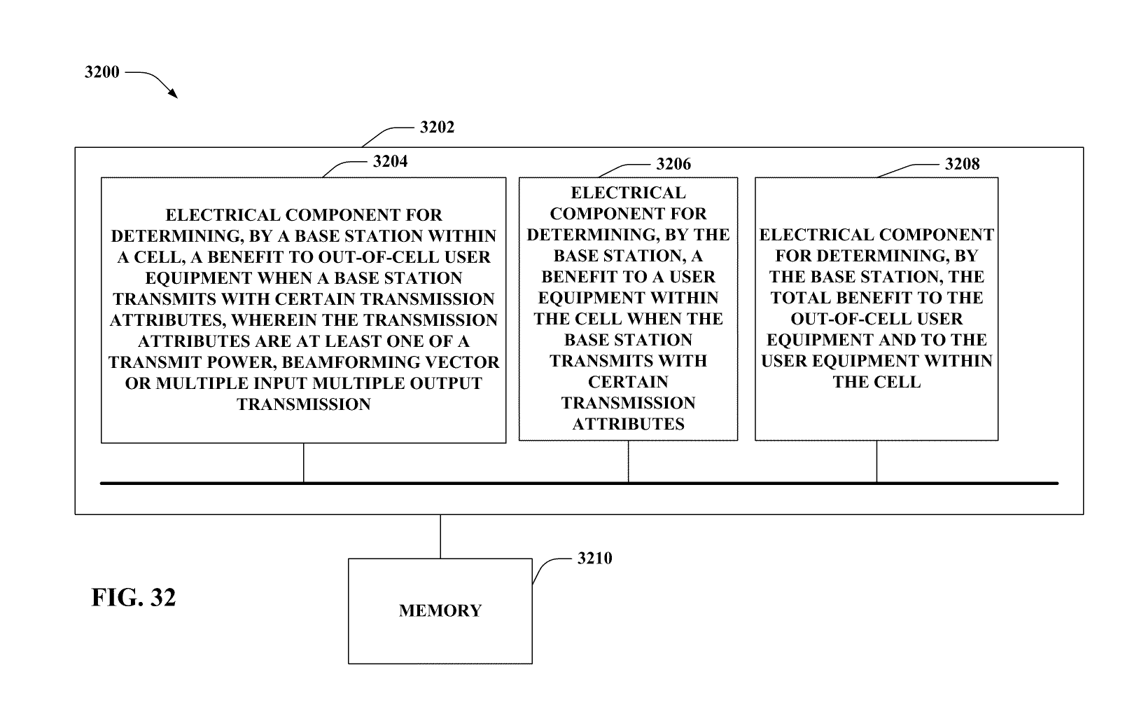

FIG. 32 is an illustration of a block diagram of an example system for facilitating interference management in accordance with various aspects set forth herein. It is to be appreciated that system 3200 is represented as including functional blocks, which can be functional blocks that represent functions implemented by a processor, hardware, software, firmware, or combination thereof. System 3200 can include a logical or physical grouping 3202 of electrical components for facilitating interference management.

The electrical components can act in conjunction. For instance, the logical or physical grouping 3202 can include an electrical component 3204 for determining, by a base station within a cell, a benefit to out-of-cell user equipment when a base station transmits with certain transmission attributes, wherein the transmission attributes are at least one of a transmit power, beamforming vector or multiple input multiple output transmission. The logical or physical grouping 3202 can also include an electrical component 3206 for determining, by the base station, a benefit to a user equipment within the cell when the base station transmits with certain transmission attributes.

The logical or physical grouping 3202 can also include an electrical component 3208 for determining, by the base station, the total benefit to the out-of-cell user equipment and to the user equipment within the cell.

The logical or physical grouping 3202 can also include an electrical component 3210 for storing. The electrical component 3210 for storing can be configured for storing transmission attributes, etc.

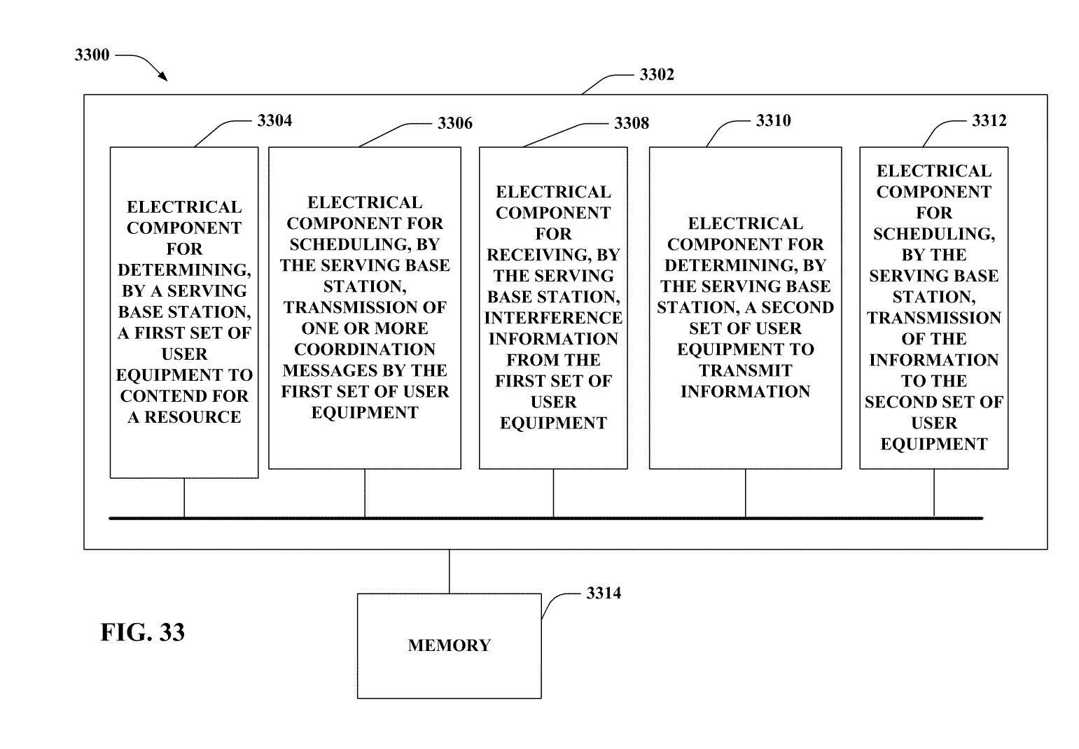

FIG. 33 is an illustration of a block diagram of an example system for facilitating interference management in accordance with various aspects set forth herein. It is to be appreciated that system 3300 is represented as including functional blocks, which can be functional blocks that represent functions implemented by a processor, hardware, software, firmware, or combination thereof. System 3300 can include a logical or physical grouping 3302 of electrical components for facilitating interference management.

The electrical components can act in conjunction. For instance, the logical or physical grouping 3302 can include an electrical component 3304 for determining, by a serving base station, a first set of user equipment to contend for a resource. The logical or physical grouping 3302 can also include an electrical component 3306 for scheduling, by the serving base station, transmission of one or more coordination messages by the first set of user equipment.

The logical or physical grouping 3302 can also include an electrical component 3308 for receiving, by the serving base station, interference information from the first set of user equipment. The logical or physical grouping 3302 can also include an electrical component 3310 for determining, by the serving base station, a second set of user equipment to transmit information.

The logical or physical grouping 3302 can also include an electrical component 3312 for scheduling, by the serving base station, transmission of the information to the second set of user equipment.

The logical or physical grouping 3302 can also include an electrical component 3314 for storing information, interference information, and/or coordination messages.

In some embodiments, one or more of the user equipment of the second set of user equipment is included in the first set of user equipment. The first set of user equipment can include a primary set and a secondary set, wherein the primary set includes ones of the first set of user equipment having at least one of: a signal-to-interference and noise ratio determined from a channel quality indicator estimated with an interference base station lowering power, a signal-to-interference and noise ratio determined from a channel quality indicator estimated without an interference base station lowering power, a traffic priority or a benefit to the user equipment.

In some embodiments, one or more coordination messages are interference management requests that include information indicative of a request to contend for a resource by the first set of user equipment.

In some embodiments, interference information from at least one of the first set of user equipment to contend for a resource includes at least one of transmit power level from one of more base-stations, information indicative of a backoff in transmission by at least one of one or more base stations, or information indicative of signal-to-interference and noise ratio or channel quality indicator determined from a power of one or more pilots.

In some embodiments, scheduling transmission of the information to the second set of user equipment comprises transmitting downlink transmission grants to the second set of user equipment to transmit information.

In some embodiments, determining the second set of user equipment to transmit data further comprises selecting a plurality of user equipment based on at least one of: a traffic priority, a signal-to-interference and noise ratio computed at a user equipment as a result of measuring interference based on at least one of pilots signaled by an interference base station in response to a coordination message received from the user equipment or a signal-to-interference and noise ratio computed based on pilots used to compute a channel quality indicator.

In some embodiments, determining the second set of user equipment to transmit data comprises selecting a plurality of user equipment having a predicted interference less than a selected threshold or a signal-to-interference and noise ratio being more than a selected threshold. In some embodiments, determining the first set of user equipment to contend for a resource comprises determining one or more user equipment in a cell that will benefit at a level that is greater than a level of benefit associated with one or more other user equipment in the cell. In some embodiments, determining the first set of user equipment to contend for a resource comprises determining an amount of interference a user equipment of the first set of user equipment is likely to see if a coordination message for the user equipment is transmitted to a base station in a neighboring cell.

In some embodiments, determining the first set of user equipment to contend for a resource comprises: determining if a benefit to the user equipment of the first set of user equipment is greater than a selected threshold; and selecting the user equipment of the first set of user equipment if the benefit is greater than the selected threshold.

In some embodiments, determining the first set of user equipment to contend for a resource comprises: determining if a benefit to the user equipment of the first set of user equipment is greater than a benefit to a second set of user equipment; and selecting the user equipment of the first set of user equipment if the benefit is greater than the second set of user equipment.

In some embodiments, determining the first set of user equipment to contend for a resource comprises determining a priority of traffic associated with one or more user equipment in a cell, wherein the determining a priority of traffic associated with one or more user equipment in a cell comprises: determining a traffic type associated with the one or more user equipment in a cell; determining a buffer state for the one or more user equipment in a cell, wherein the buffer state for the one or more user equipment in the cell is based on one or more parameters associated with the one or more user equipment in the cell, wherein the one or more parameters include a head-of-line delay for the user equipment in a cell, packet delay for the user equipment in a cell, queue length for the user equipment in a cell, packet sizes for the user equipment in a cell or an average rate at which a queue for the user equipment in a cell has been served in the past; mapping the one or more parameters associated with the one or more user equipment in a cell to a priority metric for one or more flows of traffic associated with the one or more user equipment in a cell; and selecting as the first set of user equipment to contend for a resource.

In some embodiments, a priority of traffic is transmitted to the user equipment when a serving base station schedules the user equipment to transmit the one or more coordination messages.

In some embodiments, selecting is performed based on one or more of: a priority metric being greater than a priority metric for a second set of the one or more user equipment, an expected signal-to-interference and noise ratio when no coordination message is transmitted, an expected signal-to-interference and noise ratio when a coordination message is transmitted, a quality of service class identifier label or a buffer state, wherein the buffer state is indicated by one or more of a head of line delay, a packet delay, a packet size, a queue length, a queue size, an average rate or an average rate at which the queue for the user equipment in the cell has been served in the past.

In some embodiments, selecting as the first set of user equipment to contend for a resource comprises selecting a plurality of the one or more user equipment in the cell having a priority metric greater than a selected threshold. In some embodiments, the buffer state is for one or more logical channels of the one or more user equipment in the cell. In some embodiments, the expected signal-to-interference and noise ratio when no coordination message is transmitted is obtained via a channel quality indicator report.

In some embodiments, the expected signal-to-interference and noise ratio when a coordination message is transmitted is obtained via at least one of a history of past interference reported by the user equipment or one or more measurement reports from the user equipment to a base station.

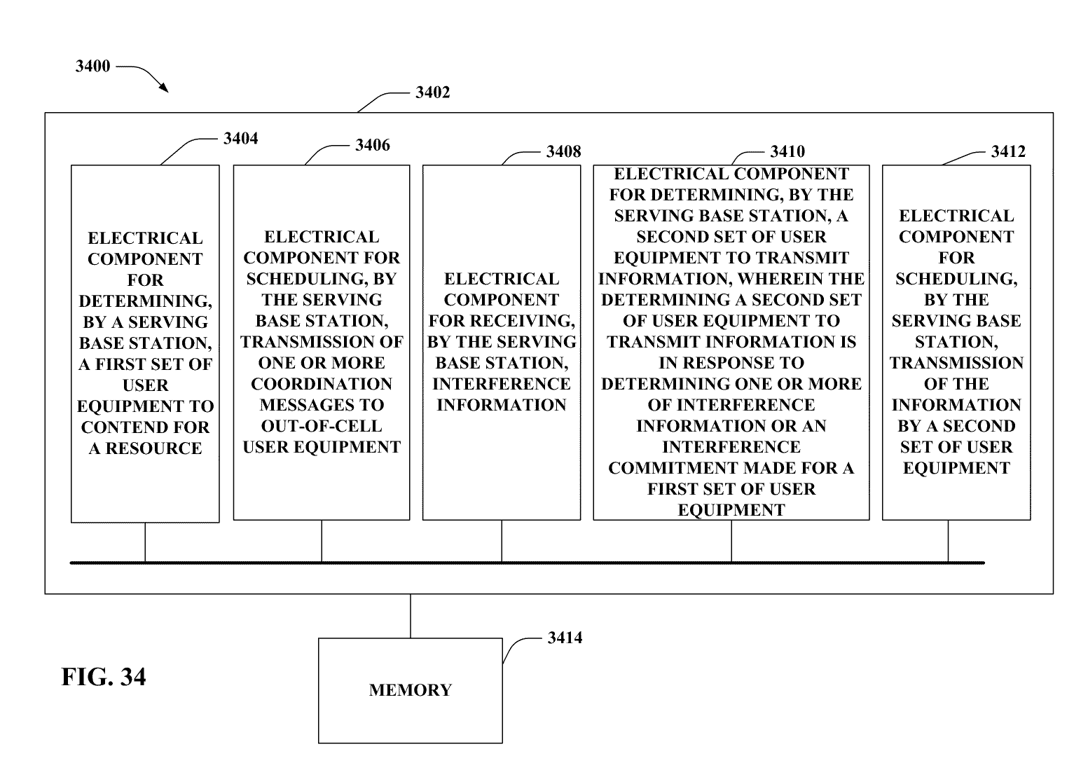

FIG. 34 is an illustration of a block diagram of an example system for facilitating interference management in accordance with various aspects set forth herein. It is to be appreciated that system 3400 is represented as including functional blocks, which can be functional blocks that represent functions implemented by a processor, hardware, software, firmware, or combination thereof. System 3400 can include a logical or physical grouping 3402 of electrical components for facilitating interference management.

The electrical components can act in conjunction. For instance, the logical or physical grouping 3402 can include an electrical component 3404 for determining, by a serving base station, a first set of user equipment to contend for a resource. The logical or physical grouping 3402 can include an electrical component 3406 for scheduling, by the serving base station, transmission of one or more coordination messages to out-of-cell user equipment.

The logical or physical grouping 3402 can include an electrical component 3408 for receiving, by the serving base station, interference information. The logical or physical grouping 3402 can include an electrical component 3410 for determining, by the serving base station, a second set of user equipment to transmit information, wherein the determining a second set of user equipment to transmit information is in response to determining one or more of interference information or an interference commitment made for a first set of user equipment.

The logical or physical grouping 3402 can include an electrical component 3412 for scheduling, by the serving base station, transmission of the information by a second set of user equipment. In some embodiments, one or more user equipment of the second set of user equipment is included in the first set of user equipment.

The logical or physical grouping 3402 can include an electrical component 3412 for storing.

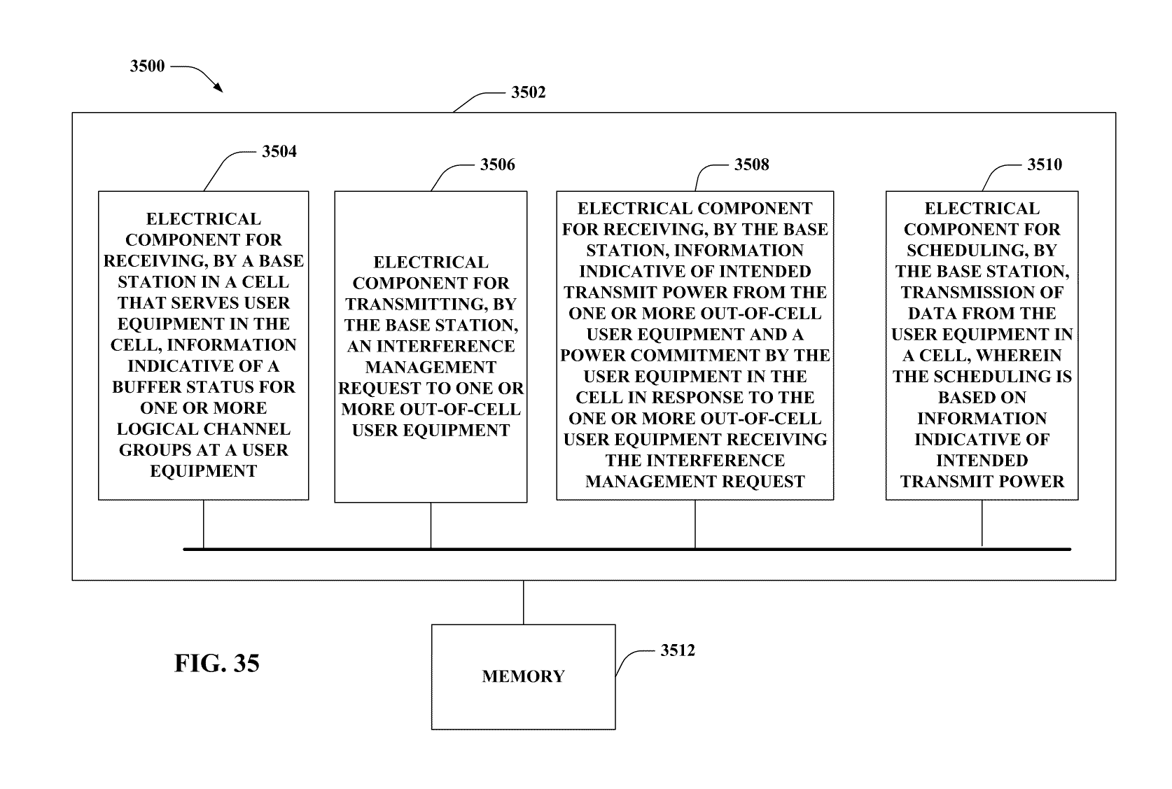

FIG. 35 is an illustration of a block diagram of an example system for facilitating interference management in accordance with various aspects set forth herein. It is to be appreciated that system 3500 is represented as including functional blocks, which can be functional blocks that represent functions implemented by a processor, hardware, software, firmware, or combination thereof. System 3500 can include a logical or physical grouping 3502 of electrical components for facilitating interference management.

The electrical components can act in conjunction. For instance, the logical or physical grouping 3502 can include an electrical component 3504 for receiving, by a base station in a cell that serves user equipment in the cell, information indicative of a buffer status for one or more logical channel groups at a user equipment.

The logical or physical grouping 3502 can include an electrical component 3506 for transmitting, by the base station, an interference management request to one or more out-of-cell user equipment.

The logical or physical grouping 3502 can include an electrical component 3508 for receiving, by the base station, information indicative of intended transmit power from the one or more out-of-cell user equipment and a power commitment by the user equipment in the cell in response to the one or more out-of-cell user equipment receiving the interference management request.

The logical or physical grouping 3502 can include an electrical component 3510 for scheduling, by the base station, transmission of data from the user equipment in a cell, wherein the scheduling is based on information indicative of intended transmit power.

The logical or physical grouping 3502 can include an electrical component 3512 for storing information indicative of intended transmit power, scheduling information, and/or interference management requests.

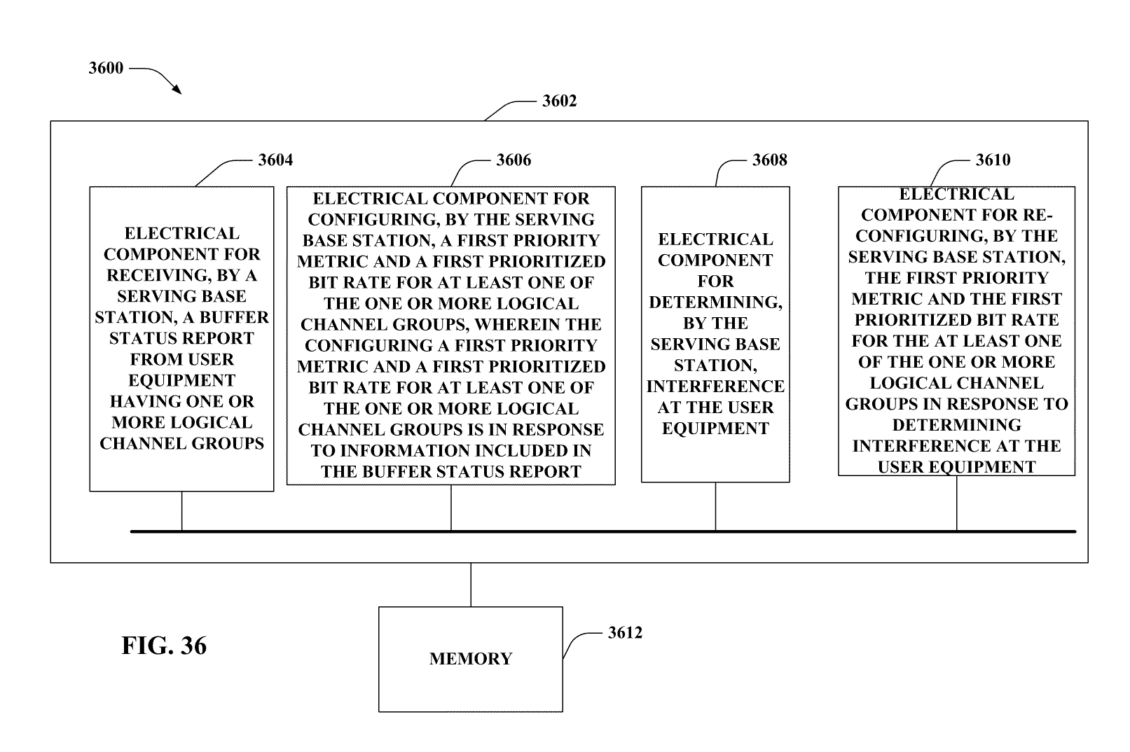

FIG. 36 is an illustration of a block diagram of an example system for facilitating interference management in accordance with various aspects set forth herein. It is to be appreciated that system 3600 is represented as including functional blocks, which can be functional blocks that represent functions implemented by a processor, hardware, software, firmware, or combination thereof. System 3600 can include a logical or physical grouping 3602 of electrical components for facilitating interference management.

The electrical components can act in conjunction. For instance, the logical or physical grouping 3602 can include an electrical component 3604 for receiving, by a serving base station, a buffer status report from user equipment having one or more logical channel groups.

The logical or physical grouping 3602 can include an electrical component 3606 for configuring, by the serving base station, a first priority metric and a first prioritized bit rate for at least one of the one or more logical channel groups, wherein the configuring a first priority metric and a first prioritized bit rate for at least one of the one or more logical channel groups is in response to information included in the buffer status report.

The logical or physical grouping 3602 can include an electrical component 3608 for determining, by the serving base station, interference at the user equipment. The logical or physical grouping 3602 can include an electrical component 3610 for re-configuring, by the serving base station, the first priority metric and the first prioritized bit rate for the at least one of the one or more logical channel groups in response to determining interference at the user equipment.

The logical or physical grouping 3602 can include an electrical component 3612 for storing priority metrics, prioritized bit rates, logical channel group information, and/or buffer status reports.

In some embodiments, the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group. In some embodiments, configuring the first prioritized bit rate is performed via radio resource control signaling.

In some embodiments, the first priority metric or the second priority metric is based on one or more of: a priority of a logical channel group, an estimated head of line delay, an estimated queue length, an estimated packet delay, an estimated packet size, an estimated average rate at which a queue has been served in the past.

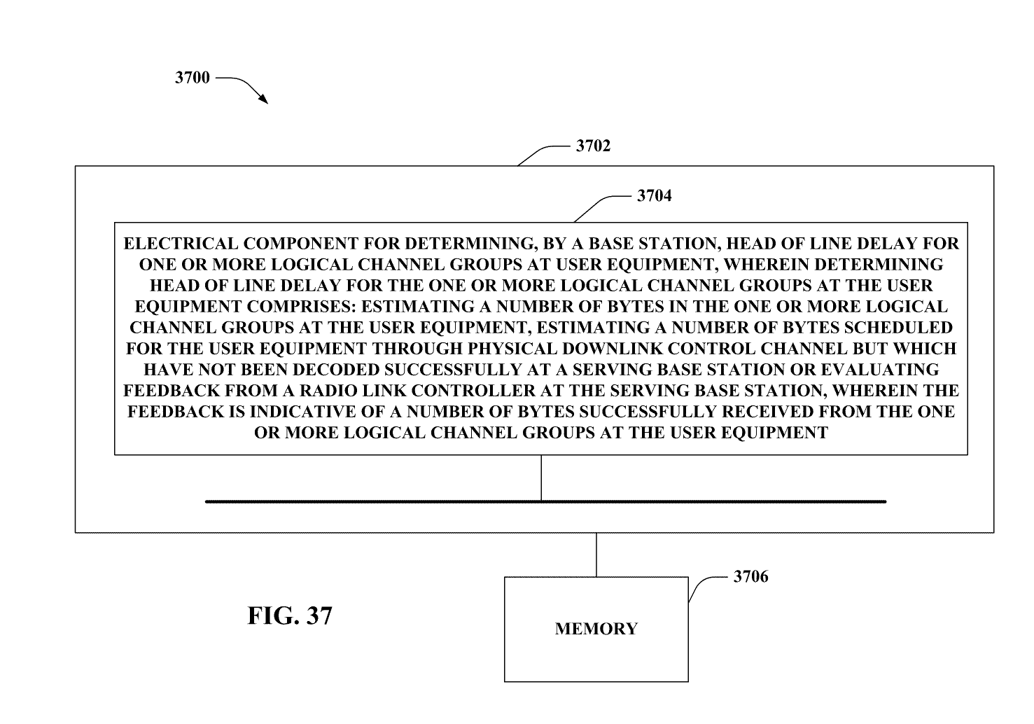

FIG. 37 is an illustration of a block diagram of an example system for facilitating interference management in accordance with various aspects set forth herein. It is to be appreciated that system 3700 is represented as including functional blocks, which can be functional blocks that represent functions implemented by a processor, hardware, software, firmware, or combination thereof. System 3700 can include a logical or physical grouping 3702 of electrical components for facilitating interference management.

The electrical components can act in conjunction. For instance, the logical or physical grouping 3702 can include an electrical component 3704 for determining, by a base station, head of line delay for one or more logical channel groups at user equipment, wherein determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

The logical or physical grouping 3702 can include an electrical component 3706 for storing head of line delay, logical channel group information, bytes in the logical channel group, scheduling information, feedback information and/or radio link information.

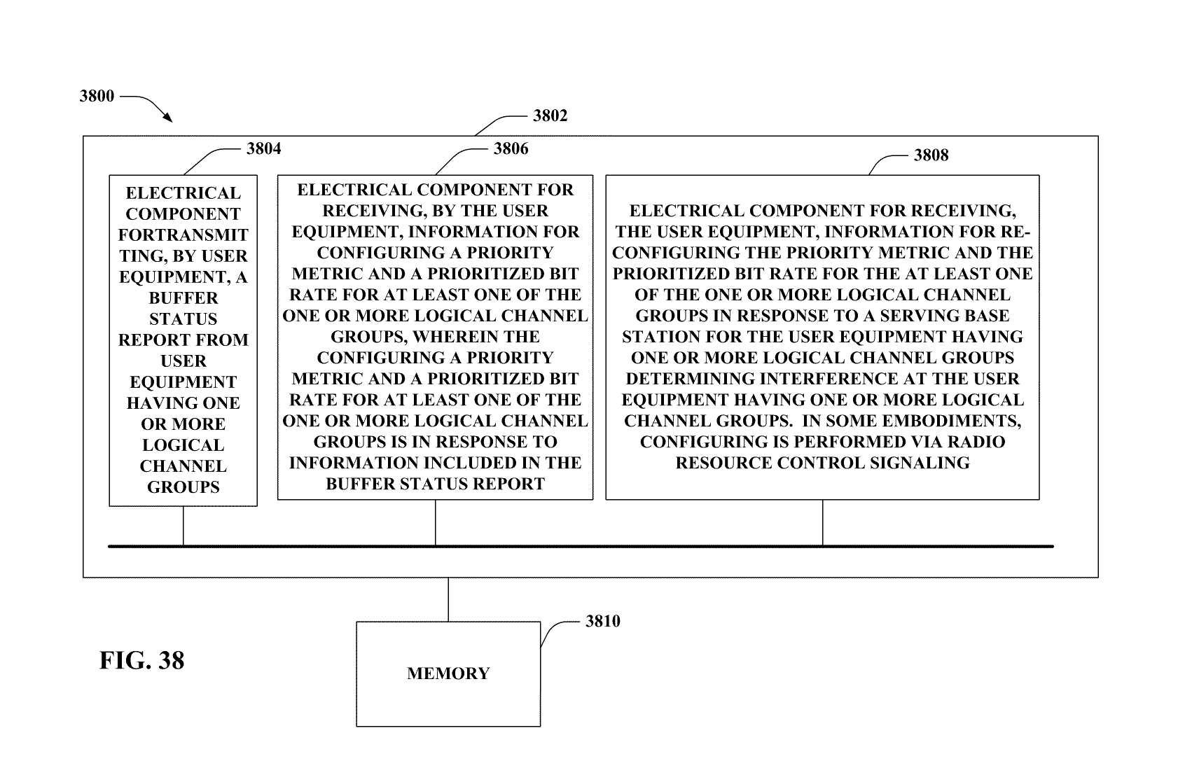

FIG. 38 is an illustration of a block diagram of an example system for facilitating interference management in accordance with various aspects set forth herein. It is to be appreciated that system 3800 is represented as including functional blocks, which can be functional blocks that represent functions implemented by a processor, hardware, software, firmware, or combination thereof. System 3800 can include a logical or physical grouping 3802 of electrical components for facilitating interference management.

The electrical components can act in conjunction. For instance, the logical or physical grouping 3802 can include an electrical component 3804 for transmitting, by user equipment, a buffer status report from user equipment having one or more logical channel groups.

The logical or physical grouping 3802 can include an electrical component 3806 for receiving, by the user equipment, information for configuring a priority metric and a prioritized bit rate for at least one of the one or more logical channel groups, wherein the configuring a priority metric and a prioritized bit rate for at least one of the one or more logical channel groups is in response to information included in the buffer status report.

The logical or physical grouping 3802 can include an electrical component 3808 for receiving, the user equipment, information for re-configuring the priority metric and the prioritized bit rate for the at least one of the one or more logical channel groups in response to a serving base station for the user equipment having one or more logical channel groups determining interference at the user equipment having one or more logical channel groups. In some embodiments, configuring is performed via radio resource control signaling.

The logical or physical grouping 3802 can include an electrical component 3810 for storing priority metric, prioritized bit rates, logical channel group information, interference information and/or radio resource control signaling information.

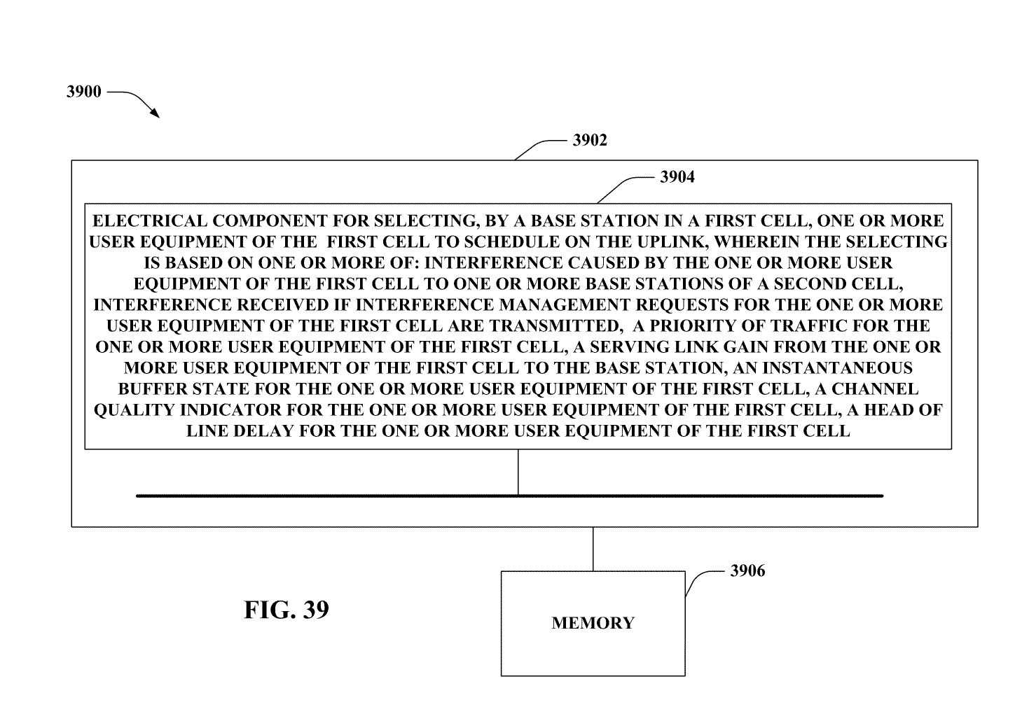

FIG. 39 is an illustration of a block diagram of an example system for facilitating interference management in accordance with various aspects set forth herein. It is to be appreciated that system 3900 is represented as including functional blocks, which can be functional blocks that represent functions implemented by a processor, hardware, software, firmware, or combination thereof. System 3900 can include a logical or physical grouping 3902 of electrical components for facilitating interference management.

The electrical components can act in conjunction. For instance, the logical or physical grouping 3902 can include an electrical component 3904 for selecting, by a base station in a first cell, one or more user equipment of the first cell to schedule on the uplink, wherein the selecting is based on one or more of: interference caused by the one or more user equipment of the first cell to one or more base stations of a second cell, interference received if interference management requests for the one or more user equipment of the first cell are transmitted, a priority of traffic for the one or more user equipment of the first cell, a serving link gain from the one or more user equipment of the first cell to the base station, an instantaneous buffer state for the one or more user equipment of the first cell, a channel quality indicator for the one or more user equipment of the first cell, a head of line delay for the one or more user equipment of the first cell.

The logical or physical grouping 3902 can include an electrical component 3906 for storing interference, priority of traffic, instantaneous buffer state, channel quality indicator information, serving link gain information and/or head of line delay information.

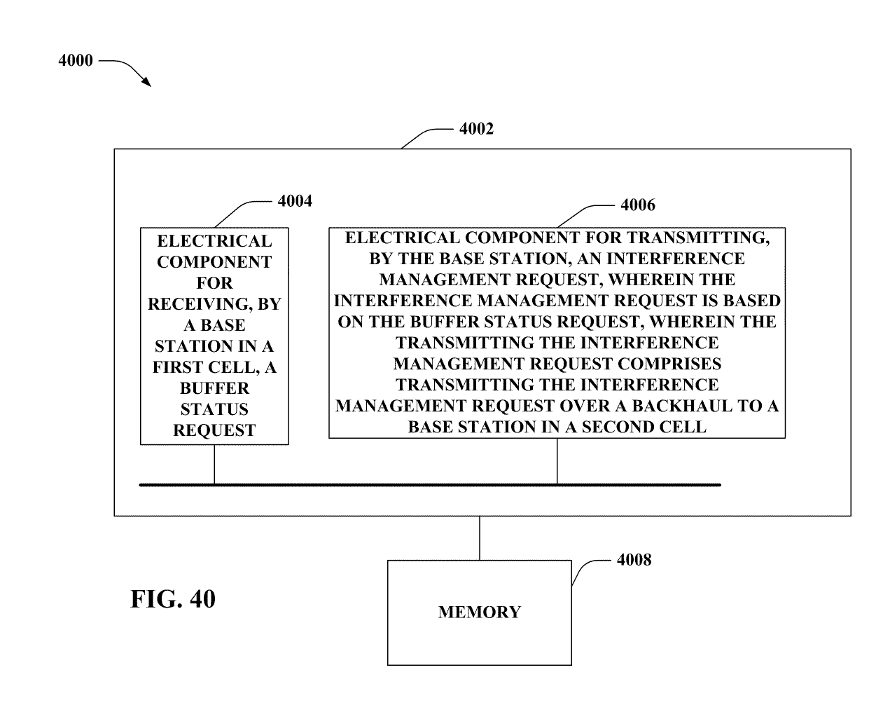

FIG. 40 is an illustration of a block diagram of an example system for facilitating interference management in accordance with various aspects set forth herein. It is to be appreciated that system 4000 is represented as including functional blocks, which can be functional blocks that represent functions implemented by a processor, hardware, software, firmware, or combination thereof. System 4000 can include a logical or physical grouping 4002 of electrical components for facilitating interference management.

The electrical components can act in conjunction. For instance, the logical or physical grouping 4002 can include an electrical component 4004 for receiving, by a base station in a first cell, a buffer status request. The logical or physical grouping 4002 can include an electrical component 4006 for transmitting, by the base station, an interference management request, wherein the interference management request is based on the buffer status request, wherein the transmitting the interference management request comprises transmitting the interference management request over a backhaul to a base station in a second cell.

The logical or physical grouping 4002 can include an electrical component 4008 for storing interference management request information, buffer status request information, and/or backhaul information.

Further to the descriptions of the apparatus provided with reference to FIGS. 5A and 5B, embodiments of apparatus can be configured to include modules configured to perform one or more steps of the methods described and/or claimed herein. Additionally, computer program products can include computer-readable medium having instructions for causing a computer to perform one or more steps of the methods described and/or claimed herein.

In some embodiments, a computer program product can include a computer-readable medium, comprising: a first set of codes for causing a computer to receive information indicative of a buffer status for one or more logical channel groups at a user equipment; a second set of codes for causing the computer to transmit an interference management request to one or more out-of-cell user equipment; and a third set of codes for causing the computer to receive information indicative of intended transmit power from the one or more out-of-cell user equipment and a power commitment by the user equipment in the cell in response to the one or more out-of-cell user equipment receiving the interference management request; and a fourth set of codes for causing the computer to schedule transmission of data from the user equipment in a cell, wherein the scheduling is based on information indicative of intended transmit power, wherein a base station comprises the computer.

In some embodiments, an apparatus can include an interference management module configured to: receive information indicative of a buffer status for one or more logical channel groups at a user equipment; transmit an interference management request to one or more out-of-cell user equipment; receive information indicative of intended transmit power from the one or more out-of-cell user equipment and a power commitment by the user equipment in the cell in response to the one or more out-of-cell user equipment receiving the interference management request; and schedule transmission of data from the user equipment in a cell, wherein the scheduling is based on information indicative of intended transmit power, wherein receiving information indicative of a buffer status, transmitting, receiving and scheduling is performed by a base station in the cell that serves the user equipment in the cell.

In some embodiments, a computer program product can include a computer-readable medium, comprising: a first set of codes for causing a computer to determine head of line delay for one or more logical channel groups at user equipment, wherein a base station comprises the computer, and wherein determining head of line delay for the one or more logical channel groups at the user equipment comprises: estimating a number of bytes in the one or more logical channel groups at the user equipment, estimating a number of bytes scheduled for the user equipment through physical downlink control channel but which have not been decoded successfully at a serving base station or evaluating feedback from a radio link controller at the serving base station, wherein the feedback is indicative of a number of bytes successfully received from the one or more logical channel groups at the user equipment.

In some embodiments, another apparatus can include: a scheduler configured to: determine head of line delay for the one or more logical channel groups at the apparatus, wherein determining head of line delay for the one or more logical channel groups at the apparatus comprises: estimating a number of bytes in the one or more logical channel groups at the apparatus, estimating a number of bytes scheduled for the apparatus through physical downlink control channel but which have not been decoded successfully at a serving base station or evaluating feedback from a radio link controller at the serving base station, wherein the feedback is indicative of a number of bytes successfully received from the one or more logical channel groups at the apparatus.

In some embodiments, another apparatus can include: a first set of codes for causing a computer to transmit a buffer status report from user equipment having one or more logical channel groups; a second set of codes for causing the computer to receive information for configuring a priority metric and a prioritized bit rate for at least one of the one or more logical channel groups, wherein the configuring a priority metric and a prioritized bit rate for at least one of the one or more logical channel groups is in response to information included in the buffer status report; and a third set of codes for causing the computer to receive information for re-configuring the priority metric and the prioritized bit rate for the at least one of the one or more logical channel groups in response to a serving base station for the user equipment having one or more logical channel groups determining interference at the user equipment having one or more logical channel groups, wherein the user equipment comprises the computer. In some embodiments, the configuring is performed via radio resource control signaling.

In some embodiments, another apparatus can include a transceiver configured to: transmit a buffer status report from user equipment having one or more logical channel groups; receive information for configuring a priority metric and a prioritized bit rate for at least one of the one or more logical channel groups, wherein the configuring a priority metric and a prioritized bit rate for at least one of the one or more logical channel groups is in response to information included in the buffer status report; and receive information for re-configuring the priority metric and the prioritized bit rate for the at least one of the one or more logical channel groups in response to a serving base station for the user equipment having one or more logical channel groups determining interference at the user equipment having one or more logical channel groups.

In some embodiments, the configuring is performed via radio resource control signaling.

In some embodiments, a computer program product, including a computer-readable medium is provided. The computer program product can include: a first set of codes for causing a computer to select one or more user equipment of a first cell to schedule on an uplink, wherein selecting is based on one or more of: interference caused by one or more user equipment of the first cell to one or more base stations of a second cell, interference estimated if interference management requests for one or more user equipment of the first cell are transmitted, a priority of traffic for one or more user equipment of the first cell, a serving link gain from one or more user equipment of the first cell to the base station, an instantaneous buffer state for one or more user equipment of the first cell, a channel quality indicator for one or more user equipment of the first cell, a head of line delay for one or more user equipment of the first cell.

In some embodiments, another apparatus is provided. The apparatus can include an interference management module configured to: select one or more user equipment of a first cell to schedule on an uplink, wherein selecting is based on one or more of: interference caused by one or more user equipment of the first cell to one or more base stations of a second cell, interference estimated if interference management requests for one or more user equipment of the first cell are transmitted, a priority of traffic for one or more user equipment of the first cell, a serving link gain from one or more user equipment of the first cell to the base station, instantaneous buffer state for one or more user equipment of the first cell or a head of line delay for one or more user equipment of the first cell.

In some embodiments, a computer program product including a computer-readable medium is provided. The computer program product can include: a first set of codes for causing a computer to determine a first set of user equipment to contend for a resource; a second set of codes for causing the computer to schedule transmission of one or more coordination messages to out-of-cell user equipment; a third set of codes for causing the computer to receive interference information; a fourth set of codes for causing the computer to determine a second set of user equipment to transmit information; and a fifth set of codes for causing the computer to schedule transmission of the information by the second set of user equipment, wherein a serving base station comprises the computer.

In some embodiments, an apparatus includes an interference management module configured to: determine a first set of user equipment to contend for a resource; schedule transmission of one or more coordination messages to out-of-cell user equipment; receive interference information; determine a second set of user equipment to transmit information, wherein determining a second set of user equipment to transmit information is in response to determining one or more of interference information or an interference commitment made for a first set of user equipment; and

schedule transmission of the information by a second set of user equipment.

In some embodiments, a computer pgoram product having a computer-readable medium includes a first set of codes for causing a computer to receive a buffer status request; and a second set of codes for causing the computer to transmit an interference management request, wherein the interference management request is based on the buffer status request, and wherein the receiving and the transmitting is performed by a base station in a first cell, wherein the transmitting the interference management request comprises transmitting the interference management request over a backhaul to a base station in a second cell.

In another aspect, an apparatus is provided. The apparatus can include: an interference management module configured to: receive a buffer status request; and transmit an interference management request, wherein the interference management request is based on the buffer status request, and wherein the receiving and the transmitting is performed by a base station in a first cell, wherein the transmitting the interference management request comprises transmitting the interference management request over a backhaul to a base station in a second cell.

A wireless multiple-access communication system can simultaneously support communication for multiple wireless access terminals. As mentioned above, each terminal can communicate with one or more BSs via transmissions on the forward and reverse links. The forward link (or downlink) refers to the communication link from the BSs to the terminals, and the reverse link (or uplink) refers to the communication link from the terminals to the BSs. This communication link can be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas can be decomposed into N_{S} independent channels, which are also referred to as spatial channels, where N_{S}≦min{N_{T}, N_{R}}. Each of the Nₛ independent channels corresponds to a dimension. The MIMO system can provide improved performance (e.g., higher throughput and/or greater reliability) if the additional dimensionalities created by the multiple transmit and receive antennas are utilized.

A MIMO system can support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

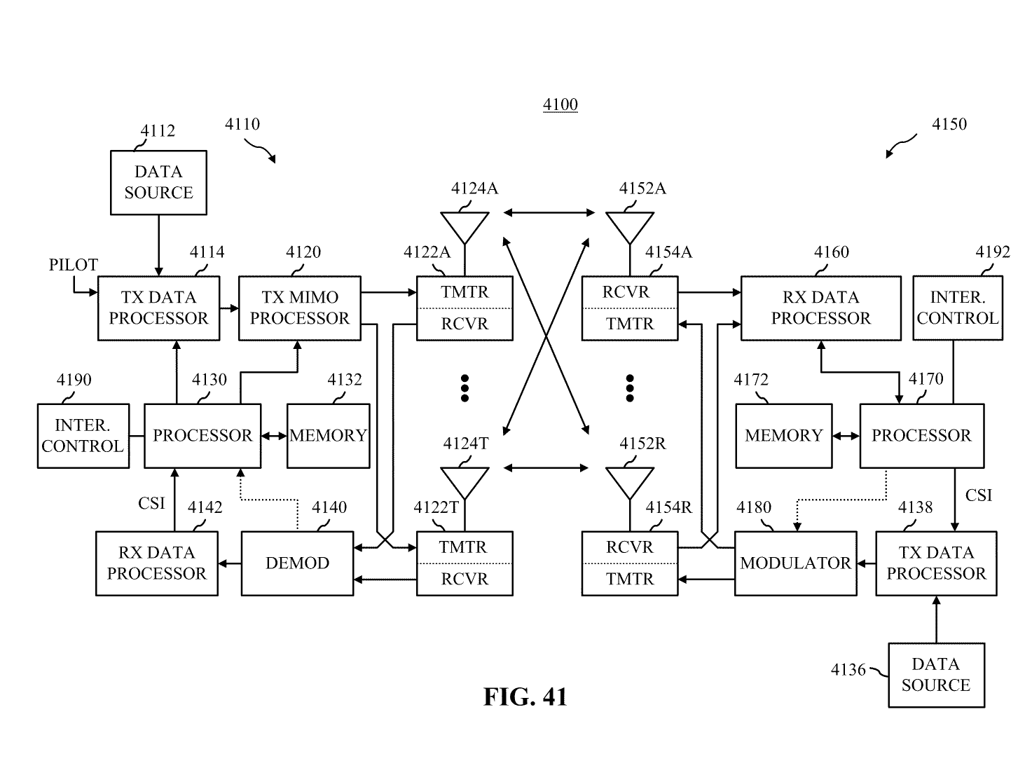

FIG. 41 shows an example wireless communication system in which the embodiments described herein can be employed. The teachings herein may be incorporated into a node (e.g., a device) employing various components for communicating with at least one other node. FIG. 41 depicts several sample components that may be employed to facilitate communication between nodes. Specifically, FIG. 41 illustrates a wireless device 4110 (e.g., an access point) and a wireless device 4150 (e.g., an access terminal) of a wireless communication system 4100 (e.g., MIMO system). At the device 4110, traffic data for a number of data streams is provided from a data source 4112 to a transmit (TX) data processor 4114.

In some aspects, each data stream is transmitted over a respective transmit antenna. The TX data processor 4114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 4130. A data memory 4132 may store program code, data, and other information used by the processor 4130 or other components of the device 4110.

The modulation symbols for all data streams are then provided to a TX MIMO processor 4120, which may further process the modulation symbols (e.g., for OFDM). The TX MIMO processor 4120 then provides N_{T} modulation symbol streams to N_{T} transceivers (XCVR) 4122A through 4122T. In some aspects, the TX MIMO processor 4120 applies beam-forming weights to the symbols of the data streams and to the antenna from which the symbol is being transmitted.

Each transceiver 4122 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 4122A through 4122T are then transmitted from N_{T} antennas 4124A through 4124T, respectively.

At the device 4150, the transmitted modulated signals are received by N_{R} antennas 4152A through 4152R and the received signal from each antenna 4152 is provided to a respective transceiver (XCVR) 4154A through 4154R. Each transceiver 4154 conditions (e.g., filters, amplifies, and downconverts) a respective received signal, digitizes the conditioned signal to provide samples, and further processes the samples to provide a corresponding “received” symbol stream.

A receive (RX) data processor 4160 then receives and processes the N_{R} received symbol streams from N_{R} transceivers 4154 based on a particular receiver processing technique to provide N_{T} “detected” symbol streams. The RX data processor 4160 then demodulates, deinterleaves, and decodes each detected symbol stream to recover the traffic data for the data stream. The processing by the RX data processor 4160 is complementary to that performed by the TX MIMO processor 4120 and the TX data processor 4114 at the device 4110.

A processor 4170 periodically determines which pre-coding matrix to use (discussed below). The processor 4170 formulates a reverse link message comprising a matrix index portion and a rank value portion. A data memory 4172 may store program code, data, and other information used by the processor 4170 or other components of the device 4150.

The reverse link message may comprise various types of information regarding the communication link and/or the received data stream. The reverse link message is then processed by a TX data processor 4138, which also receives traffic data for a number of data streams from a data source 4136, modulated by a modulator 4180, conditioned by the transceivers 4154A through 4154R, and transmitted back to the device 4110.

At the device 4110, the modulated signals from the device 4150 are received by the antennas 4124, conditioned by the transceivers 4122, demodulated by a demodulator (DEMOD) 4140, and processed by a RX data processor 4142 to extract the reverse link message transmitted by the device 4150. The processor 4130 then determines which pre-coding matrix to use for determining the beam-forming weights then processes the extracted message.

FIG. 41 also illustrates that the communication components may include one or more components that perform interference control operations as taught herein. For example, an interference (INTER.) control component 4190 may cooperate with the processor 4130 and/or other components of the device 4110 to send/receive signals to/from another device (e.g., device 4150) as taught herein. Similarly, an interference control component 4192 may cooperate with the processor 4170 and/or other components of the device 4150 to send/receive signals to/from another device (e.g., device 4110). It should be appreciated that for each device 4110 and 4150 the functionality of two or more of the described components may be provided by a single component. For example, a single processing component may provide the functionality of the interference control component 4190 and the processor 4130 and a single processing component may provide the functionality of the interference control component 4192 and the processor 4170.

In an aspect, logical channels can be classified into Control Channels and Traffic Channels. Logical Control Channels can include a Broadcast Control Channel (BCCH), which is a DL channel for broadcasting system control information. Further, Logical Control Channels can include a Paging Control Channel (PCCH), which is a DL channel that transfers paging information. Moreover, the Logical Control Channels can include a Multicast Control Channel (MCCH), which is a Point-to-multipoint DL channel used for transmitting Multimedia Broadcast and Multicast Service (MBMS) scheduling and control information for one or several Multicast Traffic Channels (MTCHs). Generally, after establishing a Radio Resource Control (RRC) connection, this channel is only used by UEs that receive MBMS (e.g., old MCCH+MSCH). Additionally, the Logical Control Channels can include a Dedicated Control Channel (DCCH), which is a Point-to-point bi-directional channel that transmits dedicated control information and can be used by UEs having a RRC connection. In an aspect, the Logical Traffic Channels can comprise a Dedicated Traffic Channel (DTCH), which is a Point-to-point bi-directional channel dedicated to one UE for the transfer of user information. Also, the Logical Traffic Channels can include an MTCH for Point-to-multipoint DL channel for transmitting traffic data.

In an aspect, Transport Channels are classified into DL and UL. DL Transport Channels can include a Broadcast Channel (BCH), a Downlink Shared Data Channel (DL-SDCH) and a Paging Channel (PCH). The PCH can support UE power saving (e.g., Discontinuous Reception (DRX) cycle can be indicated by the network to the UE) by being broadcasted over an entire cell and being mapped to Physical layer (PHY) resources that can be used for other control/traffic channels. The UL Transport Channels can comprise a Random Access Channel (RACH), a Request Channel (REQCH), an Uplink Shared Data Channel (UL-SDCH) and a plurality of PHY channels.

The PHY channels can include a set of DL channels and UL channels. For example, the DL PHY channels can include: Common Pilot Channel (CPICH); Synchronization Channel (SCH); Common Control Channel (CCCH); Shared DL Control Channel (SDCCH); Multicast Control Channel (MCCH); Shared UL Assignment Channel (SUACH); Acknowledgement Channel (ACKCH); DL Physical Shared Data Channel (DL-PSDCH); UL Power Control Channel (UPCCH); Paging Indicator Channel (PICH); and/or Load Indicator Channel (LICH). By way of further illustration, the UL PHY Channels can include: Physical Random Access Channel (PRACH); Channel Quality Indicator Channel (CQICH); Acknowledgement Channel (ACKCH); Antenna Subset Indicator Channel (ASICH); Shared Request Channel (SREQCH); UL Physical Shared Data Channel (UL-PSDCH); and/or Broadband Pilot Channel (BPICH).

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors and/or other electronic units designed to perform the functions described herein, or a combination thereof.

When the embodiments are implemented in software, firmware, middleware or microcode, program code or code segments, they can be stored in a machine-readable medium (or a computer-readable medium), such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for facilitating scheduling in a wireless communication system, the method comprising:
receiving, by a serving base station, a buffer status report from user equipment having one or more logical channel groups;
configuring, by the serving base station, a first priority metric and a first prioritized bit rate for at least one of the one or more logical channel groups, wherein the configuring a first priority metric and a first prioritized bit rate for at least one of the one or more logical channel groups is in response to information included in the buffer status report;
determining, by the serving base station, interference at the user equipment; and
re-configuring, by the serving base station, the first priority metric and the first prioritized bit rate for the at least one of the one or more logical channel groups in response to determining interference at the user equipment.

2. The method of claim 1, wherein the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group.

3. The method of claim 1, wherein configuring the first prioritized bit rate is performed via radio resource control signaling.

4. The method of claim 1, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

5. A computer program product, comprising:
a computer-readable medium, comprising:
a first set of codes for causing a computer to receive a buffer status report from user equipment having one or more logical channel groups;
a second set of codes for causing the computer to configure a first priority metric and a first prioritized bit rate for at least one of the one or more logical channel groups, wherein configuring a first priority metric and a first prioritized bit rate for at least one of the one or more logical channel groups is in response to information included in the buffer status report;
a third set of codes for causing the computer to determine interference at the user equipment; and
a fourth set of codes for causing the computer to re-configure the first priority metric and the first prioritized bit rate for the at least one of the one or more logical channel groups in response to determining interference at the user equipment, wherein a serving base station comprises the computer.

6. The computer program product of claim 5, wherein the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group.

7. The computer program product of claim 5, wherein configuring the first prioritized bit rate is performed via radio resource control signaling.

8. The computer program product of claim 5, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

9. An apparatus, comprising:
means for receiving a buffer status report from user equipment having one or more logical channel groups;
means for configuring a first priority metric and a first prioritized bit rate for at least one of the one or more logical channel groups, wherein the configuring a first priority metric and a first prioritized bit rate for at least one of the one or more logical channel groups is in response to information included in the buffer status report;
means for determining interference at the user equipment; and
means for re-configuring the first priority metric and the first prioritized bit rate for the at least one of the one or more logical channel groups in response to determining interference at the user equipment.

10. The apparatus of claim 9, wherein the first prioritized bit rate is based on one or more of a head-of-line delay, a number of packets in a buffer, a strength of a channel from associated user equipment to a serving base station, one or more strengths of channels from the user equipment to non-serving base stations or quality of service characteristics of a traffic associated with a logical channel group.

11. The apparatus of claim 9, wherein configuring the first prioritized bit rate is performed via radio resource control signaling.

12. The apparatus of claim 9, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

13. An apparatus, comprising:
a transceiver configured to receive a buffer status report from user equipment having one or more logical channel groups; and
a scheduler configured to:
configure a first priority metric and a first prioritized bit rate for at least one of the one or more logical channel groups, wherein the configuring a first priority metric and a first prioritized bit rate for at least one of the one or more logical channel groups is in response to information included in the buffer status report;
determine interference at the user equipment; and
re-configure the first priority metric and the first prioritized bit rate for the at least one of the one or more logical channel groups in response to determining interference at the user equipment.

14. The apparatus of claim 13, wherein the first prioritized bit rate is based on one or more of a head-of-line delay, a number of packets in a buffer, a strength of a channel from associated user equipment to a serving base station, one or more strengths of channels from the user equipment to non-serving base stations or quality of service characteristics of a traffic associated with a logical channel group.

15. The apparatus of claim 13, wherein configuring the first prioritized bit rate is performed via radio resource control signaling.

16. The apparatus of claim 13, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

17. A method for facilitating scheduling in a wireless communication system, the method comprising:
transmitting, to a serving base station, a buffer status report from user equipment having one or more logical channel groups;
receiving, at the user equipment, a first priority metric and a first prioritized bit rate for at least one of the one or more logical channel groups, wherein the first priority metric and the second prioritized bit rate are configured for at least one of the one or more logical channel groups in response to information included in the buffer status report; and
receiving, at the user equipment, a re-configured first priority metric and a re-configured first prioritized bit rate for the at least one of the one or more logical channel groups in response to the serving base station determining interference at the user equipment.

18. The method of claim 17, wherein the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group.

19. The method of claim 17, wherein configuring the first prioritized bit rate is performed via radio resource control signaling.

20. The method of claim 17, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

21. A computer program product, comprising:
a computer-readable medium, comprising:
a first set of codes for causing a computer to transmit, to a serving base station, a buffer status report from user equipment having one or more logical channel groups;
a second set of codes for causing the computer to receive a first priority metric and a first prioritized bit rate for at least one of the one or more logical channel groups, wherein the first priority metric and the second prioritized bit rate are configured for at least one of the one or more logical channel groups in response to information included in the buffer status report; and
a third set of codes for causing the computer to receive a re-configured first priority metric and a re-configured first prioritized bit rate for the at least one of the one or more logical channel groups in response to the serving base station determining interference at the user equipment.

22. The computer program product of claim 21, wherein the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group.

23. The computer program product of claim 21, wherein configuring the first prioritized bit rate is performed via radio resource control signaling.

24. The computer program product of claim 21, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

25. An apparatus, comprising:
means for transmitting, to a serving base station, a buffer status report from user equipment having one or more logical channel groups;
means for receiving a first priority metric and a first prioritized bit rate for at least one of the one or more logical channel groups, wherein the first priority metric and the second prioritized bit rate are configured for at least one of the one or more logical channel groups in response to information included in the buffer status report; and
means for receiving a re-configured first priority metric and a re-configured first prioritized bit rate for the at least one of the one or more logical channel groups in response to the serving base station determining interference at the user equipment.

26. The apparatus of claim 25, wherein the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group.

27. The apparatus of claim 25, wherein configuring the first prioritized bit rate is performed via radio resource control signaling.

28. An apparatus, comprising:
a transceiver configured to transmit, to a serving base station, a buffer status report from user equipment having one or more logical channel groups;
a scheduler configured to:
receive a first priority metric and a first prioritized bit rate for at least one of the one or more logical channel groups, wherein the first priority metric and the second prioritized bit rate are configured for at least one of the one or more logical channel groups in response to information included in the buffer status report; and
receive a re-configured first priority metric and a re-configured first prioritized bit rate for the at least one of the one or more logical channel groups in response to the serving base station determining interference at the user equipment.

29. The apparatus of claim 28, wherein the first prioritized bit rate is based on one or more of a head-of-line delay, a number of packets in a buffer, a strength of a channel from associated user equipment to the serving base station, one or more strengths of channels from the user equipment to non-serving base stations or quality of service characteristics of a traffic associated with a logical channel group.

30. The apparatus of claim 28, wherein configuring the first prioritized bit rate is performed via radio resource control signaling.

31. The apparatus of claim 28, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.

32. The apparatus of claim 28, wherein the first priority metric or the second priority metric is based on one or more of: a priority of a logical channel group, an estimated head of line delay, an estimated queue length, an estimated packet delay, an estimated packet size, an estimated average rate at which a queue has been served in the past.
